(19) United States
(12) Patent Application Publication
(10) Pub. No.: US 2025/0092927 A1
(43) Pub. Date: Mar. 20, 2025

(54) FRICTION DEVICE WITH FLANGE ENGAGEMENT BEAM CENTERING

(71) Applicant: RFPC HOLDING CORP., Wilmerding, PA (US)

(72) Inventor: Alan Gary Bowden, Laurinburg, NC (US)

(73) Assignee: RFPC HOLDING CORP., Wilmerding, PA (US)

(21) Appl. No.: 18/959,378

(22) Filed: Nov. 25, 2024

Related U.S. Application Data
(63) Continuation-in-part of application No. 18/913,597, filed on Oct. 11, 2024.
Application No. 18/913,597 is a continuation of application No. 17/511,051, filed on Oct. 26, 2021, now Pat. No. 12,117,055.
Application No. 17/511,051 is a continuation-in-part of application No. PCT/US2020/037168, filed on Jun. 11, 2020.
(60) Provisional application No. 62/860,035, filed on Jun. 11, 2019.

(51) Int. Cl. F16D 65/06; F16D 69/02; F16D 69/04

(52) U.S. Cl. CPC F16D 65/06; F16D 65/062; F16D 69/026; F16D 69/0416; F16D 2200/0065

(57) ABSTRACT

A friction device and method for a wheel may include a backing plate and a friction material disposed on the backing plate to form a brake surface to engage a surface of the wheel. The friction material extends between a first end and a second end along a central longitudinal axis, and between a rim side and a flange side. The friction material may include an extended volume portion that includes one or more protrusions and/or recesses extending away from a longitudinal flange side of the friction material to engage the flange of the wheel. The method including engaging and disengaging a brake surface.

### CROSS-REFERENCE TO RELATED APPLICATIONS

This application in a continuation-in-part of and claims priority 35 U.S.C. § 120 to U.S. Continuation application Ser. No. 18/913,597, filed Oct. 11, 2024, which is a continuation application claiming priority under 35 U.S.C. § 120 to U.S. patent application Ser. No. 17/511,051, filed Oct. 26, 2021, which is a bypass continuation-in-part of and claims priority under 35 U.S.C. § 365 to International Patent Application No. PCT/US2020/37168, filed Jun. 11, 2020, which claims priority under 35 U.S.C. § 119 to U.S. Provisional Application No. 62/860,035, filed Jun. 11, 2019 and 62/859,965, filed Jun. 11, 2019. The entire disclosures of which are hereby incorporated by reference herein.

### BACKGROUND

### Technical Field

The subject matter described herein relates to friction devices (e.g., brake shoes) for vehicle brake systems for vehicle brake systems.

### Description of Art

Various types of friction devices (e.g., brake shoes) having different compositions are used to achieve specific braking requirements. For example, these compositions may include cast iron and other types of friction materials that may be specifically formulated for a number of predetermined applications. These various types of friction materials may exhibit a number of uniquely different friction characteristics upon a wheel of a vehicle, specifically the wheel tread.

Braking applications, as well as contact between a wheel of a vehicle and a route, may lead to surface defects of the wheel. These surface defects may include shells, spalls, pits, generalized corrosion, cracks, flats, as well as uneven and hollow wheel wear. Conditioning a wheel tread may reduce an amount of one or more surface defects.

As one example, hollow wheel wear may refer to a wheel tread that has an amount of wear near a center of the wheel tread that is greater than an amount of wear near the rim or “field side” of the wheel. Mitigating hollow wheel wear may extend the life of a wheel that is in service. Hollow wheel wear may be measured by comparing the wheel tread along the rim of the wheel with the wheel tread near or proximate to the center of the wheel. A thickness of height of the wheel tread may be measured between a center portion or interior portion of the wheel tread and an outer portion of the wheel tread surface. The difference in height between the wheel tread surface near the rim and the wheel tread surface near the center of the wheel may indicate an amount of wear to the wheel tread. As one example, the center of a wheel of a rail vehicle may see a greater amount of wear relative to other areas of the wheel as the wheel tread near the center of the wheel directly contacts the rail during operation. For example, wear of the wheel tread near the center of a rail wheel may outpace the wear of the wheel at the rim. The diameter of the wheel near the center of the wheel tread may become smaller at a faster rate relative to the diameter of the wheel tread near the rim. By reducing hollow wheel wear, the lifespan of the wheel can be increased. Friction devices may provide inadequate friction levels for braking applications, may spark during brake applications, or may include aggressive grinding type material.

For example, PCT Patent Application No. PCT/RU2018/000340 describes a brake shoe for a railway vehicle that includes a polymer composite friction element, a metal casing, and a wrought iron insert. The weight of the wrought iron insert corresponds to 18%-30% of the weight of the brake shoe which affects the distribution of heat between the wheel and the brake shoe, the coefficients of the braking efficiency, and the effective volume of thermal absorption.

As another example, PCT Patent Application No. PCT/RU2018/000339 describes a brake shoe for a railway vehicle that includes a polymer composite friction element, a metal casing, and a wrought iron insert. The weight of the wrought iron insert corresponds to 59-90% of the weight of the brake shoe which affects the functional characteristics of the jaw.

As another example, PCT Patent Application No. PCT/RU2018/000337 describes a brake shoe for a railroad vehicle that includes a metal frame, a polymer composite friction clement, and a metal insert. Depressions are made on the surface of the friction element in zones (such as groves, openings on the side of the inserts between the insert and a friction material) ostensibly to affect a possibility of the polymer composite of the friction element crumbling within the zones where said element interfaces with the insert.

As another example, Russian Patent No. RU2504703 describes a friction material for an automobile brake pad that includes a carrier material with high open porosity which is wetted by a binder, and onto which a functional substance is applied or introduced. The residual moisture after drying may be from 0.3% to 5%. Suitable carrier materials were those materials which have a specific surface area of from 20 m²/g to 80 m²/g. The carrier material preferably has a grain size of from 90 μm to 1.5 mm, which ensured workability of the friction material. The mixing of the carrier material and the binder occurs with a surface velocity of particles of 5 m/s to 50 m/s. In a specific example, a friction material was produced that has 3990 parts of carrier material with 2100 parts of a binder (e.g. water and hydrated sodium silicate in a 1:1 ratio). Then 350 parts of molybdenum sulfide, 490 parts of a multi-component lubricant containing, for example, iron sulfide II, zinc sulfide II and/or titanium sulfide IV, as well as 140 parts of zinc sulfide II, were added.

As another example, Russian Patent No. RU2309072 describes a brake shoe that includes a metal skeleton with a U-shaped projection in its central part, a composite friction member, and an insert. The insert is arranged in a central part of the shoe and may be welded to the metal skeleton. The insert is made of high strength or malleable cast iron. A ratio of an area of a working surface of the insert to a total area of a working surface of the brake shoe is in a range of from about 4% to 20%.

As another example, Russian Patent No. RU2428599 describes a friction item that includes a metal frame with holes and of friction element with protrusions or lugs molded onto it. The friction element is made of polymer friction composite and is disposed so that the lugs are arranged inside of the holes. The hardness of composite in lugs is less than in a working part of the friction element.

For different braking applications, various types of friction devices (e.g., brake shoes) having different compositions may be used to achieve specific braking requirements. For example, these compositions may include cast iron and various other types of friction materials that are formulated for predetermined applications. Different friction materials will exhibit uniquely different friction characteristics upon a wheel of a rail vehicle, specifically the wheel tread, for braking. Friction characteristics may include reconditioning a wheel tread for removal of surface defects such as shells or spalls.

Additionally, the shape of current brake shoes, however, may allow for gradual lateral migration of the brake shoe across the tread of a wheel during operation. The lateral migration may result in asymmetric brake shoe wear, which has been associated with asymmetric wheel tread wear. The lateral migration may result in an overhanging brake shoe, which occurs when at least a portion of the brake shoe hangs off the wheel. This may reduce brake effectiveness during a braking operation. Lateral migration may lead to other undesirable conditions such as high contact conicities along the wheel tread and the formation of heat checks on the rim side of a wheel. These conditions may result in a shortened lifespan of the brake shoe and/or of the wheel itself.

Efforts to prevent the negative consequences of lateral migration are often expensive and time consuming in terms of validation and testing. For example, improving the brake rigging associated with the brake shoes adds cost and complexity, as do features like outfitting brake shoe backing plates with metal alignment flanges or the like.

Therefore, it may be desirable to have a friction device (e.g., brake shoe) that differs from those that are currently available.

### BRIEF DESCRIPTION

A friction device for a wheel, is provided. The friction device includes a backing plate configured to interface with a brake actuator of a vehicle that has a wheel with a wheel flange and a wheel tread. A friction structure is attached to the backing plate and includes a friction material and defines a central longitudinal axis. The friction structure has a longitudinal flange side, a longitudinal rim side, and two opposing ends and defines a brake surface for engaging the wheel. The friction structure includes an extended volume portion of the friction material on the longitudinal flange side. The extended volume portion defines a plurality of flange contact protrusions and recesses. One or more of the plurality of protrusions may at least partially engage the flange at least during initial use of the friction device with the wheel. The at least one protrusion of the plurality of protrusions extends a different length from the longitudinal flange side than each of the other protrusions of the plurality of protrusions.

A friction device is provided. The friction device includes a backing plate configured to interface with a brake actuator of a vehicle having a wheel with a wheel flange and a wheel tread. A friction structure is attached to the backing plate and includes a friction material that defines a central longitudinal axis. The friction structure has a longitudinal flange side, a longitudinal rim side, and two opposing ends and defines a brake surface for engaging the wheel. The friction structure includes an extended volume portion of the friction material on the longitudinal flange side. The extended volume portion defines a flange-engagement portion extending from the longitudinal flange side and extending continuously along the longitudinal length of the friction structure from opposing end to opposing end. The flange-engagement portion extends from the longitudinal flange side at varying lengths along the longitudinal length of the flange-engagement portion.

A friction device is provided. The friction device includes a backing plate and a friction structure attached to the backing plate. The friction structure includes a friction material. The friction material defines a central longitudinal axis. The friction structure has a longitudinal flange side, a longitudinal rim side, and two opposing ends. The friction structure defines a brake surface for engaging the wheel. The friction structure includes one or more wearable protrusions extending from the longitudinal flange side. The one or more wearable protrusions configured to engage a flange of the wheel.

A friction device is provided. The friction device includes a backing plate and a friction structure attached to the backing plate. The friction structure includes a first friction material that defines a central longitudinal axis. The friction structure has a longitudinal flange side, a longitudinal rim side, and two opposing ends and defines a brake surface for engaging the wheel. The friction structure includes a plurality of wearable protrusions extending from the longitudinal flange side and configured to engage a flange of the wheel. The one or more wearable protrusions of the plurality of wearable protrusions includes the first friction material. The one or more wearable protrusions of the plurality of wearable protrusions includes a lubricating friction material that is different from the first friction material.

A friction device is provided. The friction device reduces asymmetric wheel flange wear. The friction device includes a backing plate adapted to interface with a brake actuator of a vehicle having a wheel with a wheel flange and a wheel tread. A friction structure is attached to the backing plate and includes a friction material. The friction structure defines a brake surface to engage the wheel tread for braking. A longitudinal flange side has an extended volume portion with a plurality of flange contact protrusions, each configured to intermittently contact the wheel flange to reduce lateral forces during braking and thereby minimize wheel flange wear. The flange contact protrusions include a material with lower friction compared to the brake surface to create a friction gradient between the flange contact protrusions and the brake surface. The lower friction material reduces flange wear by decreasing lateral forces during wheel rotation.

A friction device is provided. The frictions device includes a backing plate and a friction structure attached to the backing plate. The friction structure includes a first friction material that defines a central longitudinal axis. The friction structure has a longitudinal flange side, a longitudinal rim side, and two opposing ends and defines a brake surface for engaging the wheel. The friction structure includes a plurality of wearable protrusions extending from the longitudinal flange side to engage a flange of the wheel. The one or more wearable protrusions of the plurality of wearable protrusions includes the first friction material. The one or more wearable protrusions of the plurality of wearable protrusions includes a lubricating friction material that is different from the first friction material.

A friction device is provided. The friction device reduces asymmetric wheel flange wear. The friction device includes a backing plate adapted to interface with a brake actuator of a vehicle having a wheel with a wheel flange and a wheel tread. A friction structure is attached to the backing plate and includes a friction material. The friction structure defines a brake surface to engage the wheel tread for braking. A longitudinal flange side has an extended volume portion with a plurality of flange contact protrusions, each to intermittently contact the wheel flange to reduce lateral forces during braking and thereby minimize wheel flange wear. The flange contact protrusions include a material with lower friction compared to the brake surface to create a friction gradient between the flange contact protrusions and the brake surface. The lower friction material reduces flange wear by decreasing lateral forces during wheel rotation.

A friction device is provided. The friction device reduces asymmetric wheel flange wear and improves brake beam centering. The friction device includes a friction structure having a tread-engaging portion and a flange-engaging portion. A flange-engaging portion includes a continuous flange contact strip extending along a longitudinal length of the friction structure. The flange contact strip includes varying protrusion lengths to distribute contact forces differently across the wheel flange during braking.

A method for engaging and disengaging a brake surface is provided. The method includes engaging a brake surface of a friction structure with a wheel of a vehicle. The friction structure includes a friction material having a central longitudinal axis, a longitudinal flange side, a longitudinal rim side, and an extended volume portion on the longitudinal flange side with a plurality of flange contact protrusions and recesses. The method further includes contacting the wheel flange with one or more of the plurality of flange contact protrusions during initial engagement of the brake surface allowing at least one of the plurality of protrusions, which extends a different length from the longitudinal flange side compared to other protrusions, to facilitate progressive engagement with the wheel flange. The method further includes disengaging the brake surface by reducing contact between the friction material and the wheel, including the plurality of flange contact protrusions.

### BRIEF DESCRIPTION OF THE DRAWINGS

The inventive subject matter may be understood from reading the following description of non-limiting examples, with reference to the attached drawings, wherein below:

FIG. 1 is a top view of a friction device according to one aspect of the invention;

FIG. 2 is a cross-sectional side view of the friction device shown in FIG. 1 along line A-A;

FIG. 3 is a bottom view of a friction device according to one example;

FIG. 4 is a bottom view of a friction device according to one example;

FIG. 5 is a bottom view of a friction device according to one example;

FIG. 6 is a bottom view of a friction device according to one example;

FIG. 7 is a bottom view of a friction device according to one example;

FIG. 8 is a bottom view of a friction device according to one example;

FIG. 9 is a bottom view of a friction device according to one example;

FIG. 10 is a bottom view of a friction device according to one example;

FIG. 11 is a partial cross-sectional and perspective view of the friction device shown in FIG. 10 along line B-B;

FIG. 12 is a cross-sectional side view of a friction device coupled with a wheel of a vehicle according to one example;

FIG. 13 is a top view of a friction device that includes an insert and an extended volume according to one example;

FIG. 14 is a bottom view of the friction device shown in FIG. 13; and

FIG. 15 is a perspective view of the friction device shown in FIG. 13.

FIG. 16 is a bottom view of an example of a friction device;

FIG. 17 is a cross-sectional end view of the friction device of FIG. 16 taken along line C-C, as applied to a flanged wheel;

FIG. 18 is an end view of a friction device, according to another aspect of the invention, as applied to a flanged wheel;

FIG. 19 is a bottom view of the friction device of FIG. 18;

FIG. 20 is a perspective view of the friction device of FIG. 18;

FIG. 21 is a top view of the friction device of FIG. 18;

FIG. 22 is a bottom view of another example of a friction device;

FIG. 23 is a bottom view of another example of a friction device;

FIG. 24 is a bottom view of another example of a friction device;

FIG. 25 is a top view of the friction device of FIG. 24 applied to a flanged wheel;

FIG. 26 is a cross-sectional end view of the friction device applied to the flanged wheel of FIG. 25 along line E-E;

FIG. 27 is a top view of two friction devices applied to flanged wheels;

FIG. 28 is a detailed sectional view of an interface between a wheel flange and an example of a friction device;

FIG. 29 is a detailed sectional view of an interface between a wheel flange and another example of a friction device;

FIG. 30 is a detailed sectional view of an interface between a wheel flange and another example of a friction device;

FIG. 31A is a bottom view of a friction device having variable multi-wear alignment protrusions, a backing plate, and a square keybridge, according to an embodiment;

FIG. 31B is a side view of the example friction device of FIG. 31A;

FIG. 31C is a top view of the example friction device of FIG. 31A;

FIG. 32A is a bottom view of a friction device having variable multi-wear alignment protrusions, a multi-wear alignment protrusion bridge, a backing plate, and a square keybridge, according to an embodiment;

FIG. 32B is a side view of the example friction device of FIG. 32A;

FIG. 32C is a top view of the example friction device of FIG. 32A;

FIG. 33A is a bottom view of a friction device having variable multi-wear alignment protrusions, a T-shaped insert, a backing plate, and a square keybridge, according to an embodiment;

FIG. 33B is a side view of the example friction device of FIG. 33A;

FIG. 33C is a top view of the example friction device of FIG. 33A;

FIG. 33D is a cross-sectional view of the example friction device of FIG. 33A along cross-section line F-F;

FIG. 34A is a bottom view of a friction device having variable multi-wear alignment protrusions, a multi-wear alignment protrusion bridge, a T-shaped insert, a backing plate, and a square keybridge, according to an embodiment;

FIG. 34B is a side view of the example friction device of FIG. 34A;

FIG. 34C is a top view of the example friction device of FIG. 34A;

FIG. 34D is a cross-sectional view of the example friction device of FIG. 34A along cross-section line G-G;

FIG. 35A is a bottom view of a friction device having variable multi-wear alignment protrusions a rim insert, a backing plate, and a square keybridge, according to an embodiment;

FIG. 35B is a side view of the example friction device of FIG. 35A;

FIG. 35C is a top view of the example friction device of FIG. 35A;

FIG. 35D is a cross-sectional view of the example friction device of FIG. 35A along cross-section line H-H;

FIG. 36A is a bottom view of a friction device having variable multi-wear alignment protrusions, a multi-wear alignment protrusion bridge, a rim insert, a backing plate, and a square keybridge, according to an embodiment;

FIG. 36B is a side view of the example friction device of FIG. 36A;

FIG. 36C is a top view of the example friction device of FIG. 36A;

FIG. 36D is a cross-sectional view of the example friction device of FIG. 36A along cross-section line J-J;

FIG. 37A is a bottom view of a friction device having variable multi-wear alignment protrusions, voids, a rim insert, a backing plate, and a square keybridge, according to an embodiment;

FIG. 37B is a side view of the example friction device of FIG. 37A;

FIG. 37C is a top view of the example friction device of FIG. 37A;

FIG. 37D is a cross-sectional view of the example friction device of FIG. 37A along cross-section line K-K;

FIGS. 37E-F are perspective views of the example friction device of FIG. 37A;

FIG. 38A is a bottom view of a friction device having variable multi-wear alignment protrusions, voids, a rim insert, a multi-wear alignment protrusion bridge, a backing plate, and a square keybridge, according to an embodiment;

FIG. 38B is a side view of the example friction device of FIG. 38A;

FIG. 38C is a top view of the example friction device of FIG. 38A;

FIG. 38D is a cross-sectional view of the example friction device of FIG. 38A along cross-section line L-L;

FIGS. 38E-F are perspective views of the example friction device of FIG. 38A;

FIG. 39A is a bottom view of a friction device having variable multi-wear alignment protrusions, voids, a T-shaped insert, a backing plate, and a square keybridge, according to an embodiment;

FIG. 39B is a side view of the example friction device of FIG. 39A;

FIG. 39C is a top view of the example friction device of FIG. 39A;

FIG. 39D is a cross-sectional view of the example friction device of FIG. 39A along cross-section line M-M;

FIGS. 39E-F are perspective views of the example friction device of FIG. 39A;

FIG. 39G is a cross-sectional view of the example friction device of FIG. 39A along cross-sectional line N-N;

FIG. 39H is a cross-sectional view of the example friction device of FIG. 39H along cross-sectional line O-O;

FIG. 40A is a bottom view of a friction device having variable multi-wear alignment protrusions, voids, a T-shaped insert, a multi-wear alignment protrusion bridge, a backing plate, and a square keybridge, according to an embodiment;

FIG. 40B is a side view of the example friction device of FIG. 40A;

FIG. 40C is a top view of the example friction device of FIG. 40A;

FIG. 40D is a cross-sectional view of the example friction device of FIG. 40A along cross-section line P-P;

FIGS. 40E-F are perspective views of the example friction device of FIG. 40A;

FIG. 41A is a top view of a friction device having a continuous ribbon of variable width multi-wear alignment protrusions, a backing plate, and a circular keybridge, according to an embodiment;

FIG. 41B is a side view the example friction device of FIG. 41A;

FIG. 41C is a bottom view the example friction device of FIG. 41A;

FIG. 42A is a top view of a friction device having a continuous ribbon of variable width multi-wear alignment protrusions, an array insert, a backing plate, and a square keybridge, according to an embodiment;

FIG. 42B is a cross-sectional view of the example friction device of FIG. 42A along cross-section line Q-Q;

FIG. 42C is a bottom view of the example friction device of FIG. 42A;

FIG. 43A is a top view of a friction device having a segmented ribbon of variable width multi-wear alignment protrusions, a backing plate, and a circular keybridge, according to an embodiment;

FIG. 43B is a side view of the example friction device in FIG. 43A;

FIG. 43C is a bottom view of the example friction device of FIG. 43A; and

FIG. 44A is a top view of a friction device having a single arc variable width multi-wear alignment tab, according to an embodiment;

FIG. 44B is a side view of the example friction device of FIG. 44A;

FIG. 44C is a top view of the example friction device of FIG. 44A;

FIG. 44D is a cross-sectional view of the example friction device of FIG. 44A along cross-section line R-R;

FIG. 44E is a cross-sectional view of the example friction device of FIG. 44A along cross-section line S-S;

FIG. 44F is a cross-sectional view of the example friction device of FIG. 44A along cross-section line T-T;

FIG. 44G is a perspective view of the example friction device of FIG. 44A including voids, according to an embodiment;

FIG. 45 is a cross-sectional view of a friction device having a single arc variable width multi-wear alignment tab and a wheel, according to an embodiment;

FIG. 46 is a cross-sectional view of a friction device having a single arc variable width multi-wear alignment tab and a wheel, according to an embodiment.

### DETAILED DESCRIPTION

One or more examples of the inventive subject matter described herein provide a friction device for use on a vehicle. In one or more examples, the friction device can be, or may be referred to as, a brake shoe. A suitable vehicle may be a railway vehicle in one embodiment. The friction device may include a bonded insert and a friction structure formed of a friction material. The friction structure may have a reduced volume relative to a traditional brake pad. In one example, a friction device may be provided that includes a backing plate, a friction material disposed on the backing plate to form a brake surface, and at least one void disposed within the friction material. The void may be an opening of the brake surface of the friction material.

During use, the friction device may engage the brake surface of the friction material with a wheel surface of a wheel to slow or stop movement of the wheel. An amount of wear of the wheel surface of the wheel may be controlled and/or reduced by the one or more voids in the friction material relative to a friction device without voids in the friction material. As one example, the one or more voids may be openings of the brake surface of the friction material such that the wheel surface may not contact the brake surface of the friction material at the one or more voids or the brake surface of the friction material may disengage from the wheel surface at the one or more voids. As another example, the brake surface of the friction structure may include and/or be made of a first material, and a portion of the voids may be filled with a different, second material such that the wheel surface may contact the first material (e.g., the friction material) at the brake surface and outside of the voids and may contact the second material at the voids.

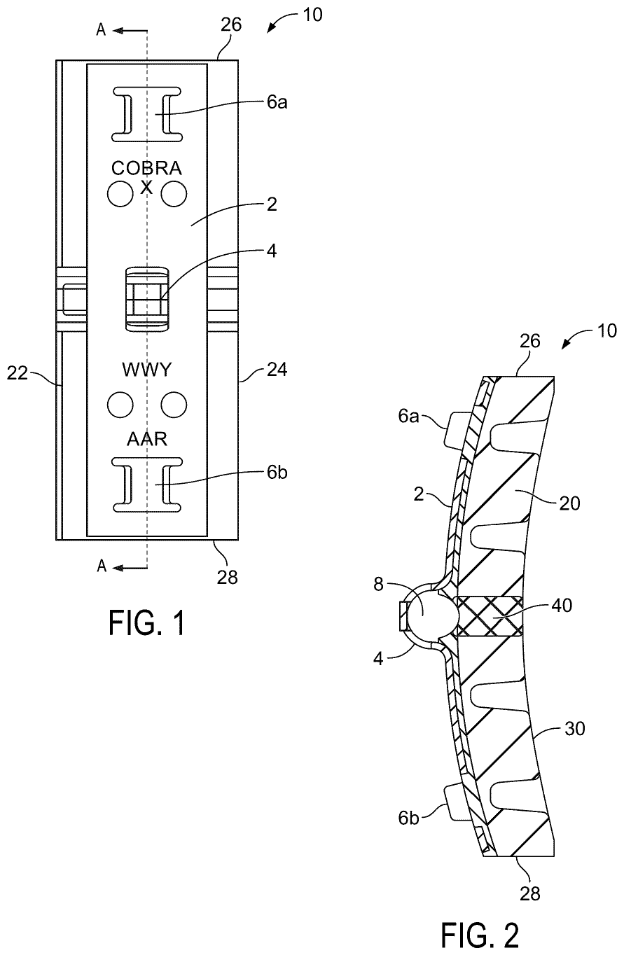

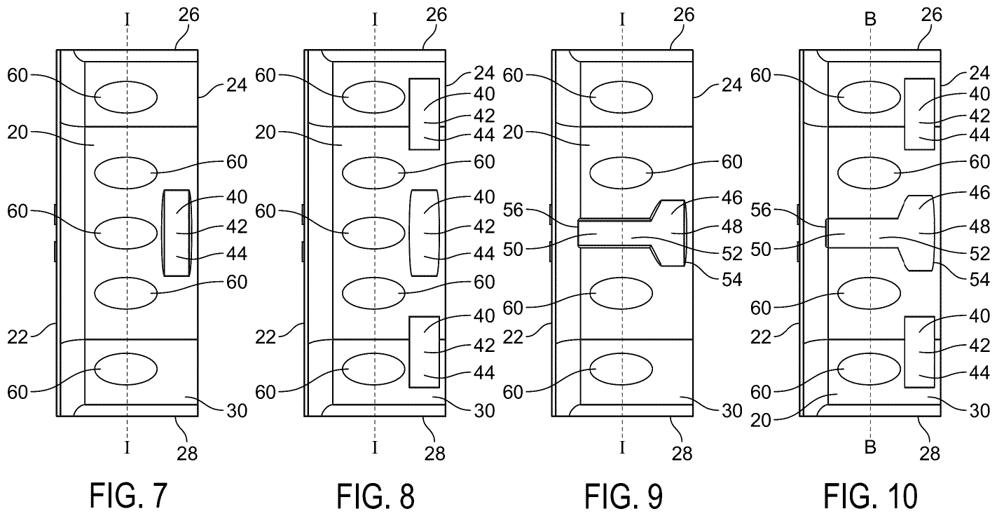

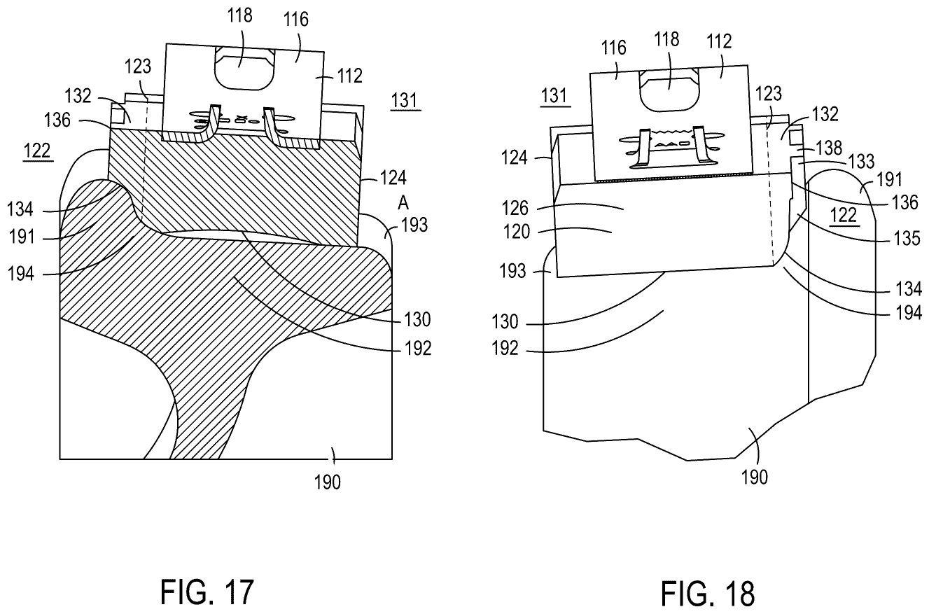

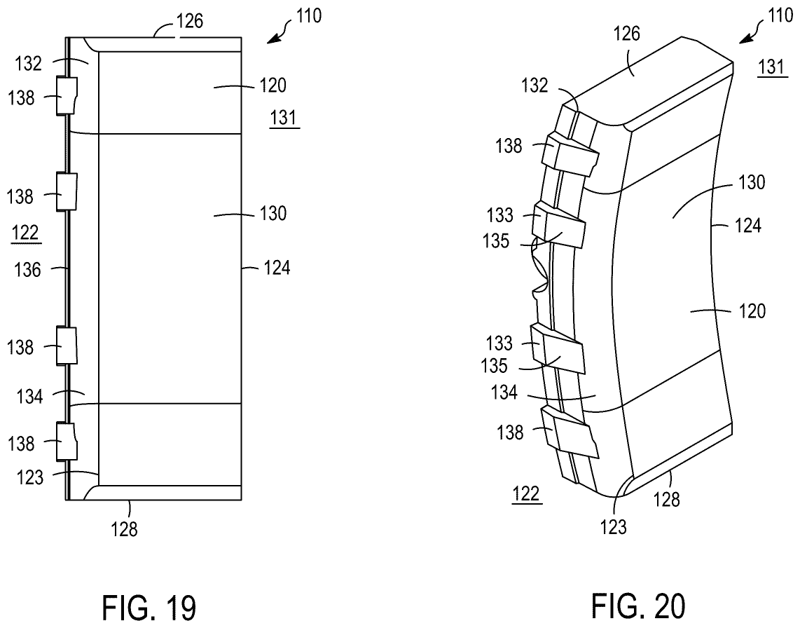

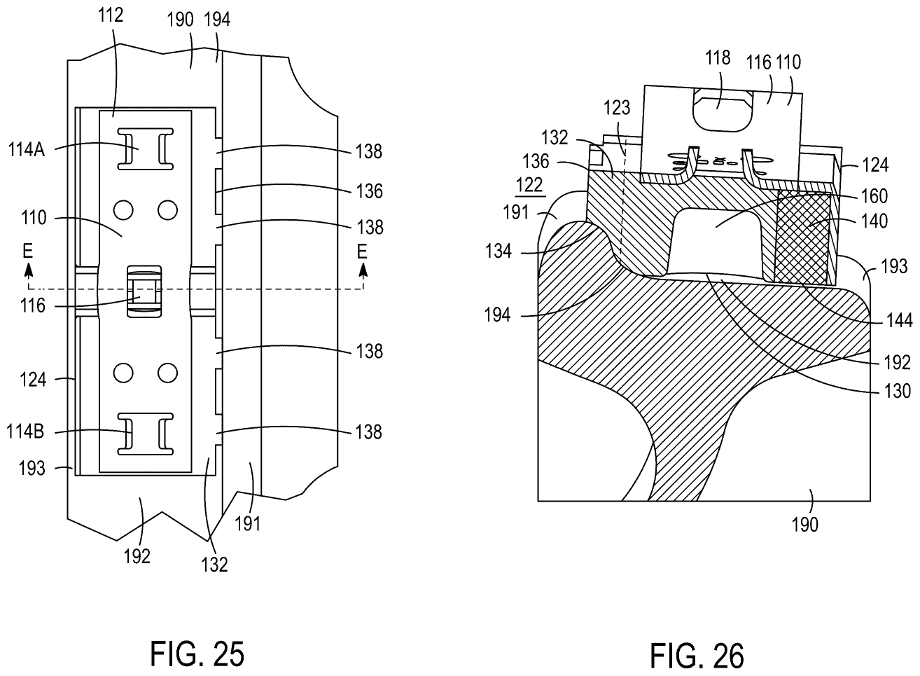

Referring to FIGS. 1, 2, and 12, a friction device 10 in accordance with at least one example of the inventive subject matter is illustrated. The friction device may include a backing plate 2. In the illustrated example, the backing plate has a substantially arcuate shape so as to permit the friction device to interact with a wheel tread or wheel surface 91 of a wheel of a vehicle (shown in FIG. 12). In the illustrated example, a steel railway vehicle is contemplated. The friction device may include a keybridge 4. The backing plate may include one or more rejection lugs 6a, 6b. An opening 8 in the keybridge may accept a locking key (not shown) which fastens the friction device to the vehicle brake head. The friction device may include a friction structure 20. At least a part or portion of the friction structure may be made of a composite friction material. The friction structure of the friction material may include a flange side 22 facing toward a flange 92 of a wheel 90, a rim side 24 facing toward a rim 93 of the wheel, and first 26 and second 28 opposing ends. The flange and rim sides may extend along the length of the friction device, and the opposing ends may extend between and connect the flange and rim sides. A central longitudinal axis I-I (see FIGS. 3-9) substantially bisects the friction device between the flange side and the rim side. The friction material forms a brake surface 30 or working surface of the friction device.

Suitable backing plates may be made of metallic material or non-metallic material, or a combination or composite material. Suitable metallic materials may include iron and iron alloys. Suitable iron alloys may include steel. In one example, the backing plate may be made of a reinforced composite material. The backing plate may be coated. Suitable coatings my include galvanic coatings (particularly if the backing plate is formed of a corrodible metal), paint, and anodized layers. Suitable paints include enamel, epoxy, and powder coatings. The backing plate may be curved axially so as to follow the curvature of a wheel. The axis for the curve may be a wheel axis. In one example, the friction structure is curved and is coaxial to the wheel, while the backing plate follows the curve of the friction structure to be coaxial to the wheel. In another example, the backing plate is curved but is not coaxial with the wheel or with the working surface of the friction structure. The degree of separation of the curvature of the backing plate relative to the friction structure may be selected based on application specific parameters.

The backing plate may have surfaces that are relatively smooth and may have one or more defined apertures therethrough and/or protrusions extending therefrom. In one example, the backing plate is undulate so as to increase its surface area. An increased surface area may provide more bonding surface to which the friction structure may bond. The undulations may be dispersed evenly across the backing plate or may be patterned so that some undulations are at a proximate edge, or some undulations are concentrated nearer the center line. The undulations may run the length of the backing plate or may be oriented widthwise. Undulations may impart stiffness in the direction of their run, and flexion perpendicular to their run. In one example, the undulations direction is skew relative to the length and the width of the backing plate. In one example, a checkered pattern or equivalent is present to allow for control over the stiffness and the flexion of the backing plate while still increasing the surface area. Various patterns and similar effects can be created by selecting either a uniform thickness of the backing plate (and thus by bends in the plate) or by using non-uniform thicknesses across the backing plate.

In one example, the width of the backing plate is the same as the width of the friction structure. In another example, the width of the backing plate differs from the width of the friction structure. A backing plate that is smaller than the width of the friction structure may be sufficient to perform the support function of the backing plate, while reducing overall weight and/or cost. A backing plate that is larger than the width of the friction structure may be sufficient to perform the support function of the backing plate, while providing enhanced support to edges of the friction material. In one example, the width ratio of the backing plate to the friction structure, the length ratio of the backing plate to the friction structure, and the ratio of the backing plate's thickness to a starting thickness of the friction structure is, independently of each other, in a range of less than about 0.5, in a range of from about 0.6 to about 0.9, about 1, in a range of from about 1.1 to about 1.2, in a range of from about 1.2 to about 1.5, or in a range of greater than about 1.6. Suitable backing plate configurations may include a full unbroken plate, a mesh, a wire form, a reinforced wire form, a mesh, or a molded composite.

In one example, the width of the brake shoe's friction structure's working surface relative to the wheel tread (which includes at least a portion of the wheel flange that touches the brake shoe during use) is in a range of less than about 35%, in a range of from about 36% to about 50%, in a range of from about 51% to about 75%, in a range of from about 76% to about 100%, or greater than about 101%. A suitable brake shoe width may vary from side to side or from end to end. A suitable shape of the friction structure may follow a contour of wheel, having a matching complimentary profile. This shaped edge may be formed with one or more of a chamfer, ridge, edge, or radius. In one example, only one edge of the friction structure is contoured. In another example, both edges are contoured to allow for installation in either orientation. In one example, the brake shoe is configured to fit to a new railway vehicle wheel having a diameter in a range of less than about 600 mm, in a range of from about 601 mm to about 1300 mm, or in a range of greater than about 1301 mm.

A pair of the rejection lugs are shown in the illustrated example. The rejection lugs may be integrally formed with the backing plate and may extend from a top surface of the backing plate. The rejection lugs may be sized and positioned in such a way so as to mate with corresponding rejection lug receptacles (not shown) on a corresponding brake head (not shown). In one example, the rejection lugs may be compatible with a variety of brake heads. In one example, the lugs may only correspond with a certain type of brake head in order to prevent the installation of the brake shoe on an improper brake head; or may be reversibly installable to prevent mis-installation; or may be designed so as to only fit with the brake head to insure it is only possible to install in the correct orientation.

In one example, the keybridge may be integrally formed with the backing plate or it may be attached to the backing plate prior to installation. The keybridge may be formed of materials similar or the same as the backing plate, discussed above. The keybridge may be coupled to a brake head (not shown) of a vehicle. In one example, the keybridge may be circular. In one example, the keybridge may be square. Based at least in part on application specific parameters, another keybridge may be shaped to facilitate fastening of the keybridge to the brake head. Suitable coupling methods for the keybridge include welding, mechanical fastening, press or friction fitting, and the like.

An example of a suitable friction structure is a brake pad. The brake pad may be useful to slow or stop a vehicle. Suitable vehicles may include automobiles, trucks, busses, mining equipment, aircraft and railway vehicles. Railway vehicles may include locomotives and railcars and may be for transport of freight and/or passengers. The friction structure may be formed of a composition friction material.

In one example, a suitable friction material is rated for a Rubbing Pressure (RP) in a range of less than about 800 N/cm², in a range of from about 801 N/cm² to about 1000 N/cm², in a range of from about 1001 N/cm² to about 1500 N/cm², or greater than about 1501 N/cm². In one example, a suitable friction material is rated for a Rubbing Speed (RV) in a range of less than about 20 m/s, in a range of from about 21 m/s to about 30 m/s, in a range of from about 31 m/s to about 50 m/s, or greater than about 51 m/s. In one example, a suitable friction material is rated for Continuous Temperature operation (CT) in a range of from about 300°° C. to about 350° C., from about 351° C. to about 400°° C., from about 401° C. to about 450° C., or greater than about 451° C. In one example, a suitable friction material is rated for Short Term Temperature (ST) in a range of from about 500° C. to about 600° C., from about 601° C. to about 700° C., from about 701° C. to about 800° C., from about 801° C. to about 900° C., or greater than about 901° C. The preceding ranges are based at least in part on, and determined by, the friction material selection, the physical configuration, and the end use application of the friction device.

In other examples, a suitable friction structure may include be semi-metallic. Semi-metallic may include a non-metallic matrix, such as a ceramic or a polymer, with a metallic filler. For example, a semi-metallic puck of iron or copper powder may be bound together by a ceramic or polymer. The fill content may be selected based at least in part on the desired performance of the friction material and friction structure made therefrom. Suitable filler content may be expressed as a ratio of metallic material to matrix material by volume or by weight. In various examples, a suitable ratio may be in a range of less than 50% by weight, in a range of from about 51% to about 75% by weight, from about 76 to about 90% by weight, or greater than 91% by weight. For example, a suitable formulation may be 90 grams of metal per 10 grams of matrix. In various examples, the fill content for the friction structure may be metal, as disclosed, a non-metal, or a combination of metal and non-metal materials.

The ceramic/iron materials may be mixed, compressed and/or sintered at a high temperature to form a solid friction structure. Suitable binding or matrix materials may include one or more of resin (such as phenol formaldehyde), graphite (which can also serve as a friction material, zirconium silicate and the like. An example formulation, including binder, is shown in Table 1.

| Constituent | Approx. range % by weight |
|---|---|
| Aluminum Silicate | 25-35 |
| Bronze particles | 10-20 |
| Graphite | 5-15 |
| Vermiculite | 10-20 |
| Phenolic resin | 10-20 |
| Steel fibers | 3-7 |
| Rubber particles | 3-7 |
| Silicon dioxide particles | 1-5 |
| Aramid fibers | 1-5 |

The powder size, fiber size, concentration distribution, grain size distribution, and morphology may be selected or controlled to affect performance of the friction structure. If the fill content is a powder, suitable powder size averages may be in a range of less than 100 micrometers, in a range of from about 101 micrometers to about 250 micrometers, in a range of from about 251 micrometers to about 500 micrometers, or greater than about 501 micrometers. The grain size distribution may be in a range of from about 0.5 to about 1, from about 1 to about 2, or greater than about 2 as a distribution relative to mean particle size. The morphology of the particles may be selected from suitable shapes. Suitable shapes may include spherical, ovoid, irregular, flake, and polygonal. In some examples the more surface area of the particle, the lower the friability of the friction structure; and in other examples, the more edged particles provide relatively more aggressive friction and conditioning than the smoother or rounder particles. The hardness of the material selected as the filler powder, in combination with the filler content, and particle morphology can contribute to the performance of the friction structure. If the fill content is a fiber, the fiber thickness and fiber length may be selected or controlled to affect performance. The fiber may be the same material as the powder fill content, and the fill content may be a mixture of powder and fiber in one example. Other suitable fibers may be formed from an aromatic polyamide or aramid, such as Kevlar™, Twaron™, Nomex™, and Technora™. Other suitable fibers may be formed from an aliphatic or semi-aromatic polyamides, such as Nylon™. Polymeric fibers may include one or more copolymers to control and affect crystallinity, melting or softening points, and the like. The length of the fibers may be controlled to affect performance. Suitable fiber lengths may be in a range of less than about 1 millimeter (mm), in a range of from about 1.1 mm to about 2 mm, in a range of from about 2.1 mm to about 5 mm, or in a range of greater than about 5.1 mm. Fiber thickness may be selected to control and affect performance. Suitable fiber thickness may be in a range of from about In one example, the fibers have a Denier in a range of less than about 20d, in a range of from about 21d to about 100d, in a range of from about 101d to about 500d, in a range of from about 501d to about 1500d, in a range of from about 1501d to about 3000d, or greater than about 3000d selected based at least in part on application specific parameters.

Suitable polymer or polymeric matrices may include phenolics, urea-formaldehyde, epoxy, cyanate ester, aromatic heterocyclics (such as Polyimides, polybenzoxazoles (PBOs), polybenzimidazoles, and polybenzthiazoles (PBTs)), inorganic and semi organic polymers (such as may be derived from silicon-nitrogen, boron-nitrogen, and phosphorus-nitrogen monomers), and silicon-based polymers, as well as mixtures and copolymers of the foregoing. The polymeric matrix, along with other additives, may include a flame retardant. Suitable flame retardants may include a composition that includes one or more of aluminum, phosphorus, nitrogen, antimony, chlorine, bromine, and in some applications magnesium, zinc and carbon.

A suitable friction structure may be affixed to and extends from the backing plate along the surface opposite the rejection lugs and keybridge. In one example, to be affixed to the backing plate the friction structure may include an adhesion layer (not shown) to facilitate proper fixture to the backing plate. In one example, the friction material is affixed via mechanical means with, or without, an adhesive layer. The friction structure may be affixed to the backing plate by means that may be selected based at least in part on the application specific parameters.

A suitable friction structure may include an outer layer that is the first to contact a wheel surface when newly installed. This outer lay may perform one or more of the following functions: prevent exposure of the friction material during storage, transport or installation to corrosion, chipping, moisture or fouling; provide an initial coating to the wheel surface on the first few rotations after installation and braking to condition or treat the wheel surface; to condition the wheel surface and remove any debris or corrosion; to fill in cracks, pits and defects in the wheel surface; and the like. In one example, the outer layer is removed from the working surface of the friction structure through friction in the first few rotations during braking after installation. In one example, the outer layer is peeled off after installation or a part of the installation process.

The brake surface of the friction structure may contact the vehicle wheel tread to apply a braking force to the vehicle. In one example, the brake surface may contact a portion of the vehicle wheel flange and/or wheel rim. In one example, the brake surface may contact all of the flange and all of the rim. In one example, the wheel tread, wheel flange, and wheel rim may be all parts of the wheel surface or wheel tread surface to which the brake shoe may be applied. Contact to the wheel flange and wheel rim still applies a braking force to the vehicle, however, contact on these parts of the wheel serve to prevent hollow wheel wear. The friction structure takes the arcuate shape of the backing plate so as to interact against a vehicle wheel or wheel tread. In one example, the brake surface may take the arcuate shape of the backing plate. The friction structure may provide the required friction and braking effort when forced against the wheel or the wheel tread.

The friction structure may include one or more wear indicators. In one example, the wear indicators are molded into the friction material of the friction structure. A suitable location for the wear indicator is at the back of the shoe. Depending on the embodiment, the backing plate itself may be the wear indicator or may have material removed to allow a wear indicator to become visible. Other suitable locations for wear indicators may include proximate to an end, around a periphery, at the centerline of the friction structure, at an distal end (or both ends) of the friction structure, as a part of a conditioning insert, or the like. During use, the wear indicators allow an observer to determine useful life of the friction structure. In one example, a groove is formed in the friction structure from the working surface down to a determined depth. During use, the depth of the groove diminishes as the working surface is worn away. An observer would then look for the groove and determine life by its remaining depth (or absence if it was at end of life and completely worn away). Other examples of wear indicators may include a differently colored portion of the friction structure. Or the conditioning insert can be configured to perform the wear indication function. In one example, an RFID chip (or equivalent) is disposed in the friction structure at the depth for which the end of life is set for the friction structure. When the friction structure is worn to expose the RFID chip, the chip will no longer function and provide a signal in response to a query (for passive chips, active chips may broadcast signals and the absence of a broadcast signal would indicated end of life). Naturally, an RFID sensor would communicate with the wear indicator chip and thereby one could determine when a brake change was needed.

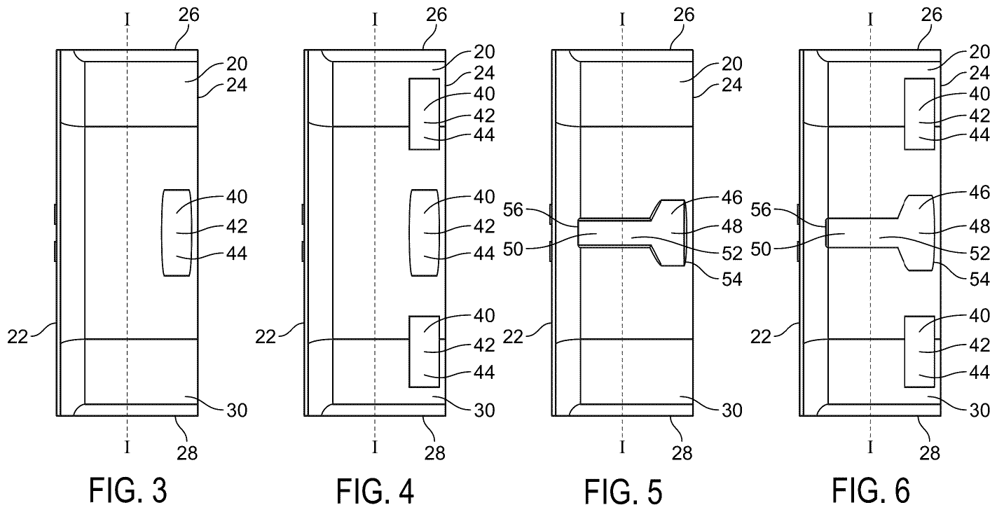

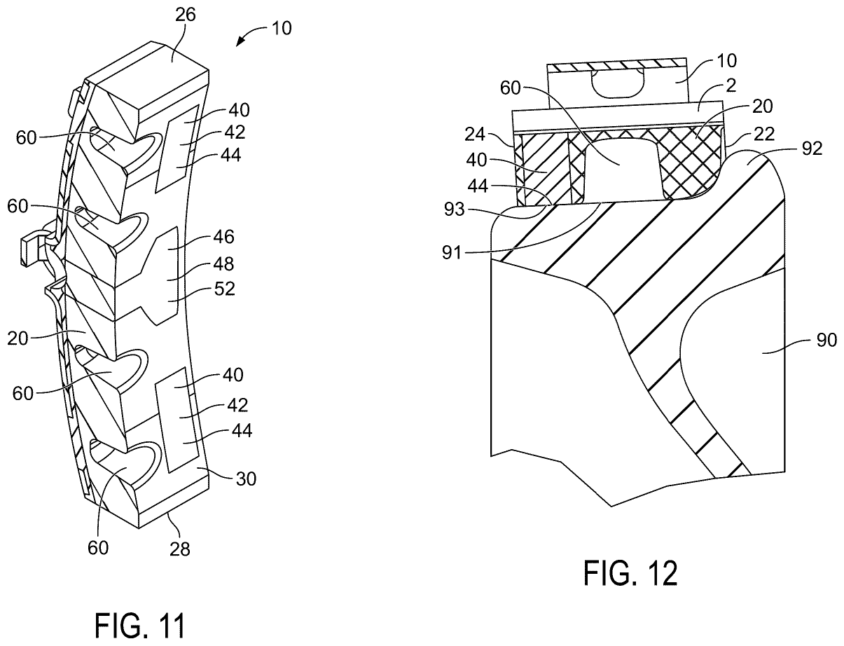

Referring to FIGS. 2-12, at least one conditioning insert 40 may be disposed in the composite friction material of the friction structure. Examples of the conditioning insert may have selected shapes and be disposed within the friction structure. These shapes may be influenced and/or dictated by application specific parameters. As one example, the conditioning insert may include an elongated portion 42. As shown in FIGS. 3 and 4, the elongated portion has a conditioning surface 44 and extends along the brake surface adjacent to and substantially parallel with the rim side of the friction structure. In this configuration, the conditioning surface of the conditioning insert may be in a position to control an amount of wear of a wheel tread proximate to the rim of a wheel of a vehicle.

In one example, the conditioning insert may be disposed at least partially within the friction structure with the conditioning surface exposed to and substantially flush with the brake surface. In other examples, the insert may be fully encapsulated within the friction structure of the brake shoe. In instances where the composite friction material fully surrounds and encapsulates the conditioning insert, repeated braking of the vehicle may wear away the composite friction material eventually exposing the conditioning surface of the conditioning insert to the wheel of the vehicle. In one example, the conditioning surface may be arcuate in shape so as to permit conditioning of the vehicle wheel. Depending on its alignment with the wheel rim, the conditioning surface may be shaped to condition the rim of a wheel.

A conditioning insert material and other parameters may be selected with reference to the conditioning function and the friction material may be selected with reference to the braking or friction function. Thus, they may contain similar materials in some examples, but the compositions differ such to perform their intended function. This difference may be substantial (e.g., a metal conditioning insert within a composite friction structure) or may be relatively subtle (e.g., both are ceramic iron metal-filled structures, with one having a different concentration of metal content). In one example, the conditioning insert may be formed of a material relatively harder and/or more abrasive than the friction structure. For example, the wheel conditioning insert may be formed of a material with suitably abrasive properties for the wheel conditioning insert. As the brake shoe may be applied to the surface of a wheel, the wheel conditioning insert rubs against the wheel surface. The abrasive properties of the insert conditions the wheel surface to prevent, reduce, or remove defects.

A suitable wheel conditioning insert may be formed from a relatively hard material. Suitable materials may be metal. Suitable metal may include one or more of Al, Si, P, S, Cl, Ti, V, Cr, Mn, Fc, Co, Ni, Cu, Zn, Mo, Sn, Sb, Tl, and oxides, carbides, and alloys of the foregoing. In one example, the metal is iron or an iron alloy. Suitable iron, and iron alloys, may include those as used in, and process to form, cast iron, forged iron, wrought iron and the like. Suitable cast iron may include malleable cast iron or ductile cast iron. Other suitable iron inserts include treated iron, regardless of its manufacturing process. Suitable treated irons may include phosphated iron, nitrided iron, heat treated iron, and the like. Some steels may be used in various examples. The steel may have controlled amounts of carbon and/or chromium, as well as a controlled ratio of martensite relative to cementite structure. Selecting the alloy content may control the hardness, and therefore the performance of the conditioning insert. In other examples, the conditioning insert may include a non-ferrous metal. Some metals, such as Cr, may be used in controlled amounts based on regulatory standards or other third-party restrictions.

In other examples, a suitable conditioning insert may include a non-metallic matrix, such as a ceramic or a polymer, preferably with a metallic filler. For example, a puck of iron powder or iron filling filled ceramic may be used. The iron may be the same, or different, from the identified suitable iron types. The fill content may be selected based at least in part on the desired performance of the conditioning insert. Suitable filler content may be expressed as a ratio of metallic material to matrix material by volume or by weight. In various examples, a suitable ratio may be in a range of less than 50% by weight, in a range of from about 51% to about 75% by weight, from about 76 to about 90% by weight, or greater than 91% by weight. For example, a suitable formulation may be 90 grams of iron powder per 10 grams of ceramic matrix. The ceramic/iron materials may be mixed, compressed and sintered at a high temperature to form a solid conditioning insert. The powder size and grain size distribution may be controlled to affect performance, as well. Suitable powder size averages may be in a range of less than 100 micrometers, in a range of from about 101 micrometers to about 250 micrometers, in a range of from about 251 micrometers to about 500 micrometers, or greater than about 501 micrometers. The grain size distribution may be in a range of from about 0.5 to about 1, from about 1 to about 2, or greater than about 2 as a distribution relative to mean particle size. The morphology of the particles may be selected from suitable shapes. Suitable shapes may include spherical, ovoid, irregular, flake, and polygonal. In some examples the more surface area of the particle, the lower the friability of the conditioning insert; and in other examples, the more edged particles provide relatively more aggressive friction and conditioning than the smoother or rounder particles. The hardness of the material selected as the filler powder, in combination with the filler content, and particle morphology can contribute to the performance of the conditioning insert. In one example, the wheel conditioning insert may be formed of a material relatively harder and/or more abrasive than the friction material. For example, the wheel conditioning insert may be formed of a material with suitably abrasive properties for the wheel conditioning insert. As the brake shoe may be applied to the surface of a wheel, the wheel conditioning insert rubs against the wheel surface. The abrasive properties of the insert conditions the wheel surface to prevent, reduce, or remove defects.

The conditioning insert may cover an area proximate to a rim side and/or a flange side of the friction device or brake shoe. The conditioning insert may cover or extend from a peripheral edge toward a center of the brake shoe. Suitable conditioning inserts may be positioned within the friction structure at a surface of the brake shoe that contacts the wheel surface or may extend to a determined depth in the friction structure. In one example, the conditioning insert may extend through the friction structure from the brake surface to the backing plate. In one example, the conditioning insert may rub against the wheel rim to reduce hollow wheel wear as the wheel operates. The conditioning insert may condition the part of the wheel rim in contact therewith while rubbing. By providing the conditioning insert along the rim side of the wheel, responsive to the friction device engaging with the wheel, the conditioning surface may engage and wear at the wheel rim. As a result, the wheel rim may experience an amount of wear that is greater than an amount of wear the wheel rim otherwise would experience during operation of the vehicle. This additional wear may result in the diameter of the wheel along the rim decreasing at a rate closer to that of the diameter of the wheel along the tread. Because the diameters of the wheel along the tread and along the rim may be decreasing at more similar rates, the rate at which hollow wheel wear occurs becomes slower thus increasing the lifespan of the wheel.

As shown in FIG. 4, multiple conditioning inserts, each having an elongated portion, may be disposed along the rim side of the friction structure. Each conditioning insert includes a conditioning insert surface thereby providing multiple conditioning surfaces 44 to wear away at the wheel rim, thus further decreasing the difference in the rate of wear between the wheel tread and the wheel rim.

Although three rectangular wheel conditioning inserts are shown, other examples may have a different number of wheel conditioning inserts utilized along the rim side that is determine with reference to application specific parameters. Further, in other examples, these inserts may have a shape other rectangular and selected to condition the wheel rim. Other suitable shapes may be selected with reference to the desired performance, but polygonal and ovoid shapes may be broadly useful across use types. The wheel conditioning surface may remove imperfections from the wheel when in use and/or may impart a coating layer on the subsequently conditions surface. The shape of the insert, the number of inserts, the insert material, and other factors (such as volume, weight, density, and end use application) may be selected to achieve a desired and proportional effect from the insert.

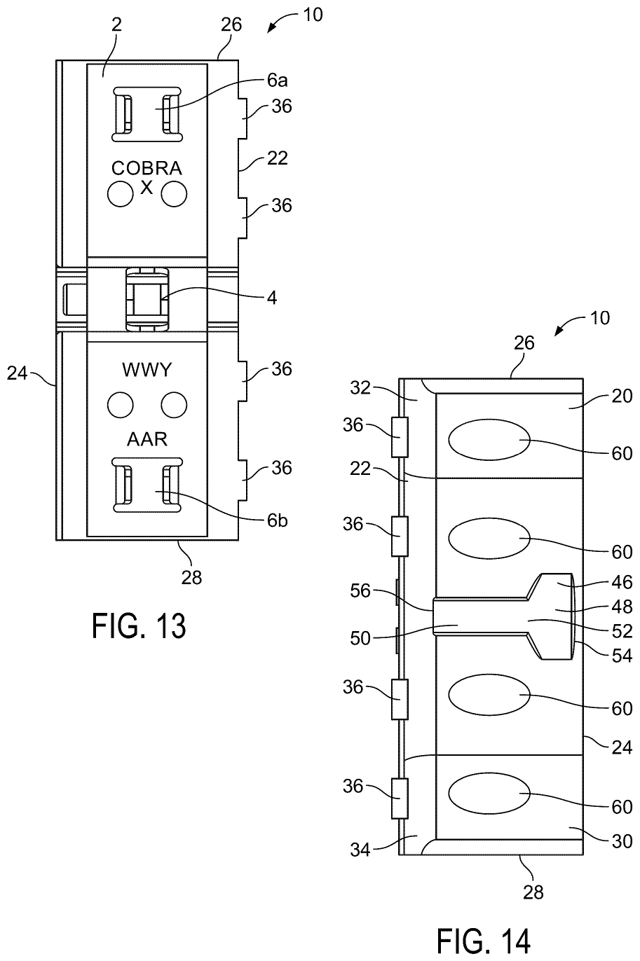

In one or more examples, the conditioning insert 46 may have a T-shape, such as illustrated in FIG. 5. The conditioning insert may have a first elongated portion 48 and a second elongated portion 50 both of which form a conditioning surface 52. The first elongated portion has an end 54 that extends along the brake surface adjacent to and substantially parallel with the rim side of the friction structure. The second elongated portion extends along the brake surface substantially perpendicular to the first elongated portion. The second elongated portion has an end 56 that may be adjacent to the flange side of the friction structure. In the illustrated example of FIG. 5, the central longitudinal axis I-I crosses the T-shaped conditioning insert substantially halfway between the end of the first elongated portion and the end of the second elongated portion. Alternatively, the T-shaped conditioning insert may be disposed at another location relative to the central longitudinal axis. With the first elongated portion adjacent to and extending along the rim side and the second elongated portion crossing the central axis I-I, the T-shaped conditioning insert may condition both the wheel tread and the wheel rim. This may condition the wheel tread, removing tread defects while simultaneously conditioning the wheel rim, removing rim defects and reduce a rate of hollow wheel wear.

To further reduce the rate of hollow wheel wear, one or more conditioning inserts may be disposed within the composite friction material of the friction structure along with the T-shaped conditioning insert. In other examples, more than two conditioning inserts may be disposed within the friction structure proximate the rim side to reduce an amount of hollow wheel wear. Other suitable shapes and configurations may include L-shaped, Y-shaped, and I-shaped inserts. The selection of the insert shape and configuration may be based at least in part on the end use application and other application specific parameters.

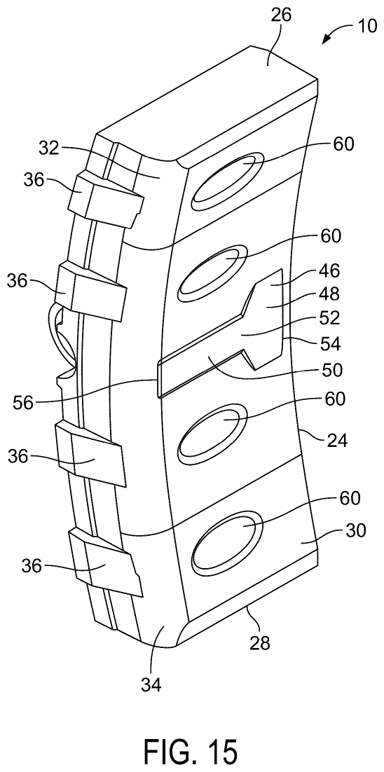

In one or more examples, the friction device may have plural conditioning inserts, and one or more of the inserts may have a shape and/or size that is different than a shape and/or size of one or more other inserts. For example, the friction device illustrated in FIG. 6 includes two rectangular shaped conditioning inserts and one T-shaped conditioning insert. The two rectangular inserts each have an elongated portion 42 disposed within the composite friction material along the rim side. The T-shaped conditioning insert is disposed between the two rectangular inserts along the central longitudinal axis, but alternatively the friction device may have an alternative number of conditioning inserts disposed in any alternative configuration. Additionally, the friction structure may include one or more voids 60 in the friction structure.

While the term “void” as used may sometimes indicate an entirely empty and hollow volume in some embodiments, in various other examples it may include materials other than the friction composite material. For example, the void may be filled with gas, a fluid, another material, etc., rather than a vacuum so as to be a true void. In examples where the void in the friction material is filled with a non-friction material filler material, suitable void filler materials may include metallic, inorganic and organic material. Suitable metallics include relatively softer metals. Example metals may include tin, zinc, lead, aluminum, copper and the like, as well as mixtures, oxides and alloys thereof. Suitable inorganic materials may include silicon and silicon-based oxides thereof; with yet other materials containing molybdenum or lithium in amounts and locations that lubricate and/or reduce wear. A suitable void filler may be a solid extreme-pressure and/or extreme-temperature lubricant. Suitable lubricants may include graphite and/or molybdenum disulfide to provide protection under heavy loadings. The solid lubricants may bond to the surface of the metal, and thereby reduce or prevent metal-to-metal contact and the resulting friction and wear when the lubricant film gets too thin. Solid additives such as copper or ceramic powder may be added to the lubricant for static high pressure and/or high temperature applications, or where corrosion might be a concern. These compounds may work as a release agent. Suitable organic materials may include carbon and polymeric materials.

The void filler polymeric materials can be homogeneous or can be composite or filled polymers. These filled polymers may include metals, such as that used for the conditioning insert, but in concentrations and/or morphologies that differ from the conditioning insert. In one or more examples, a metallic alloy of the filler material may be in an amount from about 5 percent to about 25 percent by weight. Alternatively, the filler material may comprise a metallic alloy and/or non-metallic alloys in alternative amounts. For example, in other examples, the filled polymers that constitute the void filler may include non-metallic aggregates such that the overall weight of the friction structure is less than one with no voids. If a relatively harder void filler is desired, particles such as silicon carbide, aluminum oxide or silicon oxide particles may be used. If a relatively softer void filler is used, then iron oxide or zinc oxide particles may be used. The selection of filler aggregate may include mixtures of different particles types, particle sizes, and particle size distributions. The binding agent may be selected, as well as the concentration of filler particles, to control and affect the action of the void filler and/or friction structure on the respective wheel surface, the overall weight of the friction structure, and the like.

The voids may constitute a varying amount of the working surface of the friction structure during the life of the brake device. In one example, the ratio of working surface (capable of contacting the wheel surface) and the cross sectional area of the void at the working surface is less than 5% (and in some cases zero at various life stages of the friction structure), in a range of from about 6% to about 10%, in a range of from about 11% to about 25%, in a range of from about 26% to about 50%, in a range of from about 51% to about 70%, in a range of from about 71% to about 80%, or in a range of greater than about 81%.

In one example, there may be more than one void. In one example, there may be less than about 50 voids. Note that the voids may be spaced at different thickness levels in the friction structure such that an unused friction structure has zero voids exposed, but a partially or fully used friction structure has some percentage of its working surface exposed as voids (absence of friction material). In one example, the voids are placed such that as the friction structure wears different locations of the wheel surface contact the friction structure owing to the void placement and thus exposure at that point in the life cycle. In one example, the voids define a channel that can run the length (or width) of the brake device. In some examples, the channel may operate to allow cooling air flow through the friction structure during use and may provide an egress for particulate and/or water if such are present during use.

Suitable void shapes may be circular, ovoid or ovular, or elliptical in cross sectional profile or shape. Other suitable void shapes may include T-shaped and X-shaped. In one example, the void is shaped as a cone, a hemi-sphere, a full sphere, a cylinder, a cube or cuboid, a triangular prism, a triangular pyramid, a pentagonal prism, a pentagonal pyramid, a tetrahedron, a hexagonal pyramid, parallel piped, hexagon, other prism, a torus, an ellipsoid, an icosahedron, and the like. The voids may be shaped based at least in part on the specific end use parameters. Suitable shapes may be polygonal. In one example, the shape may be capable of reducing some of the volume of composite friction material in order to reduce the wear applied to the wheel tread. The void, as shown, may be conical or tapered, having a larger cross-sectional area at the brake surface which tapers or reduces to a smaller cross-sectional area nearest the backing plate. In one example, the void may have a volume that is less than 5 percent of the volume of the friction material. In another example, the void may have a volume that is between about 5 percent and about 50 percent of the volume of the friction material. In another example, the void may have a volume that is greater than about 50 percent and less than about 75 percent of the volume of the friction material. The void may be elongated in a direction perpendicular to the axis I-I. Orienting an elongated void may have a technical effect of reducing wear of along a width of a wheel tread.

The presence of voids in the friction structure may lessen the amount of wear the brake shoe contributes to the wheel tread in some examples. The use of some void materials may contribute to conditioning, may lubricate, and/or may reduce weight. By varying the relative amount of available working surface area (brake surface) as the friction structure wears, the braking capacity of the brake shoe may be controlled. For example, if the void(s) is/are shaped so that the void cross-sectional profile decreases in response to wear of the friction structure the result may be a relative increase in working surface area, and more available braking capability. Conversely, a configuration may be selected such that the exposed void cross-sectional area increases in response to wear, and that may have the effect of reducing a braking capability of the brake shoe as it wears. In one example, the relative amount of working surface available remains constant during its use and irrespective of the amount of wear. Even as the working surface area remains constant the location(s) of the void(s) and the relative wear pattern caused by the complimentary working surface on the wheel surface may change.

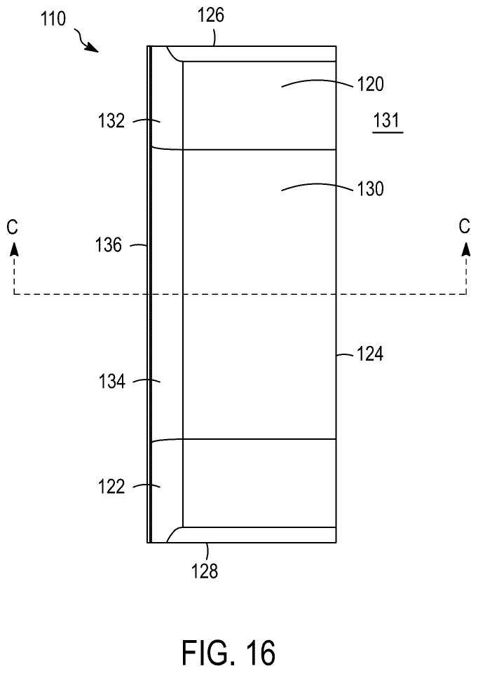

As shown in FIGS. 7-12, a friction device may have one or more voids in accordance with one or more examples. The one or more voids may be openings within the composite friction material or the friction structure. In one or more examples, one or more of the voids may be substantially bisected by the central axis I-I of the friction device. For example, the voids may be formed within the friction structure so as to be substantially aligned with the wheel tread of the wheel during use of the brake shoe. Alternatively, one or more of the voids may be offset from the central axis. In the examples illustrated in FIGS. 7 through 12, each of the voids has a substantially uniform circular shape but each void may alternatively have any unique and/or common shape and/or size relative to one or more other voids. The voids are essentially empty (other than atmosphere) such that the voids are openings along the brake surface and that extend from the brake surface a distance into the friction structure. For example, the voids lack material within its respective locations. This lack of the friction composite material at the voids may reduce a weight of the friction device, may reduce an amount of wear of the wheel tread from continually wearing away responsive to a braking force of the friction device being applied to the wheel.

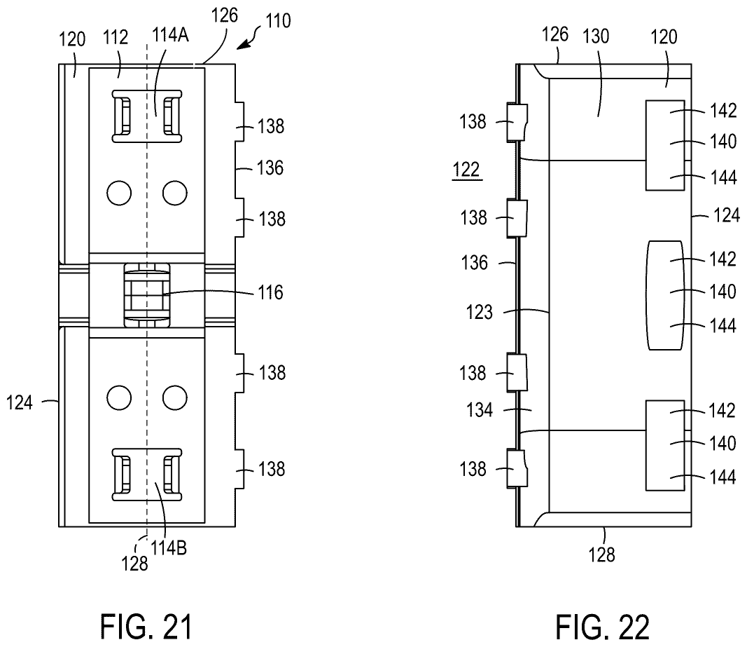

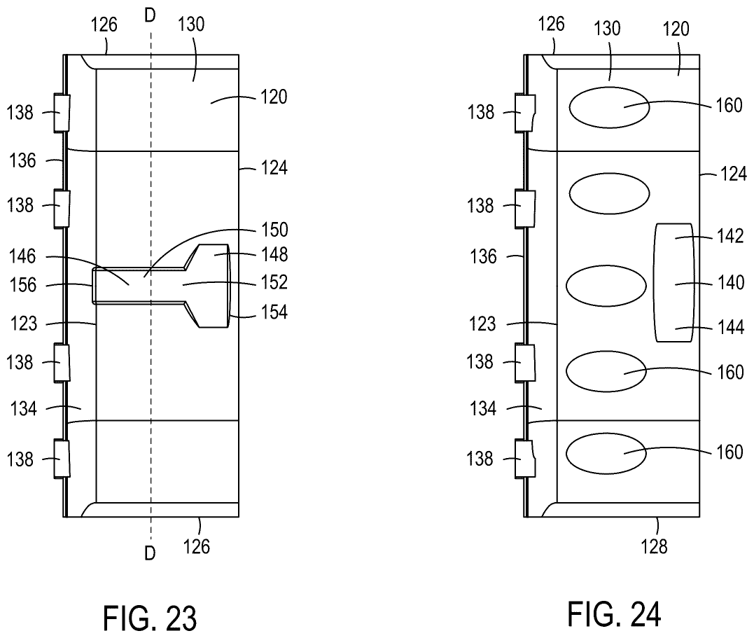

Referring to FIGS. 7-9, the friction device may include one or more voids and one or more conditioning inserts disposed within the friction structure along the brake surface. The voids and the conditioning inserts may be positioned adjacent to and substantially parallel with the rim side of the friction structure. The one or more voids may reduce an amount of wear to the wheel tread that would otherwise occur due to the braking force of the brake shoe while the conditioning inserts wear away at the wheel rim. Referring now to FIGS. 10 and 11, the conditioning insert may have a T-shape to control a location and an amount of wear to the wheel tread.

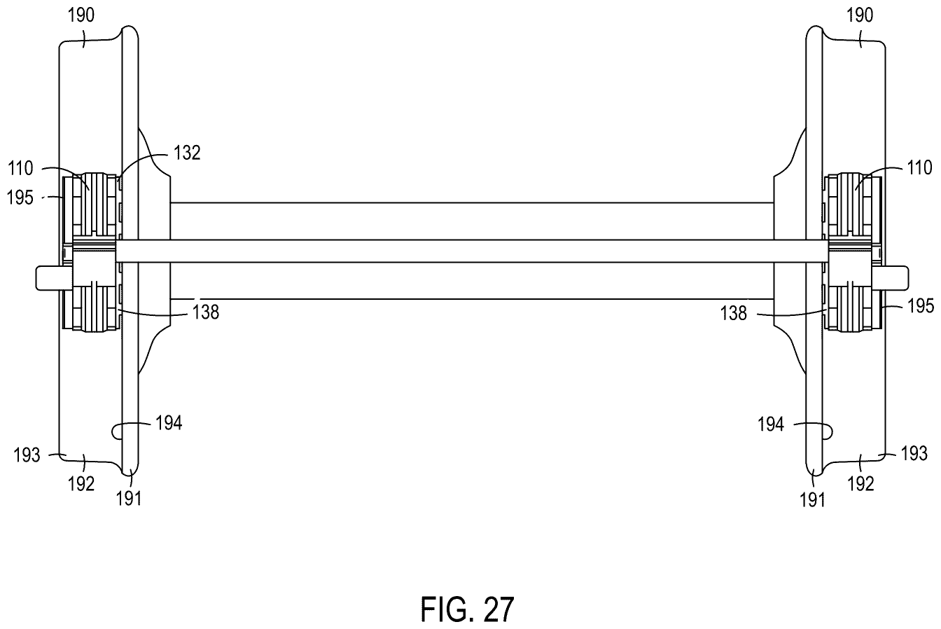

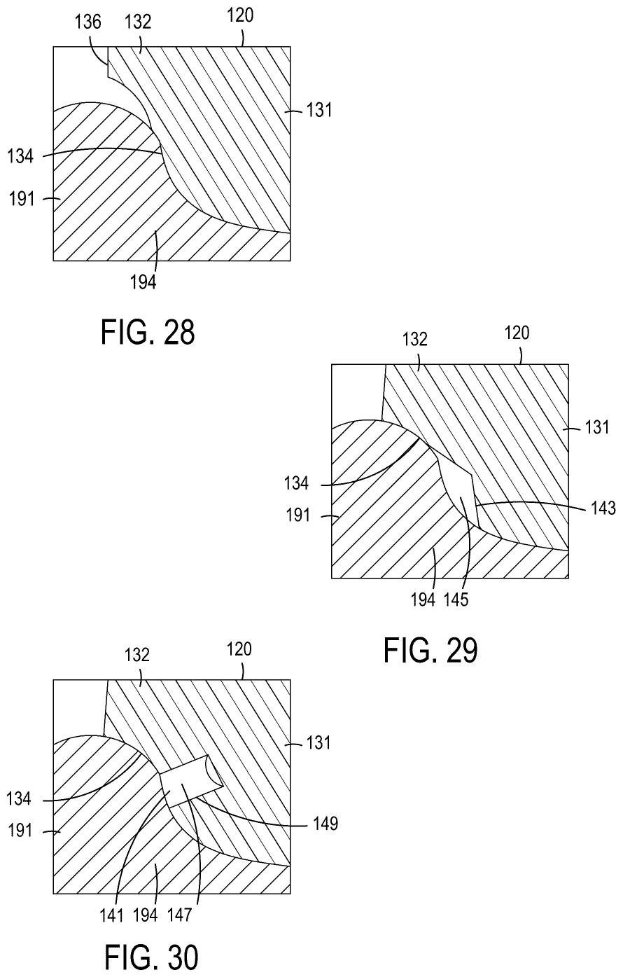

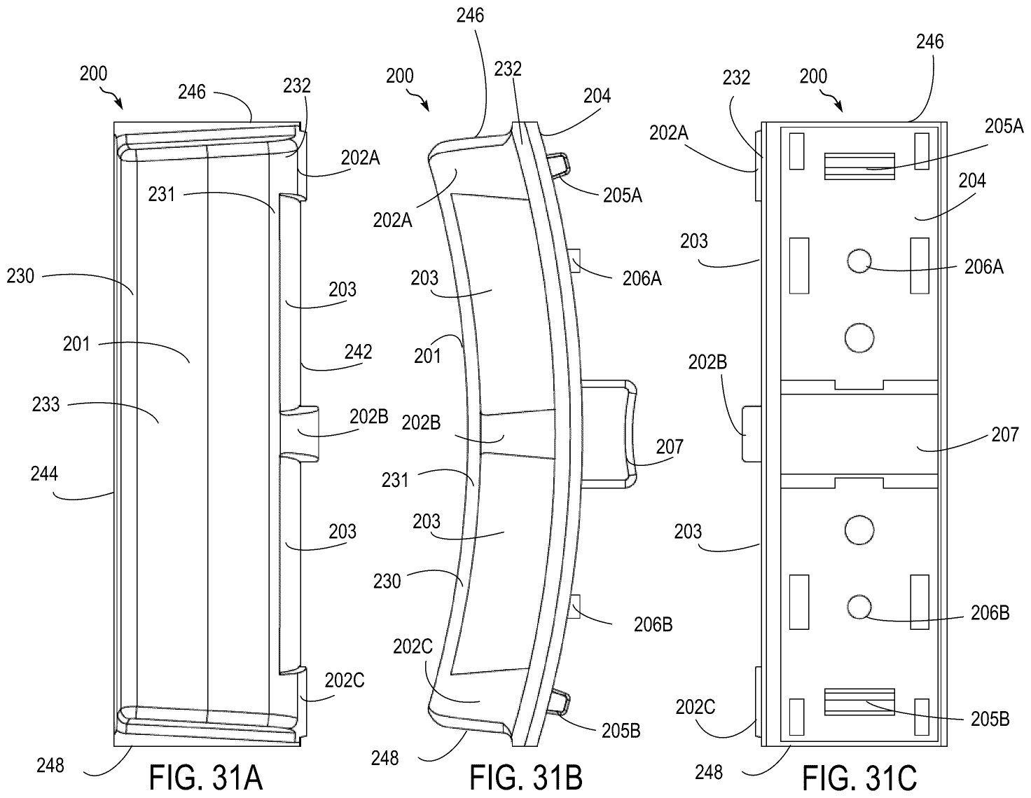

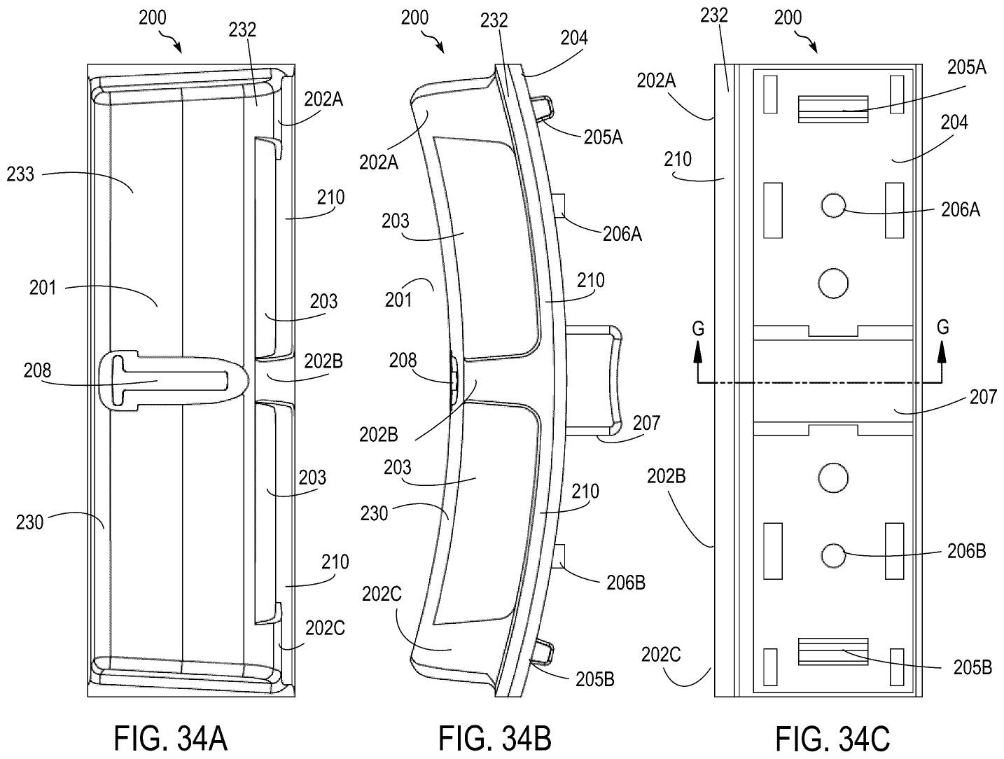

In one or more examples, the friction device may include additional components in order to facilitate proper braking, wheel wear, and/or alignment between the friction device and the vehicle wheel. For example, FIGS. 13 through 46 illustrate a friction device that includes additional components. One of the additional components may be an extended volume 32 (FIG. 14) of the friction structure that may extend from the flange side of the friction structure and a distance away from the flange side of the friction structure. The extended volume may at least partially engage, with a root (not shown) of the wheel flange in order to improve an alignment of the friction device against the vehicle wheel. The shape and size of the extended volume may be complementary with the wheel flange root, and it may include a surface 34 (FIG. 14) that may be complementary to the wheel flange root. This complementary surface may be arcuate or curved in shape to facilitate contact between the extended volume and the flange root across the length of the surface. Optionally, the extended volume may define one or more protrusions 36 (FIG. 13) that may engage the flange root or the flange of the wheel (not shown). In one example, these protrusions may be made of the same material of the friction structure but alternatively may be made of a different material. The protrusions may improve an alignment of the friction device with the wheel of the vehicle.

During use of a brake shoe without the extended volume, complementary surface, or protrusions, the flange side of the brake shoe may slide against a wheel flange during use. This results in an improper alignment of the brake shoe against the wheel. An improper alignment occurs when the brake surface may be not properly aligned with the wheel tread, and the first and second elongated portions of the T-shaped wheel conditioning insert may be not properly aligned with the wheel rim or the wheel tread. This improper alignment may be reduced in degree, or prevented entirely by use of an extended volume, complementary surface, and/or protrusions. By having the complementary surface and the one or more protrusions engage with the wheel flange root and/or wheel flange, the flange side may be prevented from sliding against the wheel flange during use of the brake shoe. The brake surface may be biased against or forced to remain properly aligned with the wheel tread, and wheel conditioning inserts may be forced to remain properly aligned with either the wheel rim or the wheel tread.

A shaped friction device may mitigate or prevent lateral migration of the friction device. By reducing lateral movement, this may reduce or prevent uneven or undesired wear of the friction device and/or undesirable interaction between the friction device and wheel. In one embodiment, the friction device may be “extra wide” relative to friction devices without an extended volume portion.

The region of the brake surface defined by the tread portion (e.g., the tread contact region) may engage the wheel tread during use of the friction device for braking. The tread contact region may be curved (e.g., be arcuate or have another non-planar or non-linear surface) in correspondence to the shape of the wheel tread. The flange contact region may be complementary in shape to at least part of the wheel flange. The flange contact region can be angled (e.g., at a non-zero-degree angle) relative to the tread contact region.

The extended volume portion may be initially manufactured (e.g., cast, machined, molded, printed, assembled, or otherwise formed) for the flange contact region. This volume portion can be located on an underside of the extended volume portion as part of the brake surface. The extended volume portion may be curved and otherwise dimensioned to correspond to the shape of the flange in a designated area of where the flange contact region will contact the flange when the friction device is installed (in a designated manner for operation) and then actuated for use against the wheel for a braking operation. Thereby, even when the friction device is first or initially used, the friction device may contact the flange in this manner for braking and alignment (e.g., alignment of the friction device relative to both the flange and wheel tread), as opposed to, for example, the friction device eventually wearing into a particular shape over time due to friction from repeated usage.

The friction structure may define both the brake surface generally and the flange contact region more specifically. For example, the curvature or other shape of the flange contact region may be formed in the friction structure. The flange contact region may be supported by the friction structure and may be continuous with the tread contact region of the brake surface. As opposed to, for example, a flange engagement surface being defined and supported by a metal U-shaped alignment flange, or the like, attached to the backing plate, or by some other element other than the friction structure.

The extended volume portion of the friction structure may be extended relative to the tread portion and wheel flange. For example, the extended volume portion may be attached to and laterally extend outward from the tread portion so as to at least partially overlap the flange when the friction device is installed for use. If the tread portion of the friction structure has the same width as a friction device without the extended volume portion, then the friction device may be characterized as being wider or extra wide. The same may be true where the tread portion of the friction structure is the same width as the wheel tread, as may be defined (for example) by the distance between the start of the flange root and the start of the wheel rim curvature on the rim side of the wheel. For example, the tread width may be the width of the surface between the flange root and the rim curvature (generally the tread surface is frustoconical, but in a plane coincident with an axis of the wheel the distance may be a straight line). Due to the extended volume portion that extends for partially overlapping and engaging with the flange, and where the tread portion of the friction structure is the same width as the wheel tread, the friction device may be wider or extra wide relative to friction devices that have a tread portion the same width as the tread but are lacking an extended volume portion.

The tread portion of the friction structure may be the same width as the wheel tread. Alternatively, a width of the tread portion may be at least 90% the width of the wheel tread, but narrower than the width of the wheel tread. In another embodiment, a width of the tread portion is at least 80% the width of the wheel tread but narrower than the width of the wheel tread. In another example, a width of the tread portion is at least 75% the width of the wheel tread, but narrower than the width of the wheel tread. In another example, a width of the tread portion is at least 70% the width of the wheel tread, but narrower than the width of the wheel tread. In another example, a width of the tread portion is from 70% to less than 100% of the width of the wheel tread. The particular width may be selected based on the material composition of the friction structure, the material (e.g., metal) composition of the wheel, a desired area of friction device-to-wheel contact (when the friction device is installed and used), and a desired level of friction to be obtained between the friction device and wheel during operation.

A maximum thickness of the friction structure at the longitudinal flange side of the friction structure (e.g., a maximum thickness of the extended volume portion at a terminating edge of the extended volume portion), after manufacturing of the friction device is complete but prior to use, may be from 30% to 75% of a maximum thickness of the tread portion of the friction structure (the portion that is positioned for contact with the wheel tread when the friction device is installed for use). The thickness may be defined by a distance between the backing plate (or an intermediate adhesive layer) and the brake surface along a direction normal to a plane of interface between the backing plate (or intermediate adhesive layer) and friction structure. In another embodiment, a maximum thickness of the friction structure at the longitudinal flange side of the friction structure, after the friction device is manufactured but prior to use, may be from 40% to 60% at least 40%, at least 50%, or the like, of a maximum thickness of the tread portion of the friction structure. In any such examples, thereby, the thickness of the extended volume portion may be a substantial fraction of the thickness of the tread portion of the friction structure, such that the extended volume portion may be an extension of the tread portion and that the flange contact region of the brake surface may be directly and primarily supported by the friction structure. This may be indicative of the extended volume portion (and thereby the flange contact region of the brake surface) contributing to braking over the life of the friction device, or some substantial portion thereof, considering that the flange contact region and extended volume portion may wear at a different rate (e.g., to a lesser extent) than the rest of the friction structure due to differences in forces on different portions of the friction device when the friction device is actuated for use in braking a vehicle.

The flange contact region of the brake surface, defined by the extended volume portion of the friction structure, may extend from the tread contact region of the brake surface in the direction of the longitudinal flange side of the friction device according to a first sectional curvature that matches the shape of the flange root (of the flange of the wheel arrangement with which the friction device is shaped, built, located, configured or designed for use). Continuing in the direction of the longitudinal flange side of the friction device, the flange contact region may include a straight section in correspondence with the shape of the flange. For example, the straight section may be linear along a cross-sectional line in the direction of the longitudinal flange side. Such a straight section can be a cross-section of an arcuately curved surface of the flange contact region as extending between the two ends of the friction structure. From the straight section, or if the flange contact region lacks a straight section, the flange contact region may transition to a different, opposite curvature (e.g., curves in an opposite or other direction), in correspondence with the shape of the transition to the top of the flange. In one aspect, the flange contact region may be S-shaped in a cross-section between the longitudinal rim and flange sides.

In an embodiment, the longitudinal flange side of the friction structure may be dimensioned to terminate no further than the top of the flange when the friction device is installed for initial use with a wheel. The terminal edge of the extended volume portion of the friction structure, as between the ends of the friction structure on the longitudinal flange side of the friction structure, may extend no further than the top of the wheel flange. In this manner, sufficient alignment may be achieved while keeping any overall increased manufacturing costs or complexity (of the friction device with the extended volume portion relative to friction devices otherwise similar but without an extended volume portion) to a minimum or otherwise reduced. In another embodiment, the longitudinal flange side of the friction structure may be dimensioned to terminate further than a top of the wheel flange, in the longitudinal flange direction away from the friction device, when the friction device is installed for initial use with a wheel. The terminal edge of the extended volume portion of the friction structure, on the longitudinal flange side of the friction structure, may extend to and past the top of the wheel flange. Such a configuration may be used, based on the shape/configuration of the wheel flange, if an additional degree of alignment is needed for the application in question. The longitudinal flange side of the friction structure may be dimensioned to terminate, in relation to the top of the flange, within plus or minus 25% of the total width of the flange, reflecting that relatively minor variances on either side of the top of the flange may not significantly affect alignment and braking functionality versus cost/complexity of manufacture.

The entirety of the extended volume portion of the friction structure may be backed by the backing plate. Alternatively, at least an outermost part of the extended volume portion, along the longitudinal flange side of the friction structure, may not be backed by the backing plate. Alternatively, the entirety of the extended volume portion may not be backed by the backing plate. The material of the extended volume portion may be thick enough to support itself and the flange contact region of the brake surface during use, without a backing (either partially or entirely) provided by a backing plate or other support member (e.g., metal support member). Such an arrangement or configuration may be desirable for reducing manufacturing cost or effort, for reducing the weight of the friction device, and/or for enabling use of the same or similar configuration of backing plate both for normal width applications (e.g., a friction structure that may be no wider than the width of the wheel tread) and extra wide applications (e.g., a friction structure that may be as wide as the width of the wheel tread and may have an extended volume portion that extends outwards on the flange side for engagement, during use, with the wheel flange).

A width of the unsupported portion of the extended volume portion of the friction structure, along a normal line extending between the rim and flange sides of the friction structure (lateral axis), may be greater than 0.001% of a total width of the friction structure and/or no more than 35%, no more than 25%, or the like, of the total width of the friction structure. In another embodiment, the width of the unsupported portion of the extended volume portion of the friction structure may be greater than 0% of the total width of the friction structure and no more than 25% of the total width of the friction structure. In another example, at least 75% of the width of the extended volume portion may not be supported by a metal backing plate or other metal support member.

The friction structure may comprise or include a shaped block-like body or bodies of the friction material and other materials/components, which may include the tread portion and the extended volume portion and together define the longitudinal flange side, the longitudinal rim side, the two opposing ends, an upper surface, and a lower or underside surface that defines the brake surface. The tread portion and the extended volume portion may be monolithic (e.g., integrally formed and comprised of the same friction material). This does not preclude one or both portions being provided with metal or other inserts (or other features) after being formed as a monolithic block or otherwise as part of the manufacturing process (e.g., the friction material may be deployed around one or more metal or other inserts disposed in a mold). As a monolithic element and in conjunction with the possible inclusion of inserts, regions of common material type (without grain boundaries at the micro level) may extend between the two portions. Optionally, the tread portion and the extended volume portion may include the same friction material but may be separately manufactured and then assembled or otherwise attached (e.g., by welding, thermocompression, use of an adhesive, use of mechanical fasteners, etc.). Alternatively, the tread portion and the extended volume portion may comprise different friction materials and may be separately manufactured and then assembled or otherwise attached. Optionally, the tread portion and the extended volume portion may be integrally formed, such as in a cast or mold, but comprise different friction materials, or the tread portion and the extended volume portion may include one or more common friction materials but regions of different materials. Each of the tread portion and the extended volume portion may comprise a single type of friction material (the same or different as between the two portions), or may comprise plural types of friction materials in different regions, layers, etc.

Regions of the friction material (or other materials) of the tread portion and the extended volume portion may differ in terms of composition, component materials, properties, etc., even if other regions of the two portions have the same composition, component materials, properties, etc. For example, regions of materials of the extended volume portion and the tread portion may have different friction qualities, different wear properties, different hardness levels, different heat transfer qualities, different colors (e.g., for wear indication), etc. For example, the outermost region of the extended volume portion (along the longitudinal flange side) may comprise a material composition that has different properties (e.g., is harder or softer) than those (e.g., hardness) of a material composition of the tread portion of the friction structure, so that the two portions exhibit different wear properties during use., different regions within the same portion (tread portion or extended volume portion) may differ in terms of composition, component materials, properties, etc. For example, the region of the extended volume portion that is positioned/dimensioned to engage the flange root during use of the friction device may comprise a material composition that has different properties than those of a material composition of the region of the extended volume portion that is positioned/dimensioned to engage the top area of the flange during use of the brake, e.g., again, so the two regions exhibit different wear properties during use. It may be desirable, for example, for different parts of the friction device to exhibit different wear properties so that the friction device wears evenly during intended use over the lifetime of the friction device, differences in material thickness and operational forces notwithstanding.

The tread portion and extended volume portion of the friction structure (e.g., body of friction material) may be integrally formed even if these portions are not wholly or partially comprised of the same friction material(s). For example, the two portions may be arranged in a common mold with each portion separately temporarily contained and comprising a different friction material. During subsequent manufacturing steps (e.g., heat and pressure treatment, curing, drying, sintering, etc.)

the two portions are allowed to intermingle at their interface, thereby bonding at the micro level, with some intermixing of the different materials at the interface.

The friction structure can define a pad or brake pad. The friction material forming the structure may have a longitudinal flange side, a longitudinal rim side, and two opposing ends, two longitudinal ends, and two lateral ends. At least the two longitudinal ends may have a plurality of protrusions that may engage with the composition friction material at a distance away from the backing plate. Additionally, or alternatively, the two lateral ends may include a plurality of protrusions that may engage with the composition friction material at a distance away from the backing plate. The plurality of protrusions may be elongated columns such as pegs with a base portion extending from the longitudinal ends and a head portion extending from the base portion. The plurality of protrusions may be elongated fins extending along the longitudinal ends. The lateral ends may further define at least one groove extending at least partially into the wheel conditioning insert to receive the composition friction material therein. In one example, the friction device may include one or more wheel conditioning insert disposed within the composition friction material. The at least one wheel conditioning insert may be formed of a material different than the composition friction material.

Another example of a friction device may include a backing plate adapted to interface with a brake head of a vehicle and a composition friction material disposed onto the backing plate to form a brake surface of the friction device for engaging a wheel of the vehicle. The composition friction material may have a longitudinal flange side, a longitudinal rim side, and two opposite ends. The friction device may include at least one wheel conditioning insert disposed within the composition friction material including a base portion having a first side nearest the backing plate, a second side extending from the first side in a direction toward the brake surface, and a longitudinal axis. A first insert body extends from the second side of the base portion and offset from the longitudinal axis in the direction of the longitudinal flange side. A second insert body extends from the second side of the base portion and offset from the longitudinal axis in the direction of the longitudinal rim side. The first insert body and the second insert body each comprise two longitudinal ends, two lateral ends, and a wheel conditioning surface for engaging the wheel of the railway vehicle.

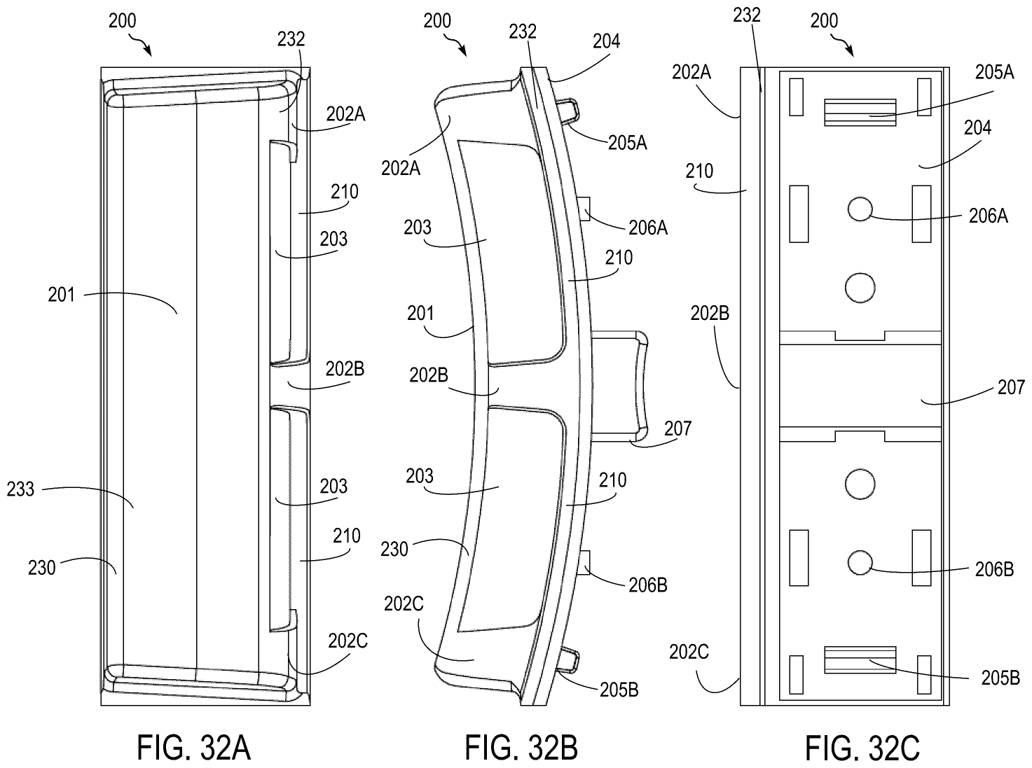

Referring to FIGS. 16-18, an example of a friction device 110 (e.g., a brake shoe) may include a backing plate 112 and a friction structure 120 (e.g., brake pad) disposed on the backing plate. The friction structure may comprise (e.g., be made or formed of, at least in part) a friction material. The friction structure may include a flange side 122 that may face in the direction of a flange 191 of a flanged wheel 190, a rim side 124 that may face a rim 193 of the wheel, opposite first and second ends 126, 128, and top and bottom surfaces. The flange and rim sides may extend along the length of the friction device, and the opposite ends may extend between and connect the flange side and the rim side. The bottom surface (e.g., underside) of the friction structure opposite the backing plate may define a brake surface 130. By controlling the selection of the material or materials that form the friction structure, the brake surface may exhibit selected (e.g., known and controlled) frictional characteristics in interaction with a wheel or other moving element when the brake surface is selectively brought to bear against (e.g., pressed against) the wheel or other moving element. For example, for a given material composition of the friction structure, there may be a higher degree of friction between the friction structure and the wheel for a given application force than if the friction structure was comprised of different materials. When the friction device is actuated for use, frictional interaction between the friction device and wheel converts kinetic energy of the wheel and vehicle into thermal energy (e.g., heat), thereby braking/slowing the wheel and vehicle. Thus, the brake surface may be dimensioned and/or otherwise configured so that when the friction device is installed and actuated for use in braking, the brake surface contacts the wheel in order to apply a friction force to the wheel. For example, if the wheel tread is frustoconical (as may be the case for rail vehicle wheels), the brake surface may be generally arcuate (along the long axis of the friction device) and slightly tapered (along a short or cross axis of the friction device) in correspondence.

The friction structure may include a tread portion 131 and an extended volume portion 132 (also referred to as a flange engagement portion or flange alignment portion). The tread portion can extend between the two ends and may extend from the rim side of the friction structure (where the tread portion at least partially defines the rim side) in the flange direction to where the friction structure meets the extended volume portion (e.g., along an interface region generally indicated by line 123 in the drawings). An underside of the tread portion defines a tread contact region of the brake surface. The tread contact region is arranged and configured (e.g., dimensioned and positioned) to engage the wheel tread when the friction device is installed for use and actuated for braking. The extended volume portion may extend between the two ends and out from the tread portion in the direction of the flange to terminate at and at least partially define the flange side of the friction structure. An underside of the extended volume portion may define a flange contact region 134 of the brake surface, which is complementary shaped to at least part of the flange (e.g., to a flange root 194 and/or to the top region of the flange). Thereby, the flange contact region may engage or about the flange (e.g., flange root and/or top region of the flange) during use of the friction device.

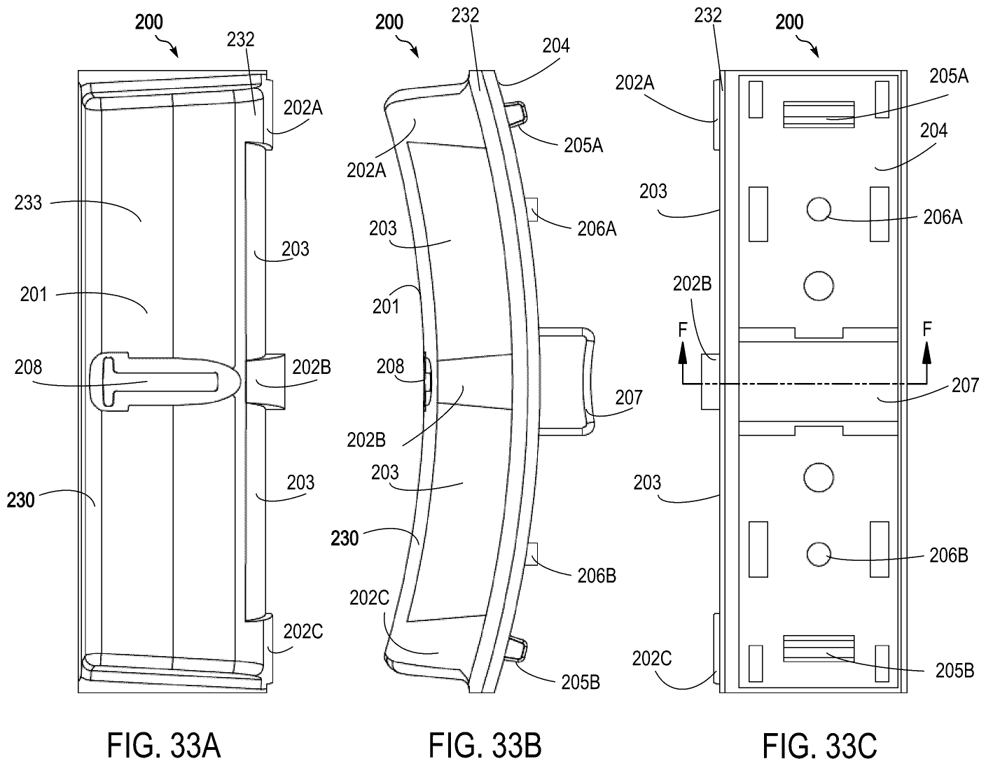

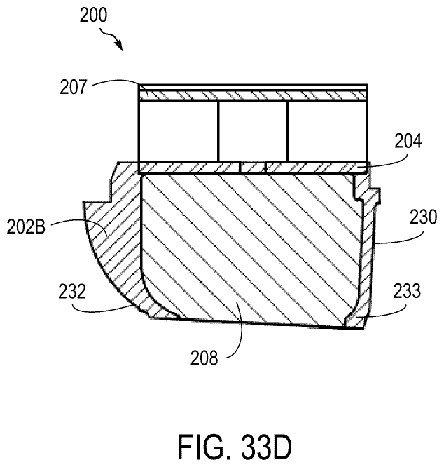

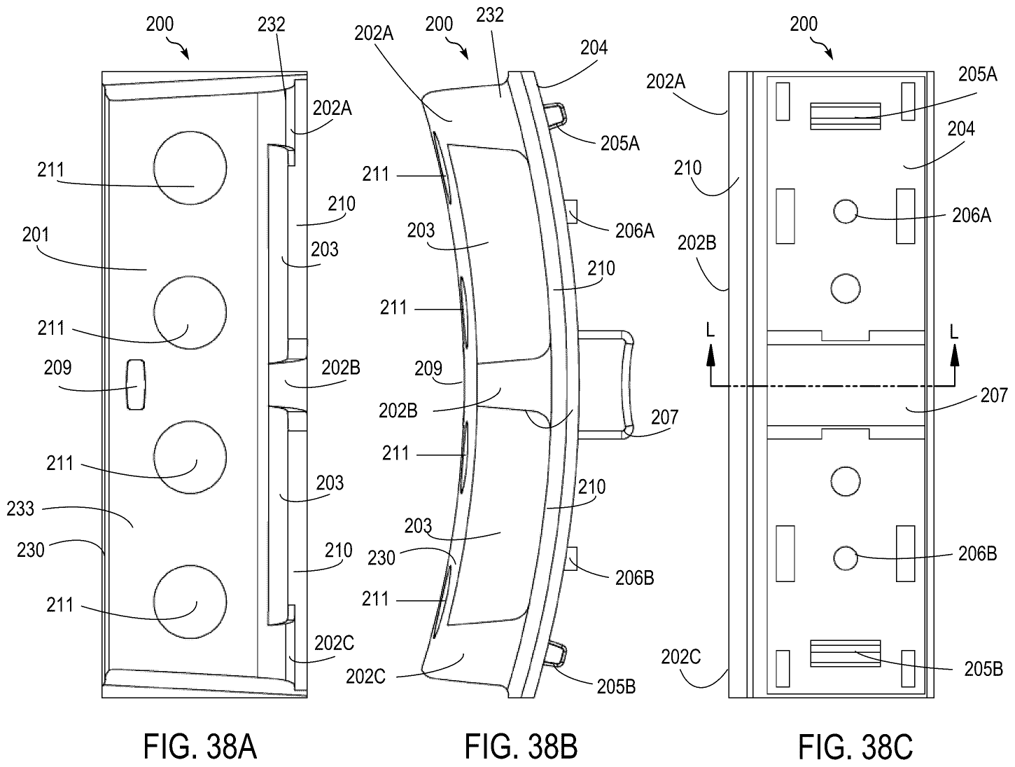

As shown in FIGS. 17-18, the flange contact region may be arranged and shaped to engage with and be complementary to the flange including the flange root. The extended volume portion may include an exposed surface 136. The bottom edge of the exposed surface may rest on the top of the flange while the flange contact region is engaged and in contact with the flange. The bottom edge of the exposed surface may still rest on the top of the flange when the flange contact region is engaged and in contact with the flange root. For example, the flange contact region may be shaped and disposed (e.g., positioned and dimensioned) to contact the flange root when the friction device is actuated, but not the top or top region of the flange. The extended volume portion may either terminate before reaching the top or top region of the flange, or even if the extended volume portion overlaps with the top region of the flange there is a space between the overlap of the extended volume portion and the top region of the flange when the friction device is actuated (see FIG. 28 as one example). In other examples, such as shown in FIG. 17, the flange contact region may contact both the flange root and the top region (e.g., top) of the flange when the friction device is actuated.

The flange contact region of the brake surface may be arcuate along the length of the friction structure between the ends to match the rounded (e.g., conical) shape of the wheel. Crosswise (e.g., from the perspective of FIG. 17), the flange contact region may be S-shaped, multi-segmented (e.g., a series of connected straight line sections, or a series of different connected curved sections, or a series of alternating straight and curved sections), or otherwise shaped to at least partially engage the flange during use. In examples, the brake surface may be configured for the entirety of the flange contact region to contact and engage the flange when the friction device is actuated. In other examples, the brake surface may be configured for only portions of the flange contact region to contact and engage the flange when the friction device is actuated. The flange contact region may be the region of the brake surface defined by the extended volume portion, at least part of which, and not necessarily all of which, may contact at least part of the flange during use of the friction device. The degree or extent to which the flange contact region contacts the flange during use of the friction device may change over time. For example, as noted above, and as shown in FIG. 28, the brake surface may be configured for the terminal edge portion of the flange contact region (e.g., as generally indicated by an edge 136) to not engage the top region of the flange while the friction device is actuated.

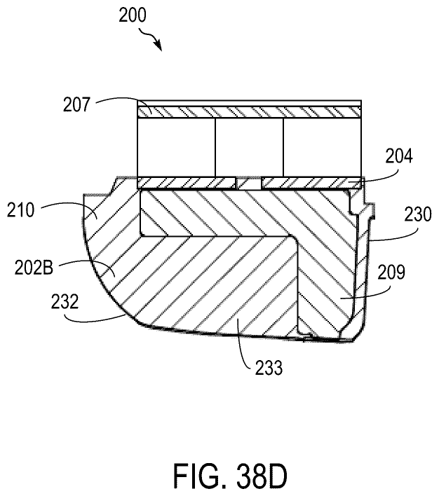

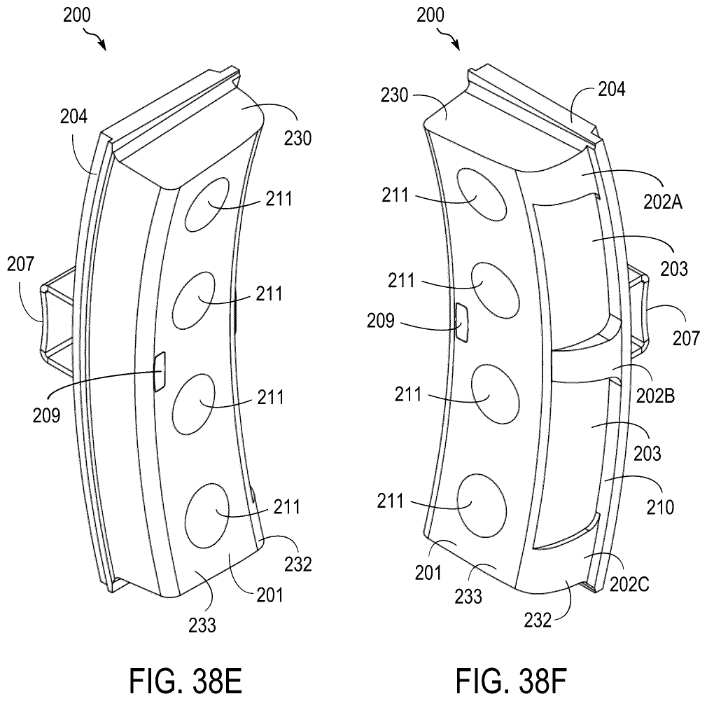

As another example, with reference to FIG. 29, the brake surface may be shaped for an intermediate portion of the flange contact region to lie away from (e.g., not contact) the flange when the friction device is actuated. In this example, from a cross-sectional perspective, the flange contact region of the brake surface may include multiple straight sections 143 that can form a trough-like notch or indentation in and along the extended volume portion of the friction structure. A gap 145 may be established between the extended volume portion and the flange in an intermediate area in between two contact areas while the friction device is actuated for use and the flange contact region contacts the flange. Alternatively, the gap could be a curved indentation or another shape of indentation, or there could be multiple different indentations of the same or different configuration. For example, as shown in FIG. 30, a gap could be established by a void 147 in the material with a circular or oval or other opening (e.g., the extended volume portion could include one or more voids each defined by a circular, oval, polygonal, or irregular opening 141 in the flange contact region of the brake surface), and an associated sidewall 149 extending from the opening into the material of the extended volume portion. It may be desirable to provide such features, in whole or in part as a function of friction device and wheel frictional interaction properties, to control or tailor the friction engagement and wear characteristics of the friction device and/or wheel over time. For example, with an indentation or void in the material (such as would establish an area of gap between the friction material and flange during use of the friction device), there could be less frictional interaction between the extended volume portion and the flange initially, but as the friction structure wore down over time, the gap might diminish and/or eventually entirely disappear, potentially increasing the degree of frictional interaction between the extended volume portion and flange. A tapered feature (e.g., indentation, void, etc.) could result in a gradually changing friction profile over time, where a feature (indentation, void, etc.) with a perpendicular side wall(s) (relative to the wear surface) could result in a substantially constant friction profile until the material around the feature wore down to the point where the feature was gone, at which point, if applicable (e.g., if there was still an underlying layer of friction material) there would be an increase in friction as a step-function.

The seating of the flange contact region on or against the flange (including, in examples, the seating of the exposed side generally atop the flange) may serve to keep the friction device in place against the wheel and aligned with the wheel tread. The seating of the flange contact region on the flange may, therefore, help prevent the lateral migration of the friction device toward the rim. Because the extended volume portion engages with the flange (e.g., with the flange root) during repeated use of the friction device, the extended volume portion may help prevent or slow the lateral migration of the friction device against the wheel flange. Additionally, the extended volume portion may help keep the flange side, rim side, and/or brake surface in proper locations against the wheel during use.

In the example of FIG. 17, the tread portion and the extended volume portion of the friction structure are integrally formed and comprised of the same friction material (e.g., the friction structure (including the two portions) may be monolithic). This does not preclude, however, the friction structure including tread conditioning inserts, or the like, disposed in the material in one or more examples. Additionally, from a cross-sectional perspective along at least part of the length of the friction device, the brake surface is continuous, with the region defined by the tread portion extending seamlessly into the region defined by the extended volume portion. There may be other regions of the brake surface, away from the portion shown in FIG. 17, that include seams, grooves, voids, etc., for example. Further, as noted, prior to initial use, a thickness of the extended volume portion at the terminal edge 136 may be from 30% to 75% (e.g., 40% to 60%) of the maximum thickness of the tread portion.

The extended volume portion of the friction structure may include a volume of one or more friction materials. The material(s) may be same or different type(s) as that of the tread portion of the friction structure. The volume of the friction material(s) may laterally extend outward from the tread portion in the direction of the wheel flange (when the friction device is installed and with the tread portion aligned with the wheel tread. An underside of the volume of friction material(s) may define the flange contact region of the brake surface. The extended volume portion may be integral with the tread portion or may be attached thereto in another manner. The tread portion and extended volume portion may share a common lateral axis defined as a straight line extending from the terminal edge of the extended volume portion on the flange side of the friction structure to the terminal edge of the tread portion on the rim side of the friction structure. Both terminal edges may define the furthest extent of any friction material of the friction device (at least at that section of the friction device), and where there is continuous friction material(s) along the common lateral axis.

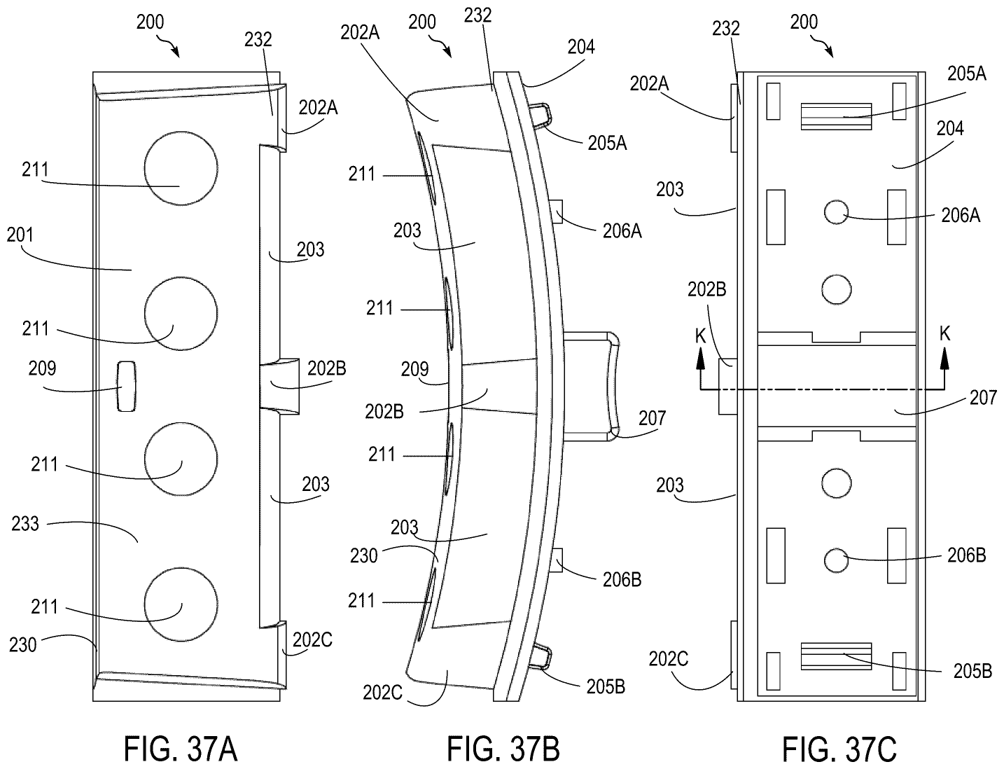

Referring now to FIGS. 18-21, the extended volume portion may include one or more protrusions 138 extending from the exposed side in the direction of the wheel flange. The protrusions may engage the wheel flange (see, e.g., FIG. 25), to assist with aligning the friction device relative to the wheel, so that the flange side, rim side, and/or brake surface may be in designated locations against the wheel during use. The protrusions may help with braking (by providing additional material to seat against the flange during use of the friction device), and with preventing lateral migration of the friction device.

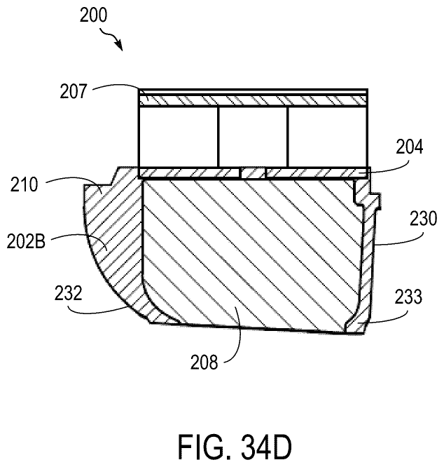

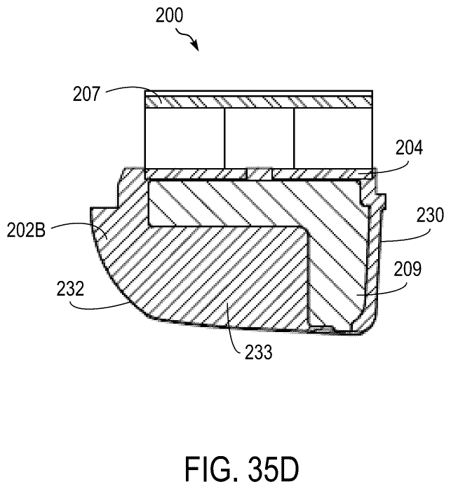

As shown in FIG. 20, the extended volume portion may be generally arcuate in correspondence to the shape of the wheel along the length of the extended volume portion between the two ends and including the side 136 of the extended volume portion. The protrusions may extend or stick out from (e.g., protrude from) the arcuate surface in the flange direction, and may be spaced apart from one another. These protrusions can form or establish alternating sections of protruding material and recesses along the length of the extended volume portion and longitudinal flange side. The protrusions may be evenly spaced apart from one another. Optionally, the protrusions may be unevenly spaced apart from one another. Or, the protrusions can be arranged in groups, with the protrusions being evenly spaced apart within each group but different distances between the groups. For example, as shown in the example in FIG. 22, the protrusions in a first pair are spaced apart by a given distance, which is the same distance between the protrusions in a second pair, but the two pairs are spaced apart by a different, longer distance. In the example of FIG. 22, there are four protrusions, but in other examples there may be more protrusions or fewer protrusions. The protrusions may have the same configuration (e.g., material composition, shape, and/or dimensions) or different configurations.

In examples, the protrusions may be polyhedral solids. For example, as shown in FIG. 20, the protrusions may have two parts or portions 133, 135. The first part or portion 133 may have a rectangular parallelepiped shape while the second part or portion 135 may have a triangular polyhedron shape (e.g., tetrahedron, pentahedron, triangular prism-shape or wedge shape, quadrilateral pyramid, etc.) Alternatively, the first and second parts of the protrusions may be provided in other shapes to achieve a desired character or aspect of interaction with the wheel flange, as is described herein. The first part may directly engage with the wheel flange while the second part may be tapered as the second part extends toward the flange contact region of the brake surface to engage with the flange root (and/or with the flange elsewhere). In one example, the first part and the second part may both be tapered (either the same or differently), to facilitate designated alignment of the friction device with the wheel. Alternatively, in other examples, neither the first part nor the second part may be tapered. In this instance, the first part and the second part may wear away by repeated uses of the friction device against the wheel.

One or more of the protrusions may comprise the same material or material(s) as the extended volume portion and/or the tread portion. Alternatively, or additionally, one or more of the protrusions may comprise a different material or materials than the extended volume portion and/or the tread portion. One or more of the protrusions may be integrally formed with the extended volume portion (e.g., as a monolithic structure). Alternatively, or additionally, one or more of the protrusions may be separately manufactured from the extended volume and then attached to the extended volume portion by an adhesive, mechanical fasteners, welding, etc. In one example, the tread portion, extended volume portion, and plural protrusions are integrally formed and comprised of the same material(s). For example, all the protrusions of the friction device may be integrally formed with the extended volume portion and tread portion and made of the same material(s). In another example, plural but fewer than all of the protrusions are integrally formed with the extended volume portion and tread portion and made of the same material(s), whereas the remaining, non-integral protrusion(s) are made of a different material or materials and attached to the extended volume portion. For example, the integral protrusions could be comprised of a friction material, and the other, non-integral protrusions could comprise a metal or metal alloy, for flange conditioning of the wheel.

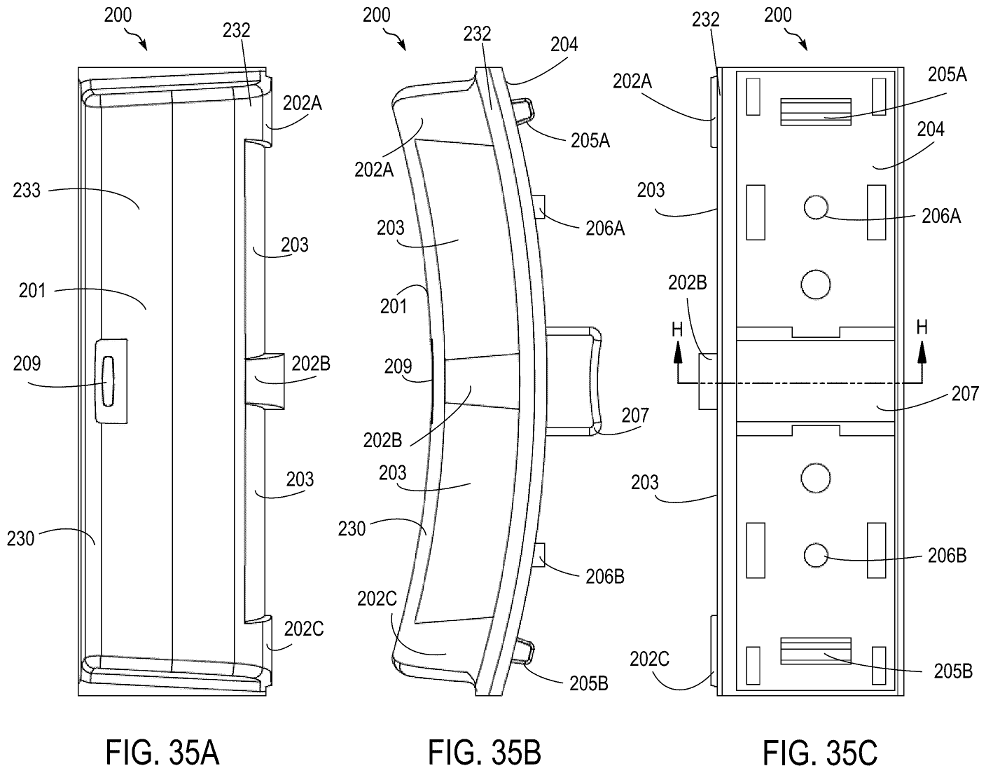

Referring now to FIG. 21 as one example, examples of the friction device include the backing plate that supports and carries the friction structure. Suitable backing plates may be made of metallic material or non-metallic material, or a combination or composite material. Suitable metallic materials may include iron, iron alloys, aluminum, titanium, etc. Suitable iron alloys may include steel. In one example, the backing plate may be made of a reinforced composite material, e.g., carbon fiber-reinforced polymer. The backing plate may be coated. Suitable coatings may include galvanic coatings (particularly if the backing plate is formed of a corrodible metal), paint, and anodized layers. Suitable paints include enamel, epoxy, and powder coatings.

The backing plate may have a top surface and a bottom surface, and may be generally arcuate in shape, or otherwise shaped in correspondence with the shape of the wheel (or portion thereof) with which the friction device is configured for use. The backing plate may be curved axially so as to follow the curvature of a wheel. The axis for the curve may be a wheel axis. In one example, the friction structure may be curved and may be coaxial to the wheel, while the backing plate follows the curve of the friction structure to be coaxial to the wheel. In another example, the backing plate may be curved but may not be coaxial with the wheel or with the working surface of the friction structure. The degree of separation of the curvature of the backing plate relative to the friction structure may be selected based on application specific parameters.

The backing plate may have surfaces that are relatively smooth and may have one or more defined apertures therethrough and/or protrusions extending therefrom. In one example, the backing plate may be undulate so as to increase the surface area of the backing plate (relative to a backing plate that does not include undulations). An increased surface area may provide more bonding surface to which the friction structure may bond. The undulations may be dispersed evenly across the backing plate or may be patterned so that some undulations are at a proximate edge or some undulations are concentrated nearer the center line. The undulations may run the length of the backing plate or may be oriented width-wise. Undulations may impart stiffness in the direction of their run, and flexion perpendicular to their run. In one example, the undulations direction is skew relative to the length and the width of the backing plate. In one example, a checkered pattern or equivalent is present to allow for control over the stiffness and the flexion of the backing plate while still increasing the surface area. Various patterns and similar effects can be created by selecting either a uniform thickness of the backing plate (and thus by bends in the plate) or by using non-uniform thicknesses across the backing plate.

For rail vehicle applications, the backing plate may include a pair of rejection lugs 114A, 114B. The rejection lugs may be integrally formed with the backing plate and may extend from a top surface of the backing plate. The rejection lugs are sized and positioned to mate with corresponding rejection lug receptacles on a corresponding vehicle brake head. The rejection lugs may be compatible with a variety of brake heads, or the lugs may only correspond with certain types of brake heads in order to prevent the installation of the friction device in incompatible systems. The friction device may include a keybridge 116. The keybridge may be integrally formed with the backing plate or the keybridge may be attached to the backing plate prior to installation. Like the backing plate, the keybridge may be made of a metallic material or a reinforced composite material. The keybridge may be coupled to a brake head of a vehicle (e.g., a railway vehicle). As shown in FIGS. 17 and 18, an opening 118 in the keybridge may accept a locking key which fastens the friction device to the railway vehicle brake head. The keybridge may take any shape necessary to facilitate fastening of the keybridge to a designated configuration of brake head.

In examples, one or more wheel conditioning inserts may be disposed within the material of the friction structure. The wheel conditioning inserts may interact with a wheel for a function other than primarily for braking, e.g., to clean, scrape, treat, or otherwise condition the wheel tread, rim, and/or flange. FIG. 22 shows one example of rectangular wheel conditioning inserts 140 disposed within the friction structure, e.g., in this example there are three inserts. The wheel conditioning inserts each include a respective elongated portion 142. The elongated portion has a wheel conditioning surface 144 that extends along the brake surface adjacent to and generally parallel with the rim side of the friction structure (e.g., a long axis of the surface 144 is generally parallel to the rim side). In this configuration, the wheel conditioning surfaces of the wheel conditioning inserts are positioned to condition the rim of the wheel (e.g., to mitigate hollow wheel wear or otherwise). Prior to initial use of the friction device, the friction device may be configured for the wheel conditioning surface to be exposed to and flush with the brake surface. It is contemplated that the wheel conditioning inserts may be initially fully encapsulated within the friction structure of the friction device. In this instance, repeated braking of the vehicle will wear away the outer layer of the composite friction material, eventually exposing the wheel conditioning surfaces of the wheel conditioning inserts to the wheel. During initial use of the friction device, the wheel conditioning inserts are covered with friction material, but after use of the friction device the wheel conditioning inserts may eventually become exposed for wheel conditioning.

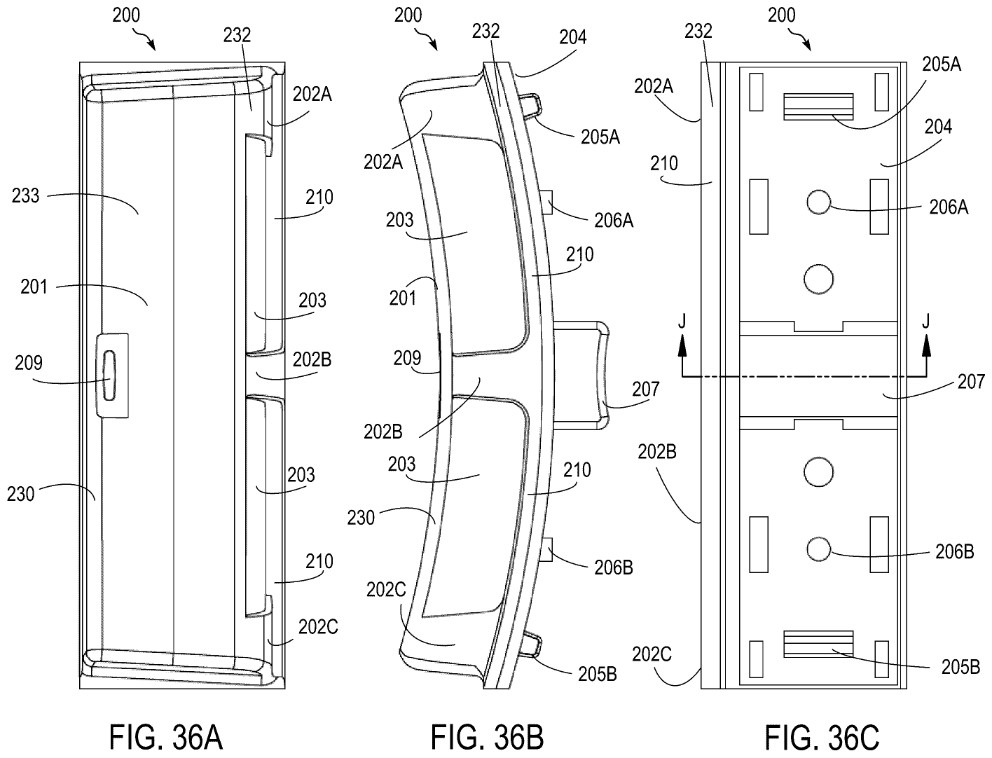

In another example, as shown in FIG. 23, a T-shaped wheel conditioning insert 146 may be disposed within the friction structure. The T-shaped wheel conditioning insert has a first elongated portion 148 and a second elongated portion 150 both of which form the wheel conditioning surface 152. The first elongated portion has an end 154 that extends along the brake surface adjacent to and generally parallel with the rim side of the friction structure. The second elongated portion extends along the brake surface generally perpendicular to the first elongated portion. The second elongated portion has an end 156 that is adjacent to the flange side of the friction structure. A central axis D-D of the friction device, equidistant between the flange side and the rim side, crosses the T-shaped wheel conditioning insert substantially halfway between the ends of the insert. With the first elongated portion adjacent to and extending along the rim side and the second elongated portion disposed in a central location along the brake surface, the T-shaped wheel conditioning insert, when applied to the wheel, may condition both the wheel tread and the wheel rim. This configuration conditions the wheel tread, removing tread defects while simultaneously conditioning the wheel rim (e.g., for removing rim defects and reducing the rate of hollow wheel wear).

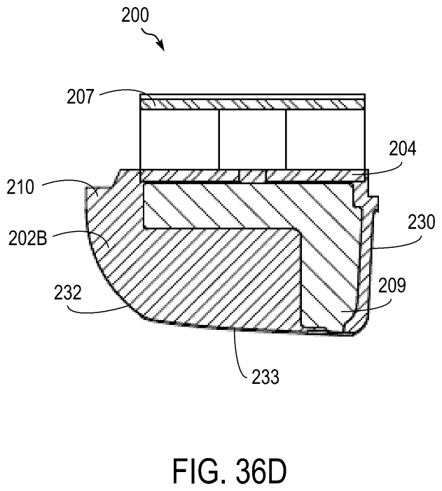

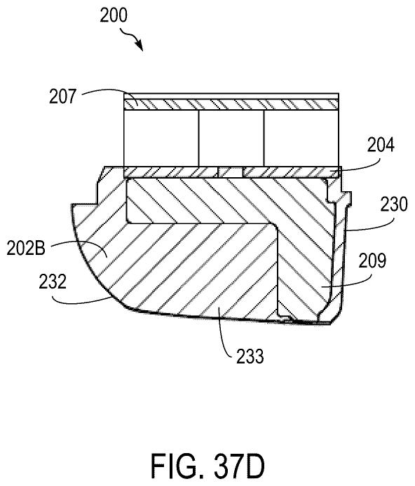

Referring now to FIG. 24 as one exemplary example, one or more voids 160 may be formed within the friction structure. In examples, for each void the material of the friction structure may define an opening in the brake surface, and one or more sidewalls extending from the opening into the material. The voids may be generally aligned with the wheel tread when applied to the wheel as shown in FIGS. 25 and 26. The voids may serve to lessen the amount of wear the friction device contributes to the wheel tread. The voids lack friction material in their respective locations, and this lack of friction material prevents the wheel tread from continually wearing away when the friction device is applied to the wheel. The void openings as shown are substantially circular, oval, or elliptical in shape, but in other examples the voids (openings and/or sidewalls/interior) may take any shape, such as polygonal, capable of reducing some of the volume of friction material in order to reduce the wear applied to the wheel tread. The voids, as shown, may be conical or tapered, having a larger cross-sectional area at the brake surface which tapers or reduces to a smaller cross-sectional area nearest the backing plate. In FIG. 24, the voids are shown with a rectangular wheel conditioning insert 140, however the voids can be used in conjunction with T-shaped conditioning inserts or other inserts. In another example, a friction device includes one or more voids but lacks any conditioning inserts. It is contemplated that the additional features of the friction device described herein can be utilized in any functional combination on a friction device.

In examples, an area of the opening of each of at least one of the voids (or the respective areas of all the voids), coincident with the brake surface, is from 2% to 30% of the entire area of the brake surface. In another example, the area of the opening of each of at least one of the voids (or the respective areas of all the voids), coincident with the brake surface, is from 30% to 40% of the entire area of the brake surface. This approximately reflects the geometry illustrated in the example of FIG. 24, as representative of an example of one possible application (where some material at the brake surface/wheel interface is lacking, to achieve the functions as stated herein, while the overall friction device still provides a typical desired level of friction interaction with a wheel for braking).

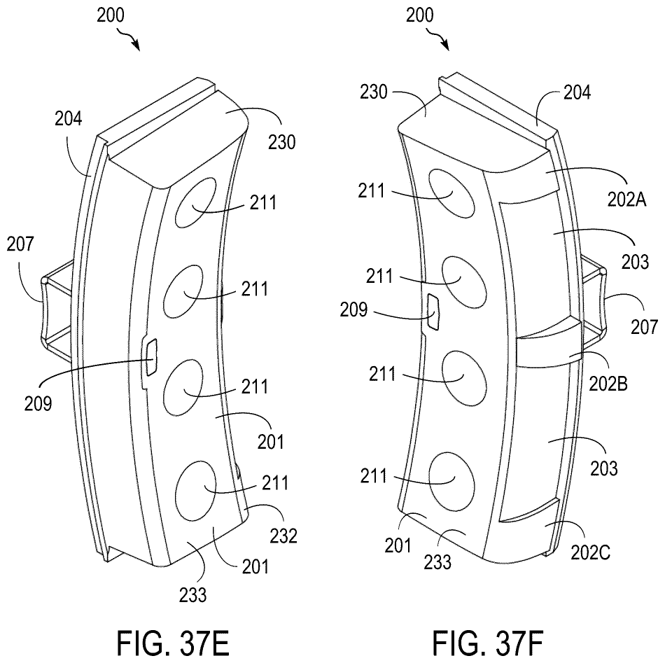

FIGS. 25-27 show an example of a friction device that includes the extended volume portion, protrusions, a wheel conditioning insert 140, and at least one void, as described above. As shown in FIGS. 25 and 27, the protrusions contact the wheel flange, and as shown in FIG. 26, the extended volume portion and the flange contact region may contact the wheel flange (e.g., the flange root and top regions of the flange). The contact between the respective elements aligns the friction device with the wheel in a designated and controlled manner. For example, as shown in FIG. 26, the wheel conditioning insert may be aligned with the wheel rim so that the wheel conditioning insert conditions the wheel rim during use. The void(s) and a majority of the brake surface are aligned with the wheel tread to prevent over conditioning of the wheel tread while still applying a designated/desired braking force to the wheel when the friction device is actuated. As shown in FIG. 27, the alignment facilitated by the extended volume portion and the protrusions leads to the friction device remaining against the wheel surface with no overhang. A small portion 195 of the wheel rim may be exposed next to the rim side of the friction structure, further demonstrating the lack of overhang.

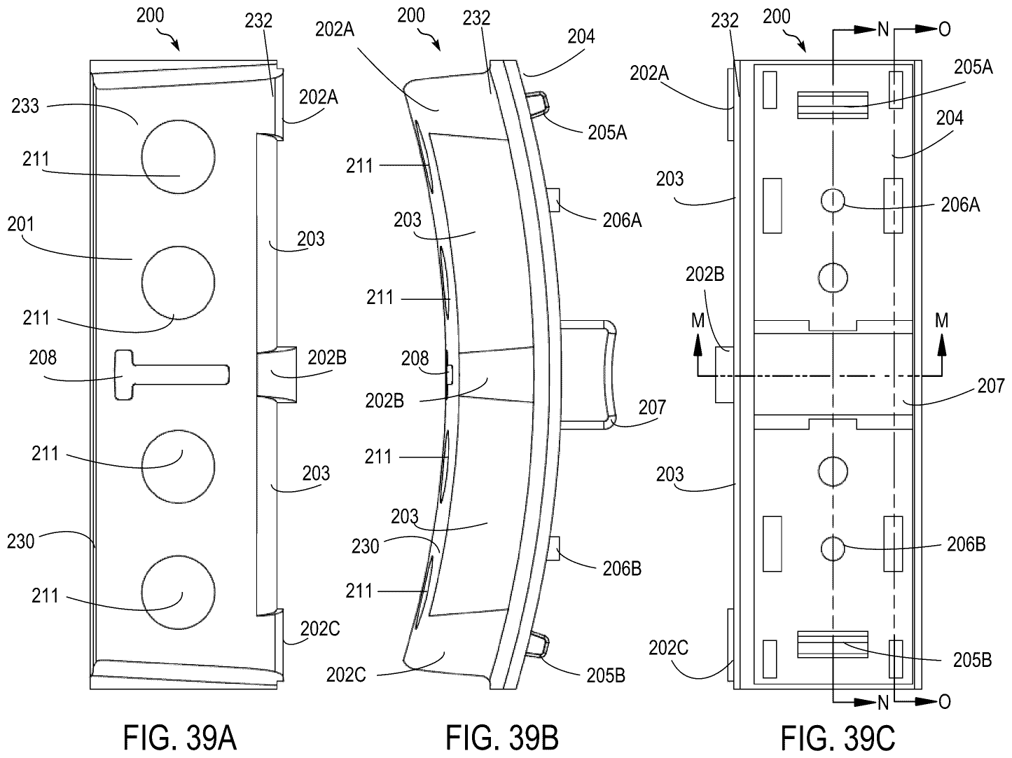

As discussed above with reference primarily to FIGS. 1-30, the features, materials, shapes, volumes, compositions, ranges, parameters, sizes etc., of various components of a friction device, e.g., backing plates, frictions structures, friction inserts, fillers, voids, tread portions, extended volume portions, protrusions, etc., are further applicable to the examples of friction devices discussed below and shown in remaining FIGS. 31-46.

Various embodiments of a friction device for a vehicle wheel are described, featuring a backing plate that interfaces with a brake actuator. Attached to the backing plate is a friction structure made of friction material, defining a central longitudinal axis, with a longitudinal flange side, a longitudinal rim side, and two opposing ends. This structure forms a brake surface for engaging the wheel and includes an extended volume portion on the flange side with multiple flange contact protrusions and recesses. These protrusions vary in length and engage the wheel flange, particularly during initial use, to facilitate progressive engagement. Additionally, a method for engaging and disengaging the brake surface involves using these protrusions to progressively contact the wheel flange, enhancing the braking process.

In one embodiment, a friction device for a vehicle such as a rail vehicle or other vehicle having a wheel (e.g., a flanged wheel having a wheel flange and wheel tread or another wheel) is described. The friction device may include a backing plate and a friction structure. The backing plate may interface with a brake actuator of the vehicle. The friction structure may be attached to the backing plate and may include a friction material. The friction structure may have a longitudinal flange side, a longitudinal rim side, and two opposing ends. The friction structure may define a brake surface for engaging a wheel for braking. The friction structure may include an extended volume portion of the friction material on the longitudinal flange side. The extended volume portion may define a plurality of flange contact protrusions and recesses, each of which may extend from the longitudinal flange side of the extended volume portion at varying lengths to engage the flange.

FIGS. 31A-C depict multiple views of a friction device 200. In accordance with one or more embodiments, the friction device of FIGS. 31A-C can include a friction structure 230 disposed on a backing plate 204. The friction structure can include a tread portion 233, an extended volume portion 232, a brake surface 201, variable multi-wear alignment protrusions 202A-C, and recesses 203. The backing plate can include a square keybridge 207, rejection lugs 205A-B, and rejection pins 206A-B.

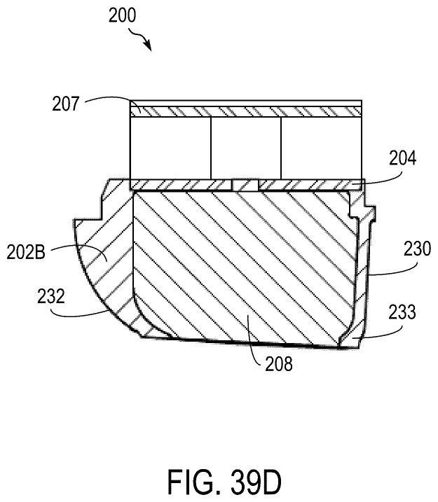

FIGS. 32A-C depict multiple views of a friction device 200. In accordance with one or more embodiments, the friction device of FIGS. 32A-C can include a friction structure 230 disposed on a backing plate 204. The friction structure can include a tread portion 233, an extended volume portion 232, a brake surface 201, variable multi-wear alignment protrusions 202A-C, a multi-wear alignment protrusion bridge 210, and recesses 203. The backing plate can include a square keybridge 207, rejection lugs 205A-B, and rejection pins 206A-B.

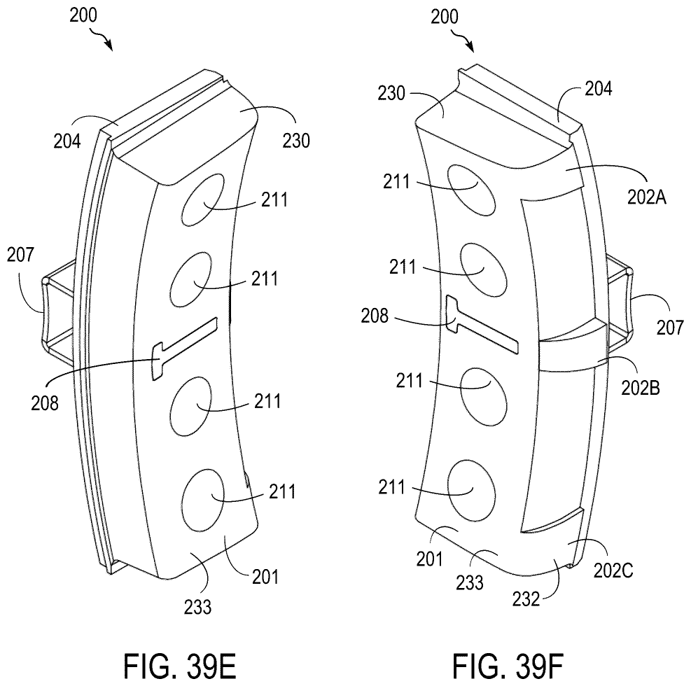

FIGS. 33A-C depict multiple views of a friction device 200. In accordance with one or more embodiments, the friction device of FIGS. 33A-C can include a friction structure 230 disposed on a backing plate 204. The friction structure can include a tread portion 233, an extended volume portion 232, a brake surface 201, variable multi-wear alignment protrusions 202A-C, recesses 203, and a T-shaped insert 208. The backing plate can include a square keybridge 207, rejection lugs 205A-B, and rejection pins 206A-B.

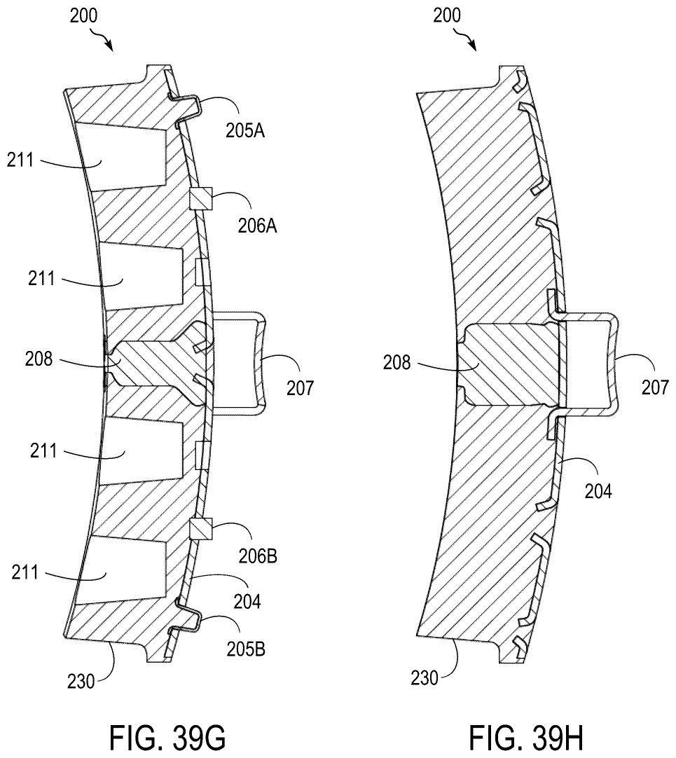

FIGS. 34A-D depict multiple views of a friction device 200. In accordance with one or more embodiments, the friction device of FIGS. 34A-C can include a friction structure 230 disposed on a backing plate 204. The friction structure can include a tread portion 233, an extended volume portion 232, a brake surface 201, variable multi-wear alignment protrusions 202A-C, a multi-wear alignment protrusion bridge 210, recesses 203, and a T-shaped insert 208. The backing plate can include a square keybridge 207, rejection lugs 205A-B, and rejection pins 206A-B.

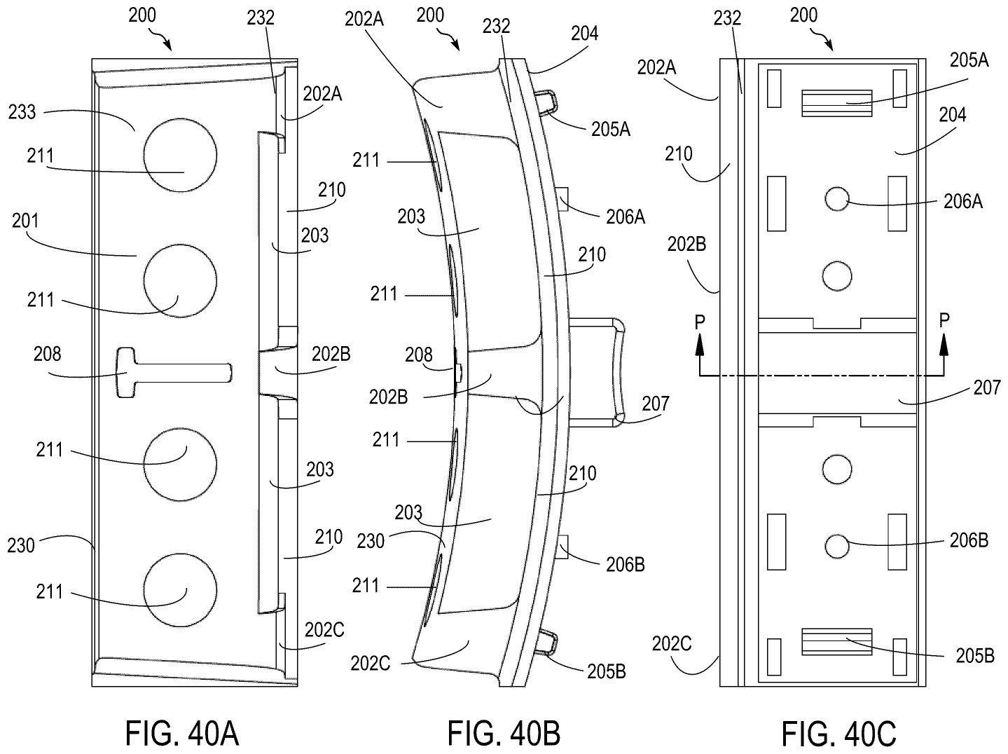

FIGS. 35A-D depict multiple views of a friction device 200. In accordance with one or more embodiments, the friction device of FIGS. 35A-C can include a friction structure 230 disposed on a backing plate 204. The friction structure can include a tread portion 233, an extended volume portion 232, a brake surface 201, variable multi-wear alignment protrusions 202A-C, recesses 203, and a rim insert 209. The backing plate can include a square keybridge 207, rejection lugs 205A-B, and rejection pins 206A-B.

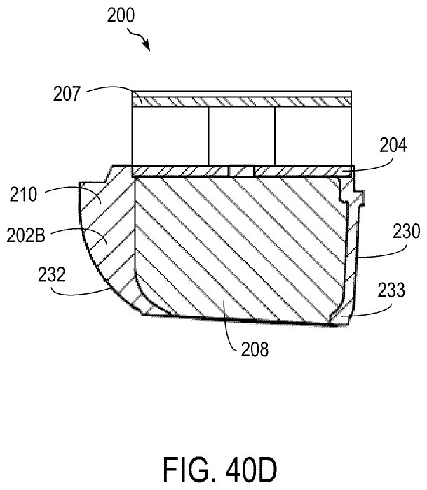

FIGS. 36A-D depict multiple views of a friction device 200. In accordance with one or more embodiments, the friction device of FIGS. 36A-C can include a friction structure 230 disposed on a backing plate 204. The friction structure can include a tread portion 233, an extended volume portion 232, a brake surface 201, variable multi-wear alignment protrusions 202A-C, a multi-wear alignment protrusion bridge 210, recesses 203, and a rim insert 209. The backing plate can include a square keybridge 207, rejection lugs 205A-B, and rejection pins 206A-B.

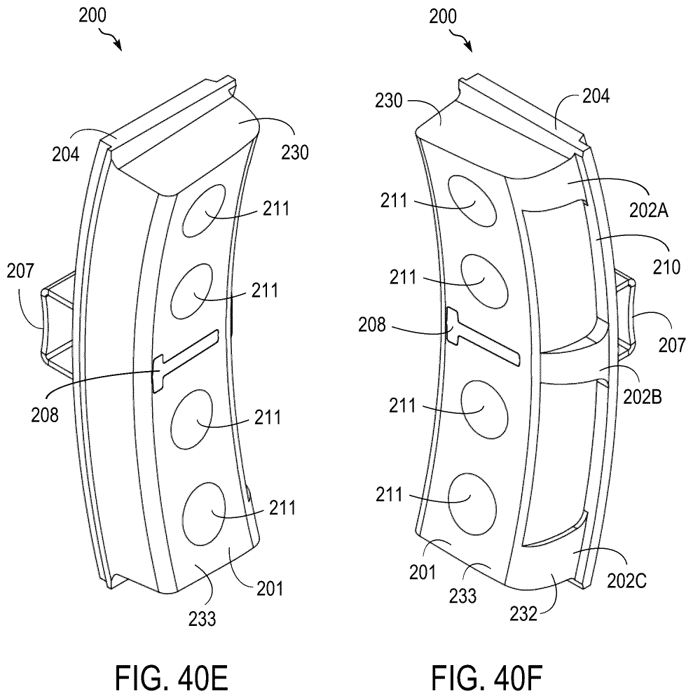

FIGS. 37A-F depict multiple views of a friction device 200. In accordance with one or more embodiments, the friction device of FIGS. 37A-C can include a friction structure 230 disposed on a backing plate 204. The friction structure can include a tread portion 233, an extended volume portion 232, a brake surface 201, variable multi-wear alignment protrusions 202A, recesses 203, voids 211, and a rim insert 209. The backing plate can include a square keybridge 207, rejection lugs 205A-B, and rejection pins 206A-B.

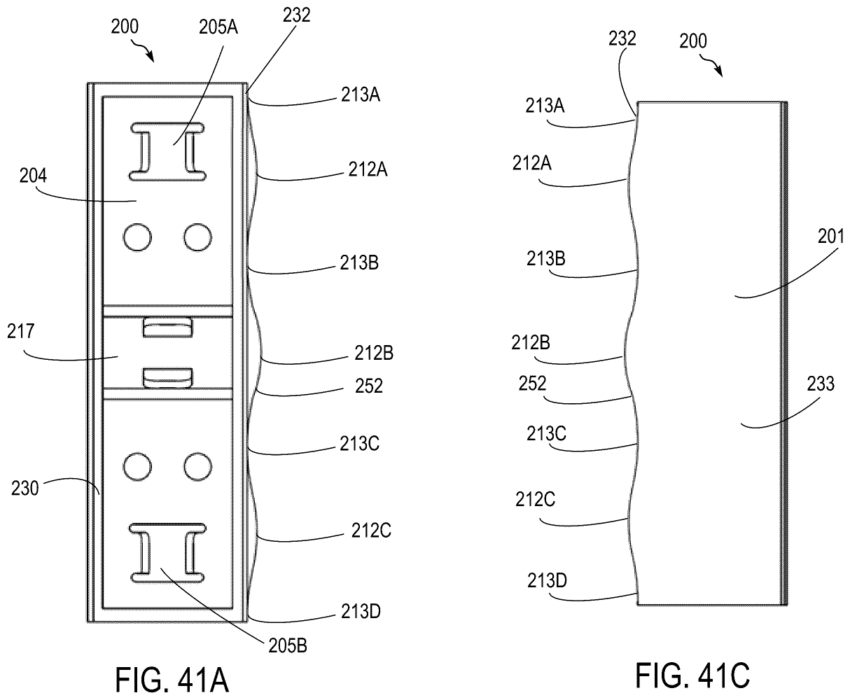

FIGS. 38A-F depict multiple views of a friction device 200. In accordance with one or more embodiments, the friction device of FIGS. 38A-C can include a friction structure 230 disposed on a backing plate 204. The friction structure can include a tread portion 233, an extended volume portion 232, a brake surface 201, variable multi-wear alignment protrusions 202A, a multi-wear alignment protrusion bridge 210, recesses 203, voids 211, and a rim insert 209. The backing plate can include a square keybridge 207, rejection lugs 205A-B, and rejection pins 206A-B.

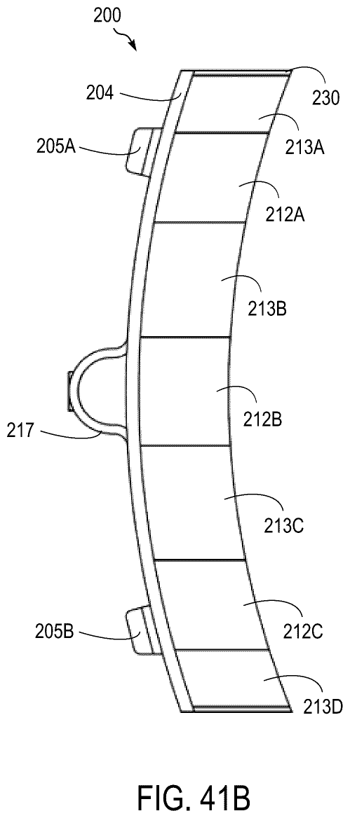

FIGS. 39A-H depict multiple views of a friction device 200. In accordance with one or more embodiments, the friction device of FIGS. 39A-C can include a friction structure 230 disposed on a backing plate 204. The friction structure can include a tread portion 233, an extended volume portion 232, a brake surface 201, variable multi-wear alignment protrusions 202A, recesses 203, voids 211, and a T-shaped insert 208. The backing plate can include a square keybridge 207, rejection lugs 205A-B, and rejection pins 206A-B.

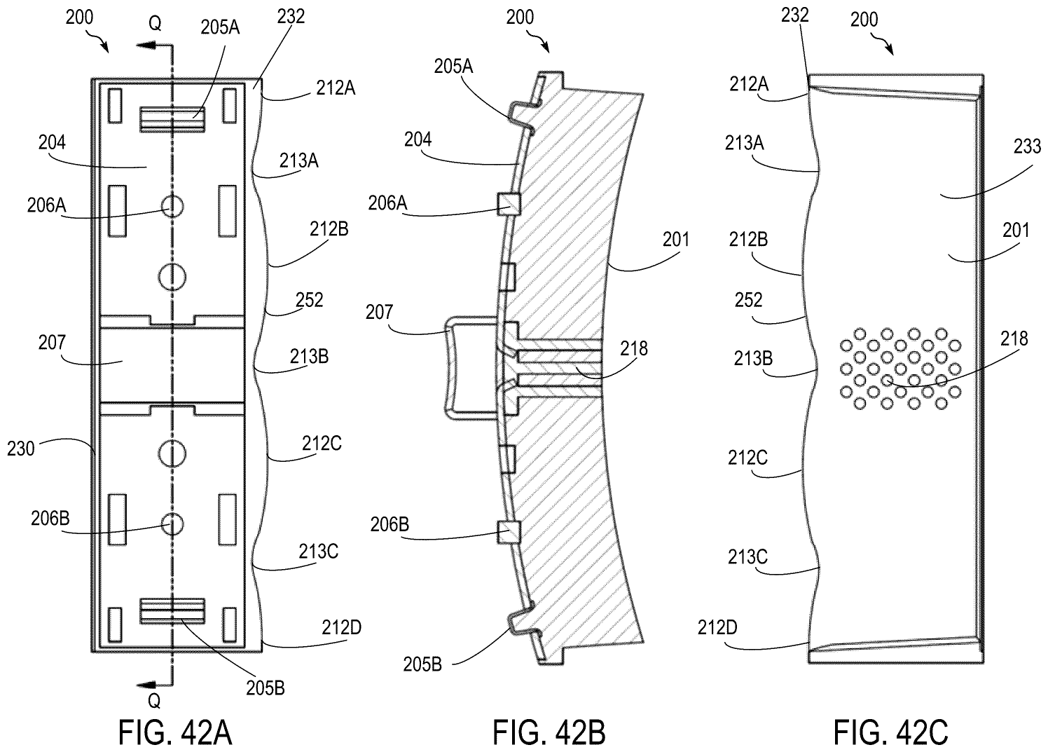

FIGS. 40A-F depict multiple views of a friction device 200. In accordance with one or more embodiments, the friction device of FIGS. 40A-C can include a friction structure 230 disposed on a backing plate 204. The friction structure can include a tread portion 233, an extended volume portion 232, a brake surface 201, variable multi-wear alignment protrusions 202A, a multi-wear alignment protrusion bridge 210, recesses 203, voids 211, and a T-shaped insert 208. The backing plate can include a square keybridge 207, rejection lugs 205A-B, and rejection pins 206A-B. A cross-sectional view of the friction device of FIGS. 40A-F (not shown) would yield similar results to the cross-sectional views of the friction device of shown in the cross-sectional views of FIGS. 39G-H.

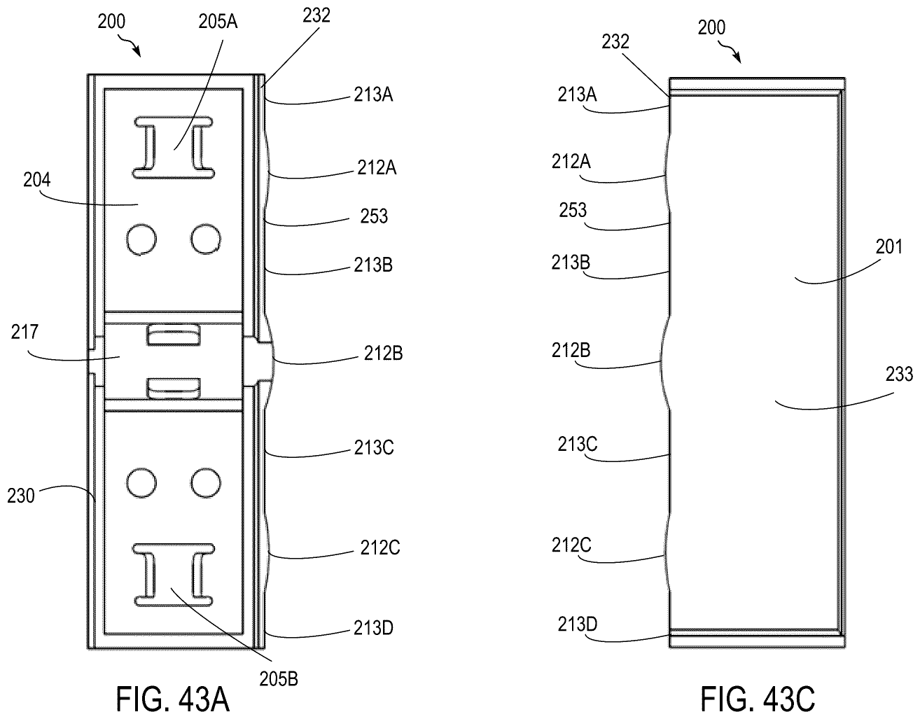

FIGS. 41A-C depict multiple views of a friction device 200. In accordance with one or more embodiments, the friction device of FIGS. 41A-B can include a friction structure 230 disposed on a backing plate 204. The friction structure can include a tread portion 233, an extended volume portion 232, a brake surface 201, and a continuous ribbon 252 of multi-wear alignment protrusions 212A-C and 213A-D. The backing plate can include a circular keybridge 217 and rejection lugs 205A-B.

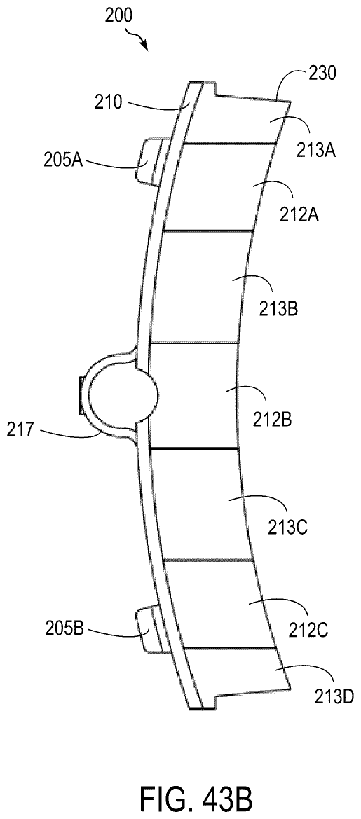

FIGS. 42A-C depict multiple views of a friction device 200. In accordance with one or more embodiments, the friction device of FIGS. 42A-B can include a friction structure 230 disposed on a backing plate 204. The friction structure can include a tread portion 233, an extended volume portion 232, a brake surface 201, a continuous ribbon 252 of multi-wear alignment protrusions 212A-D and 213A-D, and an array insert 218. The backing plate can include a square keybridge 207, rejection pins 206A-B, and rejection lugs 205A-B.

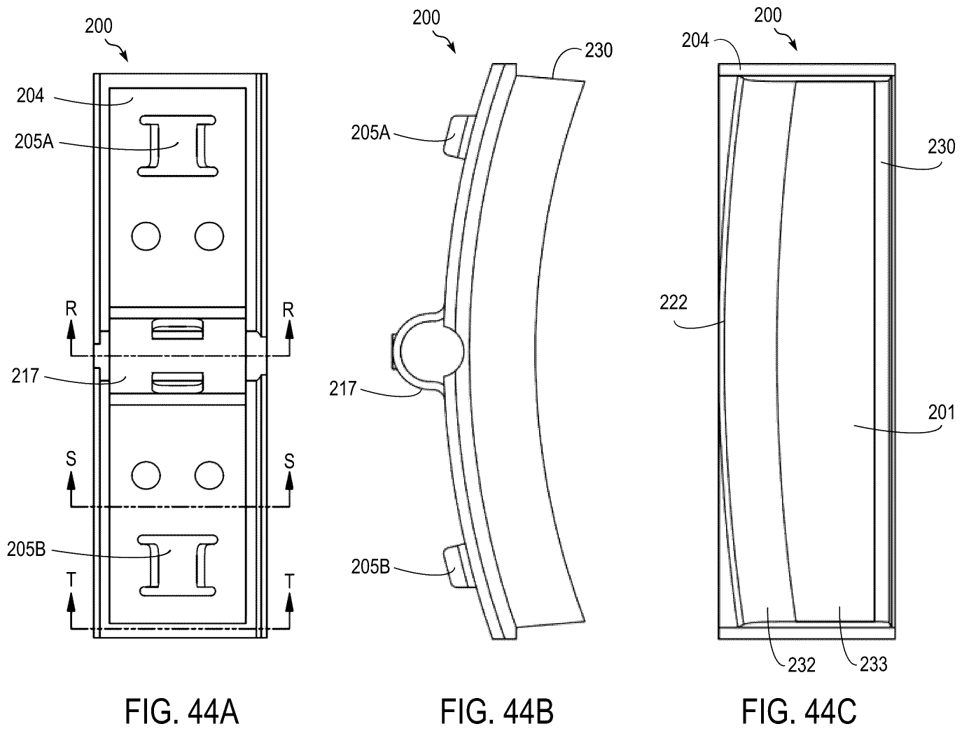

FIGS. 43A-C depict multiple views of a friction device 200. In accordance with one or more embodiments, the friction device of FIGS. 43A-B can include a friction structure 230 disposed on a backing plate 204. The friction structure can include a tread portion 233, an extended volume portion 232, a brake surface 201, a segmented ribbon 253 of multi-wear alignment protrusions 212A-C and 213A-D, and an array insert 218. The backing plate can include a circular keybridge 217 and rejection lugs 205A-B.

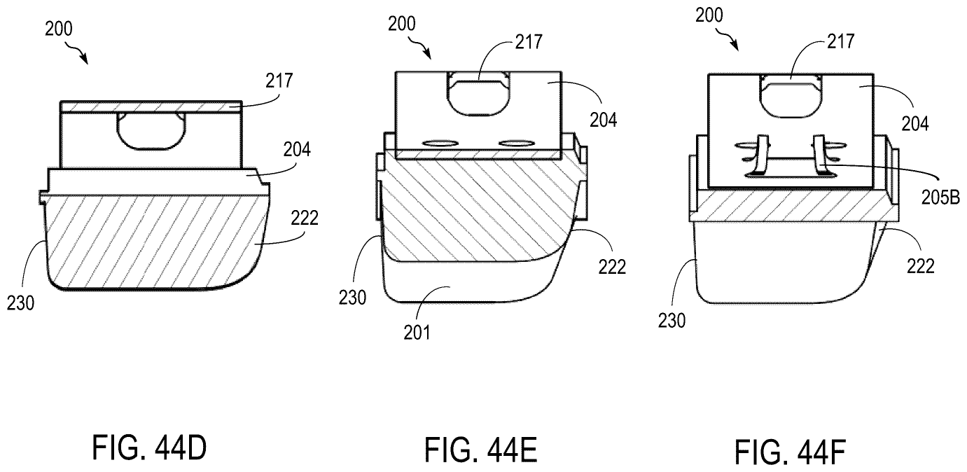

FIGS. 44A-G depict multiple views of a friction device 200. In accordance with one or more embodiments, the friction device of FIGS. 43A-B can include a friction structure 230 disposed on a backing plate 204. The friction structure can include a tread portion 233, an extended volume portion 232, a brake surface 201, and a single multi-wear alignment arc protrusion 222. The backing plate can include a circular keybridge 217 and rejection lugs 205A-B. The friction structure 230 can include voids 211, in accordance with one embodiment.

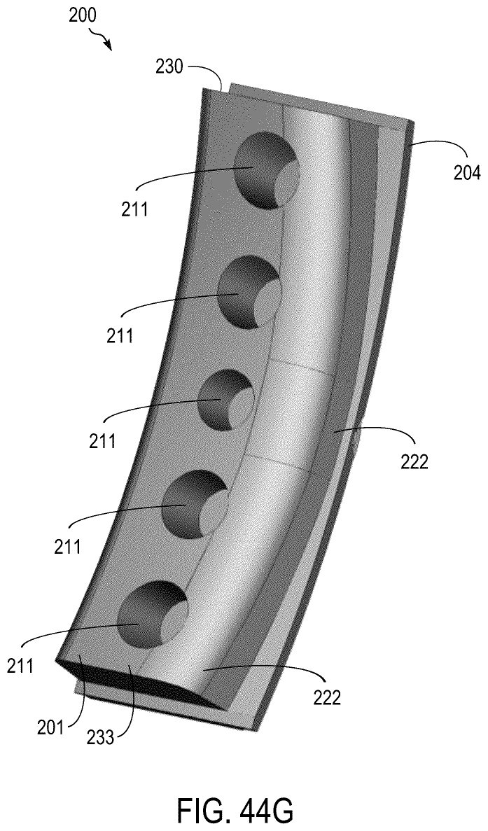

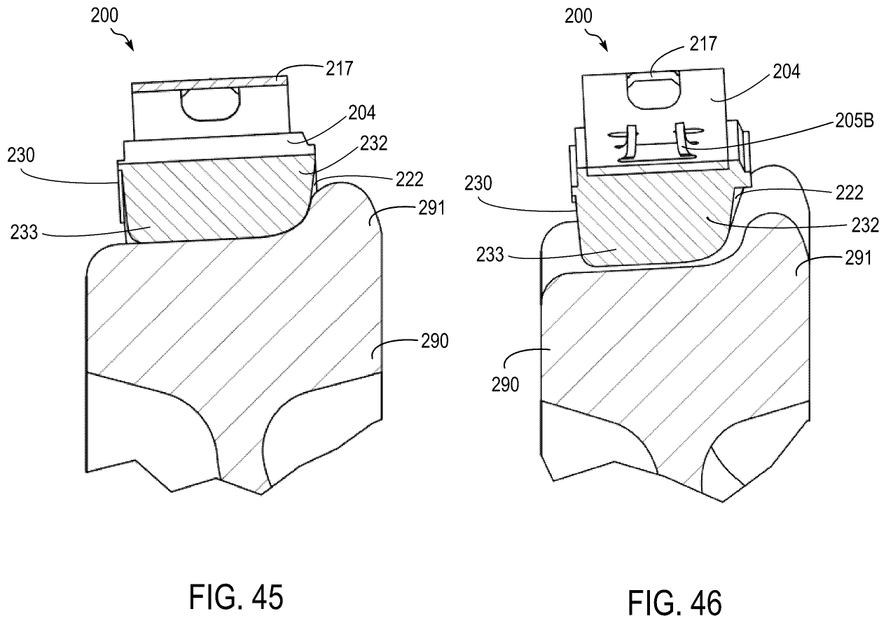

FIGS. 45 and 46 depict multiple cross-sectional views of a friction device 200 in use with a wheel 290. In accordance with one or more embodiments, the friction device of FIG. 45 can include a friction structure 230 disposed on a backing plate 204. The friction structure can include a tread portion 233, an extended volume portion 232, and a single multi-wear alignment arc protrusion 222 to engage a flange 291 of a wheel 290. The backing plate can include a circular keybridge 217 and rejection lug 205B.

Referring now to FIGS. 31-46, additional examples of a friction device are illustrated. In one or more examples, a friction device 200 may include a backing plate 204 and a friction structure 230 (e.g., brake pad) disposed on the backing plate (FIGS. 33A-33C). The friction structure may include (e.g., be made or formed of, at least in part) a friction material. The friction structure may include a flange side 244 that may face in the direction of a flange of a flanged wheel, a rim side 242 that may face a rim of the wheel, opposite first and second ends 246, 248, and top and bottom surfaces. The flange and rim sides may extend along the length of the friction device, and the opposite ends may extend between and connect the flange side and the rim side. The bottom surface (e.g., underside) of the friction structure opposite the backing plate may define a brake surface 201. By controlling the selection of the material or materials that form the friction structure, the brake surface may exhibit selected (e.g., known and controlled) frictional characteristics in interaction with a wheel or other moving clement when the brake surface is selectively brought to bear against (e.g., pressed against) the wheel or other moving element. For example, for a given material composition of the friction structure, there may be a higher degree of friction between the friction structure and the wheel for a given application force than if the friction structure was made of different materials. When the friction device is actuated for use, frictional interaction between the friction device and wheel converts kinetic energy of the wheel and vehicle into thermal energy (e.g., heat) to brake/slow the wheel and vehicle. Thus, the brake surface may be dimensioned and/or otherwise configured so that when the friction device is installed and actuated for use in braking, the brake surface contacts the wheel in order to apply a friction force to the wheel. For example, if the wheel tread is frustoconical (as may be the case for rail vehicle wheels), the brake surface may be generally arcuate (along the long axis of the friction device) and slightly tapered (along a short or cross axis of the friction device) in correspondence.

The friction structure may include a tread portion 233 and an extended volume portion 232 (also referred to as a flange engagement portion or flange alignment portion). The tread portion can extend between the two ends and may extend from the rim side of the friction structure (where the tread portion at least partially defines the rim side) in the flange direction to where the friction structure meets the extended volume portion. An underside of the tread portion defines a tread contact region of the brake surface. The tread contact region is arranged and configured (e.g., dimensioned and positioned) to engage the wheel tread when the friction device is installed for use and actuated for braking. The extended volume portion may extend between the two ends and out from the tread portion in the direction of the flange to terminate at and at least partially define the flange side of the friction structure. An underside of the extended volume portion may define a flange contact region 231 of the brake surface, which is complementary shaped to at least part of the flange (e.g., to a flange root and/or to the top region of the flange). Accordingly, the flange contact region may engage or about the flange (e.g., flange root and/or top region of the flange) during use of the friction device.

As shown in FIGS. 31A-40F, the extended volume portion of the friction device may include one or more multi-wear alignment protrusions, also referred to as tabs, 202A-202C that may contact the flange surface of a flange of a wheel during use of the friction device. In some examples, the extended volume portion may include recesses 203 between the protrusions. As shown in FIGS. 31A-40F, the protrusions may extend or stick out from (e.g., protrude from) the friction structure in the flange direction, and may be spaced apart from one another. These protrusions can form or establish alternating sections of protruding material and recesses along the length of the extended volume portion and longitudinal flange side. The protrusions may be evenly spaced apart from one another. Optionally, the protrusions may be unevenly spaced apart from one another. Or, the protrusions can be arranged in groups, with the protrusions being evenly spaced apart within each group but different distances between the groups.

In the example friction device shown in FIGS. 31A-40F, one or more of the protrusions may extend from the friction structure in the flange direction by varying extension lengths. For example, the protrusion 202B can extend from the friction structure to a first level, while the other protrusions 202A, 202C extend from the friction structure to a second level that is shorter than the first level. In other words, the protrusion 202B can contact a flange surface while the protrusions 202A, 202C remain out of contact with the flange surface. Having protrusions of varying lengths can widen the overall width of the friction structure to fill variously sized gaps between the friction structure and a flange of a wheel to prevent lateral movement of the friction device, while also allowing the protrusions to wear at different rates if there is an excess of interference between the flange and the friction structure.

In some examples, the protrusions can include one or more varying widths, lengths, shapes, and/or surface areas to increase or decrease the wear rate of one or more protrusions. As shown in FIG. 31B, the protrusions 202A, 202C are wider, and thus have a wider surface area, than the protrusion 202B. As discussed above, the protrusion 202B extends further in the flange direction than the protrusions 202A, 202C, and thus may be the only protrusion engaging the flange and/or flange surface. However, the smaller surface area of the protrusion 202B allows it to wear at a faster rate as compared to the protrusions 202A, 202C. Thus, the protrusion 202B can accommodate a wider gap between the friction structure and the flange and prevent lateral movement, but the protrusion 202B can also wear away quickly if there is too much interference between the friction structure and the flange, preventing excessive wear on the flange. In some examples, the protrusion 202B can be shaped to have the same or similar surface area as the protrusions 202A, 202C after the protrusion 202B is worn down by the flange such that the protrusion 202B has the same or similar extension length as the protrusions 202A, 202C.

In one exemplary example, the extended volume portion of the friction device can include a bridge 210 extending longitudinally along the flange engagement side of the friction structure and opposite the brake surface such that the bridge spans the upper side of the extended volume portion. In other words, the bridge can span across the top of the protrusions and recesses along the length of the friction structure. The bridge can prevent dirt, debris, etc., from accumulating between the extended volume portion of the friction structure and the wheel flange, such as the accumulation of debris in one or more of the recesses.

As discussed above, the protrusions may extend or stick out from (e.g., protrude from) the arcuate surface in the flange direction, and may be spaced apart from one another. These protrusions can form or establish alternating sections of protruding material and recesses along the length of the extended volume portion and longitudinal flange side. The protrusions may be evenly spaced apart from one another. Optionally, the protrusions may be unevenly spaced apart from one another. Or, the protrusions can be arranged in groups, with the protrusions being evenly spaced apart within each group but different distances between the groups. In the example of FIG. 31A, there are three protrusions, but in other examples there may be more protrusions or fewer protrusions. The protrusions may have the same configuration (e.g., material composition, shape, and/or dimensions) or different configurations.

Referring now to FIGS. 41A-43C, the extended volume portion can include a variable width continuous or semi-continuous/segmented ribbon 252 of protrusions. As shown in FIG. 41A, the continuous ribbon can include a continuous waveform-like arrangement of multi-wear alignment protrusions 212A-212C, 213A-213D, where the protrusions 212A-C can include a concave arcuate shape, or in other words, can be seen as peaks of the sinusoidal waveform-like arrangement, while the protrusions 213A-D can include a convex arcuate shape, or in other words, can be seen as valleys of the waveform-like arrangement. In some examples, the ribbon can include a triangular waveform-like arrangement (not shown), with each of the protrusions 212A-C extending in the flange direction to form a flange-facing triangular point, while each of the protrusions 213A-D extends in the flange direction to form the base of a triangle, or in other words, the triangular points formed by the protrusions 213A-D extend in the opposite direction to the triangular points formed by the protrusions 212A-C. As the protrusions engage with the wheel flange and the protrusions are worn away as a result of engagement with the wheel flange, the surface area of each protrusion can increase, thus decreasing the rate of wear. In other words, for a given individual protrusion, initially only the peak of the arc may engage the wheel flange. As the wheel flange wears against the arc of the protrusion, a larger surface area of the arc comes into contact with the wheel flange, slowing the wear of the protrusion.

As shown in FIG. 41A, the protrusions 212A-212C can extend further in the flange direction as compared to the protrusions 213A-213D, and each of the protrusions can extend at a different length in the flange direction relative to each other. Additionally, or alternatively, one or more protrusions can extend the same first length, while one or more additional protrusions extend the same second length that is different from the first length, etc. For example, FIG. 41A shows an example friction device in which the protrusions 212A-C extend further in the flange direction than the protrusions 213A-D, and the protrusion 212B extends even further in the flange direction than the protrusions 212A, 212C. In some examples, the protrusions can be spaced equally from each other, that is, the centers of peaks of the protrusions (e.g., 212A-212C) are spaced equally from each other, and the centers of the valleys of the protrusions (e.g., 213A-D) are spaced equally from each other. Such an arrangement of protrusions results in a sinusoidal shape wave-like arrangement of protrusions, which can provide continuously variable wear across the protrusions. The variable wearing of protrusions along the extended volume portion of the friction device can aid in filling uneven gaps or spacing between the friction device and the wheel flange but can also allow the protrusions to wear away at varying rates at various points along the extended volume portion to prevent excessive wearing on the flange.

Additionally, or alternatively, the protrusions within the ribbon of protrusions can be arranged in an asymmetrical waveform-like shape, with one or more protrusions varying in width along the extended volume portion, extension length in the flange direction, etc. For example, FIG. 42A shows a ribbon having the protrusions 212A, 212D extending a first length in the flange direction and extending along the extended volume portion a first length, while the protrusions 212B, 212C extend in the flange direction a second length that is longer than the first length and extend along the extended volume portion a second length that is longer than the first length.

FIG. 43A shows an example of a semi-continuous or segmented ribbon including the protrusions 212A-C, 213A-D. As shown in FIG. 43A, the protrusions 212A-C extend in the flange direction in an arcuate shape, while the protrusions 213A-D extend in the flange direction in a flat shape, and further, the protrusion 212B extends further in the flange direction than the protrusions 212A, 212C. Such a segmented ribbon of protrusions can provide multiple levels of protrusion engagement with the flange along the extended volume portion of the friction structure. For example, the protrusion 212B can engage the flange first, as the protrusion 212B extends furthest in the flange direction. This allows the protrusions to fill a larger gap between the friction structure and the wheel flange, thus preventing lateral movement of the friction structure even if a large gap exists. However, the protrusion 212B, having the least amount of surface area engaging the flange, can quickly wear away if there is excessive contact with the friction structure and the wheel flange, which can result in each of the protrusions 212A-C engaging the wheel flange to further prevent lateral movement of the friction structure. If there is still excessive contact after the protrusion 212B has worn away to the same extension length of the protrusions 212A, 212C, that is, all three protrusions are engaging the wheel flange, the protrusions 212A-C can wear away at similar or identical rates until they are worn away to the same extension length as the protrusions 213A-D, resulting in a uniform or near-uniform protrusion extension length along the extended volume portion of the friction structure, which can wear away at the slowest rate due to the total surface area engaging the wheel flange.

In another example, as shown in FIG. 44C, the friction device can have a single arc-shaped or triangular shape (not shown) variable width multi-wear alignment protrusion 222 extending along the extended volume portion of the friction structure. The single arc-shaped protrusion can extend the largest length in the flange direction at the center of the arc and the smallest length at the edges of the arc. Additionally, or alternatively, the single arc-shaped protrusion can extend the largest length in the flange direction at each end of the arc and extend the smallest length in the flange direction in the center of the arc (not shown). The arc-shaped protrusion can engage the wheel flange at its further extension point in the flange direction but can quickly wear away if there is excessive contact with the wheel flange due to the small amount of surface area contacting the flange. As the arc-shaped protrusion wears away, the amount of surface area engaging the wheel flange increases, thus slowing the wearing away of the protrusion.

As discussed above, with reference to FIGS. 31A-46, a friction device having one or more variable length, variable width, and/or variable wear protrusions arranged to engage a wheel flange can provide centering of the friction device (e.g., brake shoe) relative to the wheel surface by filling gaps between the friction structure and the wheel flange, while not damaging or unnecessarily wearing against the flange of the wheel due to variable wear rates of the one or more protrusions.

Further in reference to FIGS. 31A-46, one or more of the protrusions and/or recesses may comprise the same material or material(s) as the extended volume portion and/or the tread portion. Alternatively, or additionally, one or more of the protrusions and/or recesses may comprise a different material or materials than the extended volume portion and/or the tread portion. One or more of the protrusions and/or recesses may be integrally formed with the extended volume portion (e.g., as a monolithic structure). Alternatively, or additionally, one or more of the protrusions and/or recesses may be separately manufactured from the extended volume and then attached to the extended volume portion by an adhesive, mechanical fasteners, welding, etc. In one example, the tread portion, extended volume portion, and plural protrusions are integrally formed and comprised of the same material(s). For example, all the protrusions and/or recesses of the friction device may be integrally formed with the extended volume portion and tread portion and made of the same material(s). In another example, plural but fewer than all of the protrusions and/or recesses are integrally formed with the extended volume portion and tread portion and made of the same material(s), whereas the remaining, non-integral protrusion(s) are made of a different material or materials and attached to the extended volume portion. For example, the integral protrusions could be comprised of a friction material, and the other, non-integral protrusions could comprise a metal or metal alloy, for flange conditioning of the wheel.

In one embodiment, the extended volume portion, also referred to as the flange engagement portion, of the friction device can comprise a low-friction, or lubricating, portion of the friction structure to further reduce wear on a flange wheel. That is, the tread portion of the friction structure can engage the wheel tread of a wheel with a high-friction material to apply a braking force, as discussed above, while the flange engagement portion of the friction structure can engage the flange of the wheel with a low-friction and/or lubricating material to further reduce wear on the wheel flange and/or to transfer lubricant to the wheel flange to reduce wear between the wheel flange and a rail.

One or more protrusions and/or recesses of the flange engagement portion of the friction structure can be made of a low-friction and/or solid lubricant material, such as graphite, molybdenum disulfide, etc. In one example, each of the one or more protrusions/recesses can be made of a low-friction and/or lubricating material that is different from the friction material of tread portion of the friction structure to reduce wear on the wheel flange. In another example, one or more of the protrusions/recesses can be made of a low-friction and/or lubricating material, while one or more additional protrusions/recesses can be made of a higher-friction material and/or the same friction material as the tread portion of the friction structure.

Such an arrangement of both low-friction/lubricating protrusions/recesses and higher-friction protrusions/recesses in the flange engagement portion of the friction structure can aid in reducing further wear to the wheel flange, while still providing a suitable variable wear rate of the higher friction protrusions/recesses. That is, the higher-friction protrusions/recesses can fill gaps between the friction structure and the wheel flange to center the friction structure on the wheel tread surface, while the low-friction/lubricating protrusions/recesses can further reduce wear on the flange and/or lubricate the flange to reduce wear between the flange and a rail.

Still referring to the examples shown in FIGS. 31A-46, the friction device having variable wear protrusions can include a backing plate 204 to support the friction structure. The backplate can include rejection lugs 205A-B and rejection pins 206A-B. The friction device can also include a keybridge 207. The friction device can include conditioning inserts, such as a T-shaped insert 208 (FIG. 33A), a rim insert 209 (FIG. 35A), and/or an array-style insert 218 (FIG. 42C). In some examples, the friction device can include voids 211 disposed within the friction material of the friction structure.

The various features, materials, shapes, volumes, compositions, ranges, parameters, sizes, arrangements, etc., of various components of a friction device, e.g., backing plates, frictions structures, friction inserts, fillers, voids, tread portions, extended volume portions, protrusions, etc., are discussed above in detail, primarily with reference to FIGS. 1-30, and are equally applicable to the exemplary friction devices shown in FIGS. 31A-46, but are not repeated in this section for the sake of brevity.

In one or more examples of the subject matter described herein, a friction device for a wheel includes a backing plate and a friction material disposed on the backing plate to form a brake surface to engage a surface of the wheel. The friction material extends between a first end and a second end along a central longitudinal axis, and between a rim side and a flange side. A void is disposed within the friction material and extends from the brake surface a distance into the friction material. The void forms an opening of the brake surface of the friction material.

Optionally, the friction device may include a conditioning insert disposed within the friction material. The conditioning insert may include a conditioning surface configured to engage the surface of the wheel. Optionally, the conditioning surface may include a material that is different than the friction material. Optionally, the central longitudinal axis may extend through a portion of the void. The conditioning insert may be located between the void and the rim side of the friction material. Optionally, the void may be a first void. The friction device may include plural voids disposed within the friction material. Each of the plural voids may be aligned with each other and along the central longitudinal axis of the friction material. Optionally, the void may have a volume that is between about 5 percent and about 50 percent of a volume of the friction material. Optionally, the void may have a first cross-sectional profile at a location proximate the brake surface and have a different, second cross-sectional profile at a location within the friction material and a distance away from the brake surface. Optionally, the flange side of the friction material may be contoured to compliment a flange of the wheel. Optionally, at least a portion of the void may be configured to be filled with a filler material that has a composition that is different than the friction material. Optionally, the filler material may include a metallic alloy that is present in the filler material in an amount from about 5 percent to about 25 percent by weight. Optionally, the friction material may be operably coupled with the backing plate via an adhesive layer disposed between at least a portion of the backing plate and the friction material.

In one or more examples of the subject matter described herein, a friction device for use on a vehicle includes backing plate adapted to interface with a brake head of the vehicle, and a friction material operably coupled with the backing plate to form a brake surface that engages a wheel of the vehicle. A conditioning insert is disposed at least partially within the friction material. The conditioning insert including a conditioning surface configured to face the wheel. The conditioning surface includes a material that is different than the friction material. A void may be disposed within the friction material and extend from the brake surface a distance into the friction material. The void may form an opening of the brake surface of the friction material.

Optionally, the friction material may extend between a first end and a second end along a central longitudinal axis, and between a rim side and a flange side. The central longitudinal axis may extend through a portion of the void. Optionally, the void may have a volume that is between about 5 percent and about 50 percent of a volume of the friction material. Optionally, the wheel of the vehicle may engage the brake surface of the friction material outside of the void, and the wheel of the vehicle may disengage from the brake surface of the friction material at the void. Optionally, at least a portion of the void may be filled with a filler material that has a composition that is different than a composition of the friction material. Optionally, a surface of the wheel may contact the friction material outside of the void, and the surface of the wheel may contact the filler material at the void. Optionally, the void may have a volume that is between about 5 percent and about 50 percent of a volume of the friction material. Optionally, the void may be a first void. The friction device may include plural voids disposed within the friction material. Each of the plural voids may be aligned with each other and along a central longitudinal axis of the friction material.

In one or more examples of the subject matter described herein, a method includes engaging a brake surface of a friction material with a wheel surface of a wheel to slow or stop movement of the wheel, and disengaging the brake surface of the friction material with the wheel surface at a void disposed within the friction material and extending from the brake surface a distance into the friction material. The void may form an opening of the brake surface of the friction material.

As discussed, it may be desirable to mitigate or prevent the lateral migration of a friction device relative to a wheel over time, to avoid or reduce degradation of the friction device and/or wheel and to maintain a desired, consistent quality of braking performance. This may be accomplished by providing a shaped or “extra-wide” friction device according to one or more examples of the invention, as set forth herein. For example, examples of the subject matter described herein relate to friction devices having an extended volume portion of the friction material that is contoured to complement a contour of a flange of the wheel. The extended volume portion may mechanically contact the flange when the friction device is applied against the wheel. Unlike other friction devices, the complementary engagement between the extended volume portion and the flange may prevent or mitigate the lateral migration of the friction device across a flanged wheel. This may maintain the proper alignment of braking and conditioning surfaces against the wheel tread, wheel flange, and/or wheel rim, reducing wear of the friction device and/or the wheel over repeated use relative to other friction devices that experience lateral migration.

In an example, a friction device (e.g., brake shoe) includes a backing plate and a friction structure (e.g., brake pad). The backing plate may interface with a brake actuator of a vehicle having a wheel with a wheel flange and a wheel tread. The friction structure is attached or coupled to the backing plate and comprises a friction material. The friction structure has a longitudinal flange side, a longitudinal rim side, and two opposing ends and defines a brake surface for engaging the wheel. The friction structure includes a tread portion on the longitudinal rim side and a flange engagement portion on the longitudinal flange side. The flange engagement portion is attached to the tread portion and defines a flange contact region of the brake surface that may at least partially engage the flange at least during initial use of the friction device with the wheel. (That is, the flange engagement portion engages the flange both when the friction device is used initially with a designated type of wheel and when the friction device is used subsequently.) For example, the flange contact region may be complementary shaped to a shape of at least part of the flange, for the flange engagement portion to engage the flange during use. A maximum thickness of the flange engagement portion at the longitudinal flange side of the friction structure, prior to use, is from 30% to 75% of a maximum thickness of the tread portion.

In an example, a friction device (e.g., brake shoe) includes a backing plate and a friction structure (e.g., brake pad). The backing plate may interface with a brake actuator of a vehicle having a wheel with a wheel flange and a wheel tread. The friction structure is attached or coupled to the backing plate and comprises a friction material. The friction structure has a longitudinal flange side, a longitudinal rim side, and two opposing ends and defines a brake surface for engaging the wheel. The friction structure includes a tread portion on the longitudinal rim side and a flange engagement portion on the longitudinal flange side. The flange engagement portion is attached to the tread portion and defines a flange contact region of the brake surface that may at least partially engage the flange at least during initial use of the friction device with the wheel. (For example, the flange contact region may be complementary shaped to a shape of at least part the flange, for the flange engagement portion to engage the flange during use.) A maximum thickness of the flange engagement portion at the longitudinal flange side of the friction structure, prior to use, is from 30% to 75% of a maximum thickness of the tread portion., a maximum width of the tread portion between the longitudinal rim side and the flange engagement portion is equal to a width of the wheel tread.

In an example, a friction device (e.g., brake shoe) includes a backing plate and a friction structure (e.g., brake pad). The backing plate may interface with a brake actuator of a vehicle having a wheel with a wheel flange and a wheel tread. The friction structure is attached or coupled to the backing plate and comprises a friction material. The friction structure has a longitudinal flange side, a longitudinal rim side, and two opposing ends and defines a brake surface for engaging the wheel. The friction structure includes a tread portion on the longitudinal rim side and a flange engagement portion on the longitudinal flange side. The flange engagement portion is attached to the tread portion and defines a flange contact region of the brake surface that may at least partially engage the flange at least during initial use of the friction device with the wheel. (For example, the flange contact region may be complementary shaped to a shape of at least part the flange, for the flange engagement portion to engage the flange during use.) A maximum thickness of the flange engagement portion at the longitudinal flange side of the friction structure, prior to use, is from 40% to 60% of the maximum thickness of the tread portion.

In an example, a friction device (e.g., brake shoe) includes a backing plate and a friction structure (e.g., brake pad). The backing plate may interface with a brake actuator of a vehicle having a wheel with a wheel flange and a wheel tread. The friction structure is attached or coupled to the backing plate and comprises a friction material. The friction structure has a longitudinal flange side, a longitudinal rim side, and two opposing ends and defines a brake surface for engaging the wheel. The friction structure includes a tread portion on the longitudinal rim side and a flange engagement portion on the longitudinal flange side. The flange engagement portion is attached to the tread portion and defines a flange contact region of the brake surface that may at least partially engage the flange at least during initial use of the friction device with the wheel. (For example, the flange contact region may be complementary shaped to a shape of at least part the flange, for the flange engagement portion to engage the flange during use.) A maximum thickness of the flange engagement portion at the longitudinal flange side of the friction structure, prior to use, is from 40% to 60% of the maximum thickness of the tread portion, a maximum width of the tread portion between the longitudinal rim side and the flange engagement portion is equal to a width of the wheel tread.

In any of the aforementioned examples of a friction device having a friction structure with a tread portion on the longitudinal rim side and a flange engagement portion on the longitudinal flange side, it may be the case that all or at least an outermost part of the flange engagement portion (as defined along the longitudinal flange side) is not backed by the backing plate.

In another example, a friction device (e.g., brake shoe) includes a backing plate and a friction structure (e.g., brake pad) attached or coupled to the backing plate. The backing plate may interface with a brake actuator of a vehicle having a wheel with a wheel flange and a wheel tread. The friction structure has a longitudinal flange side, a longitudinal rim side, and two opposing ends, and defines a brake surface for engaging the wheel. The friction structure includes a tread portion comprising a friction material on the longitudinal rim side and an extended volume portion of the friction material on the longitudinal flange side. The extended volume portion defines a flange contact region of the brake surface that may at least partially engage the flange at least during initial use of the friction device with the wheel. (For example, the flange contact region may be complementary shaped to a shape of at least part the flange, for the extended volume portion to engage the flange during use.)

The backing plate may be flange-less (e.g., not include a flange), and/or the longitudinal flange side of the friction structure may be dimensioned to terminate no further than a top of the wheel flange when the friction device is installed for initial use with the wheel. A maximum thickness of the friction structure at the longitudinal flange side of the friction structure, prior to use, may be from 30% to 75% of a maximum thickness of a tread potion of the friction structure that may contact the wheel tread when the brakes shoe is actuated. The friction structure may include the tread portion and the extended volume portion with the two comprising a monolithic block of the friction material. At least an outermost part of the extended volume portion (in the flange direction) may not be backed by the backing plate.

The maximum thickness of the friction structure at the longitudinal flange side of the friction structure, prior to use, may be from 40% to 60% of the maximum thickness of the tread portion of the friction structure. The flange contact region of the brake surface may be initially complementary shaped to a shape of a flange root at an area of contact engagement between the extended volume portion and the flange root. The friction device may further include at least one protrusion extending from the extended volume portion of the friction material. The at least one protrusion is complementary shaped to the shape of the flange and the flange root at a location of contact engagement between the at least one protrusion and the flange and flange root.

The at least one protrusion may include a plurality of protrusions on the extended volume portion of the friction material, one or more of the protrusions may have a first shaped portion nearest the backing plate and a second, differently shaped portion nearest the brake surface, e.g., the first shaped portion may be differently tapered than a taper of the second shaped portion.

The friction device may include at least one wheel conditioning insert disposed within the friction material and comprising a material different than the friction material. The at least one-wheel conditioning insert may have an elongated portion that is offset from a central longitudinal axis of the brake surface and lying adjacent and generally parallel to the longitudinal rim side of the friction structure. An entirety of the at least one-wheel conditioning insert may be offset from a central longitudinal axis of the friction device and lies adjacent and generally parallel to the longitudinal rim side of the friction material. The at least one wheel conditioning insert may be generally T-shaped relative to a surface of the insert that is parallel to the brake surface and includes a first elongated portion that is offset from a central longitudinal axis of the brake surface and lies adjacent and generally parallel to the longitudinal rim side of the friction structure, and a second elongated portion substantially perpendicular to the first portion and extending toward the longitudinal flange side of the friction structure. The at least one-wheel conditioning insert may include a plurality of wheel conditioning inserts disposed within the friction material. An entirety of each of the wheel conditioning inserts may be offset from a central longitudinal axis of the friction device and lies adjacent and generally parallel to the longitudinal rim side of the friction structure.

The friction structure may define at least one void in the friction material. Each void may be defined by an opening in the friction structure coincident with the brake surface and one or more sidewalls extending into the friction structure down from the opening. For example, the opening may be oval, circular, or polygonal in shape.

A friction device (e.g., brake shoe) may include a friction structure (e.g., brake pad) having a brake surface, part of which (i.e., a tread region) may engage a tread of a wheel to slow or stop movement of the wheel. The friction structure may include an extended volume portion disposed along a longitudinal flange side of the friction structure. A contact surface of the extended volume portion may be complementary to a contour of a flange of the wheel adjacent to the tread, and the contact surface may engage the flange when the friction structure is applied against the wheel.

The friction device may include a backing plate adapted to interface with a brake actuator (e.g., brake head) of a vehicle that includes the wheel. The friction structure may be secured to the backing plate. The contact surface of the extended volume portion may be angled relative to tread region. The contact surface may be arcuate, polygonal, S-shaped, or multi-segmented. The extended volume portion may include an exposed surface that extends above the flange of the wheel when the friction structure is applied against the wheel. The friction structure may include at least one protrusion extending from the extended volume portion. The contact surface of the extended volume portion may be disposed between the at least one protrusion and the brake surface.

The at least one protrusion may have a shape that is complementary to the flange and may contact the flange when the friction structure is applied against the wheel. Each protrusion of the at least protrusion may have a rectangular parallelepiped-shaped portion connected to a wedge-shaped portion. The wedge-shaped portion may be disposed between the contact surface and the rectangular parallelepiped-shaped portion. The wedge-shaped portion may taper from the rectangular parallelepiped-shaped portion to the contact surface. The friction device may include at least one wheel conditioning insert disposed within the friction structure along the brake surface. The at least one-wheel conditioning insert may be formed of a different material than the friction structure.

The friction device may include at least one void disposed within the friction structure along the brake surface.

Another friction device (e.g., brake shoe) for use on a vehicle may include a backing plate and a friction structure (e.g., brake pad) disposed on the backing plate. The backing plate may be adapted to interface with a brake actuator/system (e.g., brake head) of the vehicle. The friction structure may be composed of a friction material that defines a brake surface. A tread region of the friction structure may engage a tread of a wheel of the vehicle to slow or stop movement of the wheel. The friction structure may include an extended volume portion disposed along a longitudinal flange side of the friction structure. A contact surface of the extended volume portion may be complementary to a contour of a flange of the wheel adjacent to the tread. The contact surface may engage the flange when the friction structure is applied against the wheel.

The contact surface of the extended volume portion may be angled relative to the tread region of the brake surface. The contact surface may be arcuate, polygonal, S-shaped, or multi-segmented. The extended volume portion may include an exposed surface that extends above the flange of the wheel when the friction structure is applied against the wheel. The friction structure may include at least one protrusion extending from the extended volume portion. The contact surface of the extended volume portion may be disposed between the at least one protrusion and the brake surface. The at least one protrusion may include multiple protrusions aligned in a row between the backing plate and the contact surface of the extended volume portion of the friction structure.

The at least one protrusion may have a shape that is complementary to the flange and may contact the flange when the friction structure is applied against the wheel. The friction device may include (i) at least one wheel conditioning insert disposed within the friction material along the brake surface and/or (ii) at least one void disposed within the friction material along the brake surface.

Another friction device may include a friction structure. The friction structure may include a brake surface that has a tread region that may engage a tread of a wheel to slow or stop movement of the wheel. The friction structure may include an extended volume portion disposed along a longitudinal flange side of the friction structure. The extended volume portion may include a contact surface that is angled relative to the tread region and may be complementary to a contour of a flange of the wheel adjacent to the tread. The contact surface may engage the flange when the friction structure is applied against the wheel. The friction structure may include at least one protrusion extending from the extended volume portion and may engage the flange when the friction structure is applied against the wheel. The contact surface of the extended volume portion may be disposed between the at least one protrusion and the tread region.

A method of forming a friction device for use on a vehicle may include providing a backing plate adapted to interface with a brake actuator (e.g., brake head) of the vehicle, and disposing a friction material onto the backing plate to form a friction structure that defines brake surface for engaging a wheel of the vehicle. The friction structure may include a longitudinal flange side, a longitudinal rim side, and two opposing ends. An extended volume portion of the friction material may be provided on the longitudinal flange side to at least partially engage a flange on the wheel of the vehicle when the friction device is applied against the wheel. The extended volume portion engaging the flange may align the brake surface of the friction structure with a wheel tread of the wheel. The brake surface of the friction device may be initially complementary shaped to a shape of the flange at a location of contact engagement between the extended volume portion and the flange. The method may include providing a plurality of protrusions on the extended volume portion of the friction material. At least one of the protrusions may have a first shaped portion nearest the backing plate and a second shaped portion nearest the brake surface. The first shaped portion may be differently shaped from the second shaped portion. The first shaped portion may be differently tapered than a taper of the second shaped portion.

A method of forming a friction device for use on a vehicle may include providing a backing plate as described herein, and, separately from the backing plate, forming a friction structure, comprising a friction material, that defines a brake surface for engaging a wheel of the vehicle. Then, the friction structure is secured to the backing plate, e.g., using an adhesive, thermocompression, welding, etc.

A suitable backing plate (and friction device more generally) may be flange-less, meaning lacking a U-shaped or otherwise-shaped metal flange, attached to or otherwise part of the backing plate, for wrapping around and up and over a wheel flange for alignment purposes. By omitting a metal alignment flange, the friction device may be less expensive to manufacture while having improved braking properties. Depending on the particular shape/configuration of the wheel with which the friction device is intended for use, the friction device, in addition to the friction structure having an extended volume portion, may be outfitted with a metal flange or other supplemental alignment features, for alignment of the friction device with the wheel during use.

Another friction device (e.g., brake shoe) for use on a vehicle may include a backing plate and a friction structure (e.g., brake pad) disposed on the backing plate. The backing plate may be configured to interface with a brake actuator/system (e.g., brake head) of the vehicle. The friction structure may be composed of a friction material that defines a brake surface. A tread region of the friction structure may engage a tread of a wheel of the vehicle to slow or stop movement of the wheel. The friction structure may include an extended volume portion disposed along a longitudinal flange side of the friction structure. The extended volume portion may include a plurality of protrusions that may partially engage a flange of the wheel at least during initial use of the friction device. One or more of the protrusions can extend at varying lengths from the longitudinal flange side of the friction structure.

The friction device can include at least one conditioning insert disposed within the friction structure. The at least one conditioning insert can be positioned on one side of the central longitudinal axis of the friction device adjacent to the longitudinal rim side. The at least one conditioning insert can include a material that is different than the friction material.

The plurality of protrusions can include a first protrusion extending a first length from the longitudinal flange side, a second protrusion and a third protrusion that each extend a second length from the longitudinal flange side that is different from the first length. The first protrusion can be a first width and the second and third protrusions can be a second width that is wider than the first width. The first protrusion can include a smaller flange engagement surface area than each of the second and third protrusions.

The friction device can include a bridge protrusion that extends from the extended volume portion and extends longitudinally along the length of the friction structure. The bridge protrusion can be disposed on the friction structure opposite the brake surface of the friction structure. The bridge protrusion can extend from the longitudinal flange side the first length along the longitudinal length of the friction structure.

The friction structure can define at least one void in the friction material. The void can be defined by an opening in the friction structure coincident with the brake surface and one or more sidewalls extending into the friction structure from the opening.

Another friction device (e.g., brake shoe) for use on a vehicle may include a backing plate and a friction structure (e.g., brake pad) disposed on the backing plate. The backing plate may be configured to interface with a brake actuator/system (e.g., brake head) of the vehicle. The friction structure may be composed of a friction material that defines a brake surface. A tread region of the friction structure may engage a tread of a wheel of the vehicle to slow or stop movement of the wheel. The friction structure may include an extended volume portion disposed along a longitudinal flange side of the friction structure. The extended volume portion may include a flange-engagement portion extending from the longitudinal flange side. The flange-engagement portion can extend continuously along the longitudinal length of the friction structure from opposing end to opposing end. The flange-engagement portion can extend from the longitudinal flange side at varying lengths along the longitudinal length of the flange-engagement portion.

The flange-engagement portion can include one or more arc-shaped protrusions that extend concavely away from the longitudinal flange side and one or more arc-shaped protrusions that extend convexly away from the longitudinal flange side. At least one or more of the arc-shaped protrusions extending convexly away from the longitudinal flange side are disposed in the flange-engagement portion between one or more of the arc-shaped protrusions that extend concavely away from the longitudinal flange side.

The flange-engagement portion can include a singular arc-shaped protrusion. The singular arc-shaped protrusion can extend along the longitudinal length of the friction structure away from the longitudinal flange side at varying lengths across the longitudinal length of the singular arc-shaped protrusion. The singular arc-shaped protrusion can extend concavely away from the longitudinal flange side. The singular arc-shaped protrusion can extend convexly away from the longitudinal flange side.

The flange-engagement portion can include one or more protrusions extending a first length from the longitudinal flange side, one or more protrusions extending a second length from the longitudinal flange side, and one or more protrusions extending a third length from the longitudinal flange side. Each of the first, second, and third lengths can be different.

The friction device can include at least one conditioning insert disposed within the friction structure. The at least one conditioning insert can be positioned on one side of the central longitudinal axis of the friction device adjacent to the longitudinal rim side. The at least one conditioning insert can include a material that is different than the friction material.

Another friction device (e.g., brake shoe) for use on a vehicle may include a backing plate and a friction structure (e.g., brake pad) disposed on the backing plate. The friction structure may be composed of a friction material that defines a brake surface. The friction structure can include one or more wearable protrusions extending from the longitudinal flange side. The one or more wearable protrusions can be configured to engage a flange of the wheel.

Another friction device (e.g., brake shoe) for use on a vehicle may include a backing plate and a friction structure (e.g., brake pad) disposed on the backing plate. The friction structure may be composed of a friction material that defines a brake surface. The friction structure can include one or more wearable protrusions extending from the longitudinal flange side and configured to engage a flange of the wheel. One or more of the wearable protrusions of the plurality of wearable protrusions can comprise the first friction material, and one or more wearable protrusions of the plurality of wearable protrusions can comprise a lubricating friction material that is different from the first friction material.

A method for engaging and disengaging a brake surface includes engaging a brake surface of a friction structure with a wheel of a vehicle. The friction structure including a friction material having a central longitudinal axis, a longitudinal flange side, a longitudinal rim side, and an extended volume portion on the longitudinal flange side with a plurality of flange contact protrusions and recesses. The method includes contacting the wheel flange with one or more of the plurality of flange contact protrusions during initial engagement of the brake surface and allowing at least one of the plurality of protrusions, which extends a different length from the longitudinal flange side compared to other protrusions, to facilitate progressive engagement with the wheel flange. The method further includes disengaging the brake surface by reducing contact between the friction material and the wheel, including the plurality of flange contact protrusions.

In various embodiments, the present disclosure provides friction devices that include added functional features such as reducing asymmetric wheel flange wear, minimizing hollow wear, and enhancing brake beam centering. In one embodiment, the friction devices include features to reduce wheel flange wear, minimizing hollow wear, and enhancing brake beam centering. In one embodiment, the friction devices may include materials with high-friction, mid-friction, and lubricating properties employed in braking and wear reduction. In one embodiment, the friction devices include features such as varying protrusion lengths, arc shapes, and friction gradients that may be tied to functional aspects such as lateral force minimization and stress distribution. In one embodiment, the friction devices include features such as voids for stress absorption and continuous flange strips with variable geometry, among other implementation scenarios.

In various embodiments, additional functional and structural variations of the friction devices further include asymmetric spacing of protrusions to address vibrational issues and wear uniformity. In one embodiment, the friction devices include a multi-layer structure for improved durability and lubrication functionality. In one embodiment, the friction devices include a heat dissipation mechanism to enhance thermal management during use. In one embodiment, the friction devices implement a pressure-activated self- lubricating material for sustained flange protection. In one embodiment, the friction devices include protrusions that optimize force distribution and improve operational stability. In one embodiment, the friction devices employ material density variations to adapt the friction structure to different functional requirements.

One general aspect includes a friction device. The friction device also includes a backing plate configured to interface with a brake actuator of a vehicle having a wheel with a wheel flange and a wheel tread. The device also includes a friction structure attached to the backing plate and may include a friction material, the friction material defining a central longitudinal axis, the friction structure having a longitudinal flange side, a longitudinal rim side, and two opposing ends and defining a brake surface for engaging the wheel. The device also includes the friction structure may include an extended volume portion of the friction material on the longitudinal flange side, the extended volume portion defining a plurality of flange contact protrusions and recesses, where one or more of the plurality of flange contact protrusions may at least partially engage the wheel flange at least during initial use of the friction device with the wheel, and where at least one protrusion of the plurality of flange contact protrusions extends a different length from the longitudinal flange side than each of the other protrusions of the plurality of flange contact protrusions.

Implementations may include one or more of the following features. The friction device may include at least one wheel conditioning insert disposed within the friction structure, where an entirety of the at least one wheel conditioning insert is positioned on one side of the central longitudinal axis of the friction device adjacent the longitudinal rim side, where the conditioning insert reduces hollow wear of a tread surface of the wheel. The plurality of flange contact protrusions may include a first protrusion that extends a first length from the longitudinal flange side, a second protrusion and a third protrusion that each extend a second length from the longitudinal flange side that is different from the first length where the plurality of flange contact protrusions center the friction device on a tread surface of the wheel and reduce asymmetrical wear of the wheel flange. The first protrusion may include a first width and where the second protrusion and the third protrusion each may include a second width that is wider than the first width. The first protrusion may include a smaller flange-engagement surface area than each of the second protrusion and the third protrusion. The at least one wheel conditioning insert may include a material different than the friction material. The friction structure defines at least one void in the friction material, the void defined by an opening in the friction structure that is coincident with the brake surface and one or more sidewalls extending into the friction structure from the opening. The extended volume portion further may include a bridge protrusion extending from the extended volume portion and extending longitudinally along a length of the friction structure, where the bridge protrusion is disposed on the friction structure opposite the brake surface of the friction structure, and where the bridge protrusion extends along a first length from the longitudinal flange side along a longitudinal length of the friction structure. The friction structure may include a tread portion configured to align with and contact the wheel tread when the friction device is actuated.

One general aspect includes a friction device. The friction device also includes a backing plate configured to interface with a brake actuator of a vehicle having a wheel with a wheel flange and a wheel tread. The device also includes a friction structure attached to the backing plate and may include a friction material, the friction material defining a central longitudinal axis, the friction structure having a longitudinal flange side, a longitudinal rim side, and two opposing ends and defining a brake surface for engaging the wheel. The device also includes the friction structure includes an extended volume portion of the friction material on the longitudinal flange side, the extended volume portion defining a flange-engagement portion extending from the longitudinal flange side and extending continuously along a longitudinal length of the friction structure from opposing end to opposing end, where the flange-engagement portion extends from the longitudinal flange side at varying lengths along the longitudinal length of the flange-engagement portion.

Implementations may include one or more of the following features. The friction device where the flange-engagement portion may include one or more arc-shaped protrusions extending concavely away from the longitudinal flange side and one or more arc-shaped protrusions extending convexly away from the longitudinal flange side. At least one of the one or more arc-shaped protrusions extending convexly away from the longitudinal flange side are disposed in the flange-engagement portion between one or more of the arc-shaped protrusions extending concavely away from the longitudinal flange side. The flange-engagement portion may include a singular arc-shaped protrusion extending along the longitudinal length of the friction structure, where the singular arc-shaped protrusion extends from the longitudinal flange side at a plurality of varying lengths across an entirety of the singular arc-shaped protrusion. The singular arc-shaped protrusion extends concavely away from the longitudinal flange side. The singular arc-shaped protrusion extends convexly away from the longitudinal flange side. The flange-engagement portion may include one or more protrusions extending a first length from the longitudinal flange side, one or more protrusions extending a second length from the longitudinal flange side, and one or more protrusions extending a third length from the longitudinal flange side, where the first length is different than the second length and the third length is different than the first and second lengths. The first length is longer than the second length and the second length is longer than the third length. An entirety of the at least one wheel conditioning insert is positioned on one side of the central longitudinal axis of the friction device adjacent the longitudinal rim side.

One general aspect includes a friction device. The friction device also includes a backing plate. The device also includes a friction structure attached to the backing plate, the friction structure may include a friction material, the friction material defining a central longitudinal axis, the friction structure having a longitudinal flange side, a longitudinal rim side, and two opposing ends and defining a brake surface for engaging the wheel. The device also includes the friction structure includes one or more wearable protrusions extending from the longitudinal flange side, the one or more wearable protrusions configured to engage a flange of the wheel.

Implementations may include one or more of the following features. The friction device where the one or more variable protrusions of the friction structure may include: the friction material; and a lubricating friction material that is different from the friction material.

One general embodiment includes a friction device configured to reduce asymmetric wheel flange wear. The friction device also includes a backing plate adapted to interface with a brake actuator of a vehicle having a wheel with a wheel flange and a wheel tread; and a friction structure attached to the backing plate and may include a friction material, the friction structure defining: a brake surface configured to engage the wheel tread for braking; a longitudinal flange side having an extended volume portion with a plurality of flange contact protrusions, each configured to intermittently contact the wheel flange to reduce lateral forces during braking to minimize wheel flange wear; and where the flange contact protrusions may include a material with lower friction compared to the brake surface to create a friction gradient between the flange contact protrusions and the brake surface, the lower friction material configured to reduce flange wear by decreasing lateral forces during wheel rotation.

Implementations may include one or more of the following features. The friction device where at least one of the flange contact protrusions includes a lubricating friction material configured to transfer lubricant to the wheel flange to reduce wear between the wheel flange and a rail. The flange contact protrusions include alternating materials may include: a first material matching the friction material of the brake surface for maintaining structural integrity; and a second lubricating material configured to selectively reduce wear on the wheel flange. The brake surface is dimensioned to align with the wheel tread and maintain even wear distribution across the wheel tread. The friction device may include a bridge protrusion extending along a longitudinal length of the friction structure opposite the brake surface, the bridge protrusion configured to enhance brake beam centering by balancing lateral forces during actuation. The flange contact protrusions may include: at least one protrusion extending a first length from the longitudinal flange side, and at least one protrusion extending a second length from the longitudinal flange side, where the first length and the second length are configured to create a staggered engagement with the wheel flange, reducing asymmetric wear. The flange contact protrusions may include arc-shaped protrusions extending concavely or convexly from the longitudinal flange side, an arc-shaped design configured to improve dynamic alignment between the wheel flange and the friction device. The friction device may include one or more voids within the friction structure, the voids configured to absorb stress and minimize material deformation during extended use to preserve a functional geometry of the flange contact protrusions. The flange contact protrusions may include: a first width and surface area for initial contact with the wheel flange, and a second width and surface area for sustained engagement, differing widths defined by a difference between the first width and the second width is configured to reduce friction-induced heat and extend a life of the friction structure. The friction structure may include a tread portion and a flange portion, the flange portion may include a plurality of protrusions coated with a low-friction material to provide dual benefits of wheel flange protection and lubricant application. The flange contact protrusions are asymmetrically spaced along the longitudinal flange side, the asymmetry configured to mitigate resonant vibrations and ensure uniform wear on the wheel flange during braking operations. The friction structure may include: a multi-layer construction may include an inner layer of high-durability friction material for structural integrity, and an outer layer of lubricating friction material disposed on the flange contact protrusions, the outer layer configured to reduce both lateral forces and rail wear during use. The friction device may include a thermally conductive insert embedded in the flange-engaging portion, the thermally conductive insert configured to dissipate heat generated during flange engagement to minimize thermal deformation of the friction structure. The extended volume portion on the longitudinal flange side includes a self-lubricating material that gradually releases lubricant under applied pressure, the lubricant reducing wheel flange wear without requiring external lubrication. The plurality of flange contact protrusions is arranged to create alternating high-and low-pressure zones during engagement with the wheel flange, the pressure zones configured to balance lateral forces and enhance the centering of the brake beam. The friction structure is configured with a variable-density friction material, the variable density tailored to provide higher compressibility near the flange-engaging portion to absorb shock and lower compressibility near the tread-engaging portion to maintain braking performance.

One general aspect includes a friction device configured to reduce asymmetric wheel flange wear and improve brake beam centering. The friction device also includes a friction structure having a tread-engaging portion and a flange-engaging portion; a flange-engaging portion may include a continuous flange contact strip extending along a longitudinal length of the friction structure, the flange contact strip configured with varying protrusion lengths to distribute contact forces differently across the wheel flange during braking.

Implementations may include one or more of the following features. The friction device where the flange-engagement portion includes protrusions of differing lengths and widths, arranged to reduce lateral forces by modulating engagement patterns along the wheel flange. The friction device may include at least one wheel conditioning insert positioned adjacent to the tread-engaging portion, the insert configured to align the brake surface with a wheel tread and minimize hollow wear by conditioning the wheel surface during braking. The flange-engagement portion may include at least one concave arc-shaped protrusion and at least one convex arc-shaped protrusion configured to optimize engagement with the wheel flange by compensating for variations in flange geometry.

The singular forms “a,” “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

All numbers and ranges used in the specification and claims are to be understood as being modified in all instances by the term “about.” By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

The terms “first”, “second”, and the like are not intended to refer to any particular order or chronology, but refer to different conditions, properties, or elements. The term “at least” is synonymous with “greater than or equal to.” The term “not greater than” is synonymous with “less than or equal to.” The term “includes” is synonymous with “comprises.”

Spatial or directional terms, such as “left”, “right”, “inner”, “outer”, “above”, “below”, and the like, relate to the disclosure as shown in the drawing FIGS. and are not to be considered as limiting as the disclosure can assume various alternative orientations. As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values. As used herein, the terms “perpendicular” or “substantially perpendicular” mean a relative angle as between two objects at their real or theoretical intersection is from 85° to 95°, or from 87° to 93°, or from 88° to 92°, or from 89° to 91°, or from 89.5° to 90.5°, or from 89.75° to 90.25°, or from 89.9° to 90.1°, inclusive of the recited values.

This written description uses examples to disclose the examples, including the best mode, and to enable a person of ordinary skill in the art to practice the examples, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. A friction device comprising:
a backing plate configured to interface with a brake actuator of a vehicle having a wheel with a wheel flange and a wheel tread; and
a friction structure attached to the backing plate and comprising a friction material, the friction material defining a central longitudinal axis, the friction structure having a longitudinal flange side, a longitudinal rim side, and two opposing ends and defining a brake surface for engaging the wheel, and
the friction structure comprising an extended volume portion of the friction material on the longitudinal flange side, the extended volume portion defining a plurality of flange contact protrusions and recesses, wherein one or more of the plurality of flange contact protrusions may at least partially engage the wheel flange at least during initial use of the friction device with the wheel, and wherein at least one protrusion of the plurality of flange contact protrusions extends a different length from the longitudinal flange side than each of the other protrusions of the plurality of flange contact protrusions.

2. The friction device of claim 1, further comprising at least one wheel conditioning insert disposed within the friction structure, wherein an entirety of the at least one wheel conditioning insert is positioned on one side of the central longitudinal axis of the friction device adjacent the longitudinal rim side, wherein the conditioning insert reduces hollow wear of a tread surface of the wheel.

3. The friction device of claim 1, wherein the plurality of flange contact protrusions comprises a first protrusion that extends a first length from the longitudinal flange side, a second protrusion and a third protrusion that each extend a second length from the longitudinal flange side that is different from the first length wherein the plurality of flange contact protrusions center the friction device on a tread surface of the wheel and reduce asymmetrical wear of the wheel flange.

4. The friction device of claim 3, wherein the first protrusion comprises a first width and wherein the second protrusion and the third protrusion each comprise a second width that is wider than the first width.

5. The friction device of claim 4, wherein the first protrusion comprises a smaller flange-engagement surface area than each of the second protrusion and the third protrusion.

6. The friction device of claim 1, wherein the at least one wheel conditioning insert comprises a material different than the friction material.

7. The friction device of claim 6, wherein the friction structure defines at least one void in the friction material, the void defined by an opening in the friction structure that is coincident with the brake surface and one or more sidewalls extending into the friction structure from the opening.

8. The friction device of claim 7, wherein the extended volume portion further comprises a bridge protrusion extending from the extended volume portion and extending longitudinally along a length of the friction structure, wherein the bridge protrusion is disposed on the friction structure opposite the brake surface of the friction structure, and wherein the bridge protrusion extends along a first length from the longitudinal flange side along a longitudinal length of the friction structure.

9. The friction device of claim 1, wherein the friction structure comprises a tread portion configured to align with and contact the wheel tread when the friction device is actuated.

10. A friction device comprising:
a backing plate configured to interface with a brake actuator of a vehicle having a wheel with a wheel flange and a wheel tread; and
a friction structure attached to the backing plate and comprising a friction material, the friction material defining a central longitudinal axis, the friction structure having a longitudinal flange side, a longitudinal rim side, and two opposing ends and defining a brake surface for engaging the wheel, and
the friction structure includes an extended volume portion of the friction material on the longitudinal flange side, the extended volume portion defining a flange-engagement portion extending from the longitudinal flange side and extending continuously along a longitudinal length of the friction structure from opposing end to opposing end, wherein the flange-engagement portion extends from the longitudinal flange side at varying lengths along the longitudinal length of the flange-engagement portion.

11. The friction device of claim 10, wherein the flange-engagement portion comprises one or more arc-shaped protrusions extending concavely away from the longitudinal flange side and one or more arc-shaped protrusions extending convexly away from the longitudinal flange side.

12. The friction device of claim 11, wherein at least one of the one or more arc-shaped protrusions extending convexly away from the longitudinal flange side are disposed in the flange-engagement portion between one or more of the arc-shaped protrusions extending concavely away from the longitudinal flange side.

13. The friction device of claim 10, wherein the flange-engagement portion comprises a singular arc-shaped protrusion extending along the longitudinal length of the friction structure, wherein the singular arc-shaped protrusion extends from the longitudinal flange side at a plurality of varying lengths across an entirety of the singular arc-shaped protrusion.

14. The friction device of claim 13, wherein the singular arc-shaped protrusion extends concavely away from the longitudinal flange side.

15. The friction device of claim 13, wherein the singular arc-shaped protrusion extends convexly away from the longitudinal flange side.

16. The friction device of claim 10, wherein the flange-engagement portion comprises one or more protrusions extending a first length from the longitudinal flange side, one or more protrusions extending a second length from the longitudinal flange side, and one or more protrusions extending a third length from the longitudinal flange side, wherein the first length is different than the second length and the third length is different than the first and second lengths.

17. The friction device of claim 16, wherein the first length is longer than the second length and the second length is longer than the third length.

18. The friction device of claim 10, further comprising at least one wheel conditioning insert disposed within the friction structure, wherein an entirety of the at least one wheel conditioning insert is positioned on one side of the central longitudinal axis of the friction device adjacent the longitudinal rim side.

19. A friction device comprising:
a backing plate; and
a friction structure attached to the backing plate, the friction structure comprising a friction material, the friction material defining a central longitudinal axis, the friction structure having a longitudinal flange side, a longitudinal rim side, and two opposing ends and defining a brake surface for engaging the wheel, and the friction structure includes one or more wearable protrusions extending from the longitudinal flange side, the one or more wearable protrusions configured to engage a flange of the wheel.

20. The friction device of claim 19, wherein the one or more variable protrusions of the friction structure comprises:
the friction material; and
a lubricating friction material that is different from the friction material.

21-40. (canceled)
